(19) United States
(12) Patent Application Publication
(10) Pub. No.: US 2024/0065246 A1
(43) Pub. Date: Feb. 29, 2024

(54) Angler's Rigging Jig

(71) Applicant: James Michael Battisti, Stevensville, MT (US)

(72) Inventor: James Michael Battisti, Stevensville, MT (US)

(21) Appl. No.: 17/898,348

(22) Filed: Aug. 29, 2022

(51) Int. Cl. A01K 97/00

(52) U.S. Cl. CPC A01K 97/00

(57) ABSTRACT

In general, a jig is a device that mechanically maintains the correct positional relationship between a piece of work and a tool, or between parts of work during assembly. The Anglers Rigging Jig is a device that mechanically and magnetically retains and maintains the correct positional relationship between pieces of terminal fishing rig during assembly, as well as tools commonly used in this process. Standard pieces of terminal fishing rig include fishing monofilament, hooks, sinkers, and bobbers. Standard tools include fishing line nippers, forceps, hook-eye threaders, hook-eye cleaners and hook point sharpeners. The Angler's Rigging Jig expedites terminal rig modifications by retaining and orienting these items in a systematic fashion. It is a replacement for the lips/mouth while tying knots and adjusting terminal rigging.

### CROSS-REFERENCE TO RELATED APPLICATIONS

This application claims the benefit of Provisional Patent Application No. 63/260,727.

### BACKGROUND OF THE INVENTION

### Field

The invention relates to the field of fishing, specifically devices that help anglers build and adjust a fishing rig by temporarily retaining and orienting hooks, lines, sinkers and other tools/tackle, as well as assist in tasks such as hook threading and knot tying/untying.

### Prior Art

Fishing is a popular outdoor activity and sport enjoyed each year by millions of people worldwide, for centuries. Distinct from methods like spearing or netting, angling is a fishing technique where a hook is attached to fishing line and this line is often then connected to a fishing rod and reel. In general, a lure is a hook disguised as something fish living in a particular body of water will bite, upon which the angler pulls back on rod to set hook in fish's mouth, and then reel it in.

Anglers attach bobbers and or sinkers to the fishing line to place the lures where fish are located in the water column. This end section, with lure and additional attachments is commonly referred to as the terminal rig, or simply ‘rig’. Basic rig adjustments include threading line through eye of hook, tying secure line-to-hook and line-to-line knots, adding a sinker or bobber, and untying unwanted knots that form when casting. These rig adjustments are most often done standing/sitting near the water being fished and exposed to the weather.

Anglers commonly perform rig adjustments in a ‘work zone’ located between nose and belly button, easily accessed by both hands, with shoulders relaxed and things in focus. In an area similar to which one would hold a book to read it. Lures, line and sinkers can be difficult to manipulate when tying knots and assembling a well-built rig. This is especially true when using a ‘fly fishing’ technique where relatively small and delicate lures, line and sinkers are often required for success. Without a spot to temporarily hold these items in the work zone, anything dropped is easily lost in the wind, water, or shoreline rocks and sand.

As both hands are required for most rig adjustments, the human mouth and lips are often used to temporarily hold hook, line and sinker. The lips are frequently used to hold line (while connected to rod and reel) such that a portion of the rig hangs in the ‘work zone’ so it can be easily manipulated/adjusted. Both hands are then used to retrieve, manipulate and stow lure boxes, sinker dispensers, and spools of line as well as operate nippers and forceps, thread hooks and tie knots etc. The lip method is also commonly used to temporarily hold other tackle including lure, additional line, or even potentially toxic lead-containing sinkers. As the lips are used for many rig adjustment/knot tying procedures, actions like speaking, drinking and eating are difficult or impossible.

A variety of devices have been developed to help anglers build and adjust rigs. In fact, so many different gadgets/tools have been patented for this purpose that it is beyond the scope of this application to discuss them all. Thus, a few examples of prior art in each related ‘tool category’ are provided to demonstrate novelty of the invention described in this application:

Fishing nippers are a commonly used tool to accurately cut fishing line when held in hand. A variety of fishing nippers have been developed that have useful secondary functions such as hook-eye threaders/cleaners and knot tensioners (including U.S. Pat. Nos. 7,254,854B2, 5,136,744A, 3,521,918A).

Forceps are basically small pliers that temporarily hold a variety of fishing tackle when held in hand. Modifications to forceps include those that enable angler to cut fishing line as well as hold and attach sinkers and help tie knots (including U.S. Pat. Nos. 5,557,874A, 6,272,709B1, US20160021862A1).

Hook-eye threaders help anglers guide fishing line through the eye of hook when held in hand (including Patents US20070193104A1, U.S. Pat. No. 2,682,126A) or attached to fishing rod (US20170332616A1, U.S. Pat. No. 7,793,458B2) or attached to storage box (US20200187476A1). Some threaders help tie knots (including U.S. Pat. Nos. 231,454S, 4,697,370A, 4,403,797A) and some utilize magnets (including Patent US779345961). ‘Hands-free’ hook-eye threaders were not found in prior art.

Knot tying tools have been developed to assist in attachment of fishing line to hook when held in hand (including U.S. Pat. Nos. 3,787,081A, 3,667,790A, 6,817,634B2, 3,106,417A, 9,635,847B1, 2,716,036A and US20200337287A1). Knot tying tools have also been developed for joining two strands of line when held in hand (including U.S. Pat. Nos. 3,787,081A, 5,690,370A, 4,400,025A, and U.S. Ser. No. 10/264,774B2). Tools have also been developed for line-to-hook and line-to-line knots when held in hand (including U.S. Pat. Nos. 2,804,710A, 5,240,295A, 2,773,713A, and 7,494,162B1). Hook retainers that mount to rod have also been developed (including U.S. Pat. No. 3,418,742A, US20150201600A1, US20020116861A1, U.S. Pat. No. 7,299,583B2, US20100269400A1 and U.S. Pat. No. 2,527,625A) and requires the angler to use one hand to hold rod or put rod on a surface close to work zone.

Shot applicator tools (including U.S. Pat. No. 9,288,974B2, 2,790,341A, 2,829,550A, 4,377,027A, 7,013,594B1 and 3,825,961A) have been developed to assist in temporary retention of sinkers when attaching to line. No prior art was found that temporarily retains sinkers ‘hands-free’ during rig adjustments.

In general, the prior art discussed thus far require angler to use one hand to retain and manipulate the described tool and the other hand to retain and manipulate the hook, line, sinker, rod etc. At some point, things still seem end up in the lips or dropped. Therefore, a need exists for a rigging jig. A stable bench-like device with retainers specifically-designed to temporarily hold and orient hooks, lines, sinkers, (and other angling tools) to one-another in the work zone, without using the mouth, lips or hands.

A variety of clips, connecting links and split-rings have been developed for ‘hands-free’ attachment of tools at fixed locations, albeit with limited tool mobility/ease of manipulation. Retractable lanyards, commonly called ‘zingers’, have been previously developed for ‘hands-free’ mounting/attaching of angling tools (including nippers, foreceps, hook threaders, knot tools and nets) so they are easily accessed and manipulated in the work zone. A wide variety of zingers are available that pin-on, clip-on, or screw-on fishing vests/packs/waders (including Patent US875753282). Zingers keep tools from dangling randomly in the work zone, thus reducing the chance of fishing line getting tangled

Zingers are available in several weight capacities where the retraction spring tension is ‘matched’ with the tool. For example, a zinger suitable for use with a relatively lightweight nipper would not be capable of holding a net as the spring would stretch to its limit and zinger may even become detached from its mount. Likewise, the spring in a retractable lanyard suitable for use with a net may be too strong for a pair of nippers, resulting in a lot of unnecessary pulling by angler. Retractable lanyards that ‘lock’ at user-specified distances are also available (including U.S. Pat. No. 10,661,106B2). The purpose of this discussion regarding zingers is to demonstrate the wide variety available, and how they can be used to attach tools in the ‘work zone’ during rigging adjustments. However, zingers usually feature one or more connections that enable 360° rotation of attached tool and thus do not maintain proper orientation of attached tool in work zone. The invention described in this application functions properly when left-to-right orientation is maintained and free rotation provided by most zingers would result in unwanted knots and tangles.

Neck lanyards are also commonly used by anglers for ‘hands-free’ mounting/attaching of angling tools (including nippers, forceps, hook threaders, knot tools and nets) so they are easily accessed and manipulated in the work zone. A wide variety of neck lanyards have been developed. For example, simple neck lanyards that retain a single frequently-used item, such as an identification card, in a fixed and secure location (including U.S. Pat. Nos. 6,752,305B2, 5,027,477A, and 3,825,035) are used in place of a zinger to hold nippers or forceps. More elaborate neck lanyards include multiple attachment points, lure boxes, integrated retractable zingers, neck pad, lure drying patch and more (including U.S. Pat. Nos. 5,077,927A, 5,806,732A, US20100258603A1, U.S. Pat. Nos. 1,736,337A and 2,171,676A). Neck lanyards present a choking hazard and are often equipped with a safety clasp.

A lanyard with fixed length must also be compatible with the individual angler's focal length and some lanyards are too short. This is especially the case when using polarized eyewear to protect eyes from sun damage. Many anglers choose between changing to corrective glasses or squinting and holding hook at arms-length, for example, to thread it. Thus, a particular fixed-length neck lanyard may be too short for some anglers to use. Likewise, a particular fixed-length neck lanyard may be too long for younger or smaller-sized anglers and could generate unwanted tangles or get in the way when landing or releasing a fish. Adjustable neck lanyards are also available, allowing user to adjust the fixed and secure location at which connected tool is retained. The purpose of this discussion regarding neck lanyards is to demonstrate the wide variety available, and how they can be used to attach tools in the ‘work zone’ during rigging adjustments.

‘Hands-free’ retainers for temporarily holding hooks/tools have been developed for the angler. One common example of temporary hook retention is a foam or fur patch on surface of fishing vest designed for temporary retention of lures. Another example is a magnet that can be attached by Velcro or pins at a fixed location on fishing vest or hat for temporary retention of hook or other small iron-containing item (US20140026297A1, U.S. Pat. No. 6,163,889A). Hook/tool retainers have been developed to attach to fixed surface with suction cups (US20110005121A1) or pins (U.S. Pat. No. 3,012,361A). ‘Hands-free’ benchtop magnetic hook/tool retainers have also been developed (US20040232018A1).

Lure/line/sinker tackle storage devices have also been developed that mount in ‘work zone’ and utilize ‘hands-free’ line or hook retainers (including U.S. Pat. No. 10,375,943B2, 7,380,367B1, 9,545,091B2, 6,168,981B1, 7,013,596B1, US20050011108A1, U.S. Pat. Nos. 3,151,790A and 8,205,376B1). The invention described in this application temporarily retains hooks/tools in work zone during rig adjustment and is distinct from a tackle storage device.

‘Hands-free’ retainers/baskets for temporarily holding/organizing the relatively thick diameter “floating fly line” (including U.S. Pat. No. 5,542,204A, US790039262, DE10201511840663, U.S. Pat. Nos. 7,140,148B1, 6,052,936A, US20060185222A1, and U.S. Pat. No. 6,119,390A) have been developed. These retainers are designed to organize “floating fly line” and is distinct from the invention described in the current application which is designed to temporarily retain relatively thin/translucent tapered leader or monofilament fishing line (including tippet material).

‘Hands-free’ retainers for temporarily holding fishing line while adjusting terminal rig have been developed. Bench-top/mechanized devices (including U.S. Pat. Nos. 9,185,894B1, 4,871,200A, US20180064085A1, U.S. Pat. Nos. 9,474,259B2, 2,469,037A, 2,498,920A, 2,947,558A, and 4,573,719A) for tying hook-to-line and line-to-line knots are not designed to be mounted in ‘work zone’ while fishing. Rod-mounted ‘hands-free’ retainers for temporarily holding line while tying a line-to-line connection (U.S. Pat. No. 3,756,638A) have been developed. Spool dispensers have been developed (including Patents US20120111984A1 and DE10201322478163) that retain/store fishing line in work zone and are distinct from the temporary line retention during rig adjustment/knot tying described in this application. The invention described in this application is not a device for storing spools of line.

‘Hands-free’ retainers for temporarily holding fishing line and lure in ‘work zone’ for the purpose of tying knots have been developed. For example, U.S. Pat. No. 7,568,738B1 describes a multi-functional tool that attaches to a fixed location (waist belt) and retains/orients line with respect to hook. U.S. Pat. Nos. 3,606,405A and 2,713,807A describe fishline tying devices that attache to a cord lanyard and retains/orients lines and hooks with respect to one-another using clips and/or elastomeric retainers. U.S. Pat. No. 7,650,714B1 describes a device that attaches to neck lanyard and retains/rotates a hook for hook-to-line attachment. U.S. Pat. No. 3,680,750A describes a device that can be attached in work zone that also flips open similar to the invention described in this application.

Although these common angling tools (nippers, forceps, hook-eye cleaners, hook-eye threaders, hook sharpeners) have been combined in a variety of ways, to the knowledge of the inventor, a device that functions as the Angler's Rigging Jig described here is novel.

### Objects and Advantages

The term ‘jig’ has been previously used in the prior art of fishing to refer to both a type of lure using a hook with a bent/weighted shank as well as the brief up-and-down motion an angler uses to move a lure in the water. The invention described here is unrelated to the fields of weighed jig hooks or angler movement of lures in the water. However, this invention is a ‘jig’, a term used to describe a device that controls the orientation and location of other parts or tools with respect to one-another. For example, a pocket-hole jig holds a piece of wood and simultaneously guides a drill bit to make consistently accurate holes at a specified angle and depth in the wood.

Thus, this invention is best described as an Angler's Rigging Jig, used to temporarily control the orientation and location of hook, lines and sinkers with respect to one-another during assembly or adjustment of a fishing rig. The Angler's Rigging Jig can also temporarily retain ferromagnetic (iron-containing) tools/tackle (including forceps, nippers, and lure boxes) commonly used during terminal rig adjustments. This invention also functions as a hook-eye threader and device for tying hook-to-line and line-to-line knots in a controlled, step-wise manner with consistent results. Methods for hook threading, knot tying and sinker attachment are included in this application.

Anglers attach a variety of components (including hook, line, and sinker) in a variety of combinations, to place lures on, or at some specified depth below, the surface of water. The collective assembly of these components can be referred to as the ‘terminal rig’, or simply, ‘rig’. An example of a very simple rig is fishing line connected to a hook (using a suitable knot) with some bait on the hook. Modification of this rig by attaching a sinker to the fishing line (near the hook) helps angler place lure at specified depth in water. Further modification of this rig can include attachment of a bobber to line (at specified distance from sinker) helps maintain a specified depth. Common adjustments of this rig can include movement of bobber, removal of unintended knots, addition/removal of line, sinkers and lures.

A major problem for anglers is that lures, line and sinkers can be difficult to manipulate when tying knots and assembling a well-built rig. This is especially true when using a ‘fly fishing’ technique where relatively small and delicate lures, line and sinkers are often required for success. Without a spot to temporarily hold these items, anything dropped is easily lost in the wind, water, or shoreline rocks and sand. Anglers commonly perform rig modifications/adjustments in a ‘work zone’ located between nose and belly button, easily accessed by both hands, with shoulders relaxed and things in focus. The work zone is an area similar to which one would hold a book with both hands to read it.

As both hands are required for rig modifications/adjustments, the human mouth and lips are frequently used to temporarily hold hook, line and sinker. The lips are frequently used to hold line (while connected to rod and reel) such that a portion of the rig hangs in the ‘work zone’ so it can be easily manipulated/adjusted. Both hands are then used to retrieve, manipulate and stow lure boxes, sinker dispensers, and spools of line as well as operate nippers and forceps, thread hooks and tie knots etc. The lip method is also commonly used to temporarily hold other tackle including lure, additional line, and even poisonous lead-containing sinkers. As the lips are used for many rig adjustment/knot tying procedures, actions like speaking, drinking and eating are difficult or impossible.

Accordingly, several objects and advantages of the invention described in this application are as follows;
First, simple non-lip hook retainers (that allow both hands to be free) described in prior art include, pin-on, Velcro-on, clip-on foam patches, fur patches, magnets that can hold hooks temporarily that are most commonly used to dry them to prevent wet hooks from going back in storage box and rusting. These simple hook retainers are not designed to function as a retainer during rig adjustments and although may be used for holding hook while threading, it is not generally practiced. The Angler's Rigging Jig provides a strong hands-free magnetic hook retainer that also functions as retainer for iron-containing nippers and forceps.
Second, prior art includes a variety of hook threaders and hook-to-line knot tools that mechanically or magnetically retain/orient eye of hook with respect to fishing line (a simple hook to line ‘jig’). Most of these kinds of tools require a hand to hold the respective tool when performing rig adjustments. Other threaders and hook-to-knot tools have been described that attach to fishing rod. It is not easy to perform rig adjustments when line attached to rod and rod has to be held or placed somewhere to be in ‘work-zone’. The Angler's Rigging Jig provides an attachment point for connecting it to user-preferred location in ‘work zone’.
Third, bench-top mechanized prior art has been described for providing a ‘hands-free’ hook threading, hook-to-line and line-to-line knots. These devices require a bench or other stable surface for proper function, are not designed for use while outdoors, and are not mounted in ‘work zone’. The Angler's Rigging Jig provides ‘hands-free’ hook threading, hook-to-line and line-to-line orientation and connection in ‘work zone’ when properly attached to vest, waders, pack, or lanyard.
Fourth, although prior art includes a variety of line retainers designed to hold/organize the relatively thick fly line (such as a stripping basket) this is distinct from fragile monofilament. Prior art was not identified describing a simple non-lip monofilament retaining device, as they were always included as a part of a more complex tool like threader or knot tier that require a hand to hold/manipulate. The Angler's Rigging Jig provides ‘hands and lip-free’ monofilament retention and orientation in the work zone that is gentle even for the relatively small-diameter fragile tippet used in fly-fishing.
Fifth, although shot applicator tools have been developed to assist in temporary retention of sinkers when attaching to line. No prior art was found that temporarily retains sinkers ‘hands-free’ during rig adjustments as they are described as a part of a more complicated hand-held tool. When mounted properly, the Angler's Rigging Jig provides ‘hands and lip-free’ temporary retention and orientation recess for sinkers. A device for keeping poisonous sinkers out of mouths (especially kids) was one of the major drivers in the development of the Angler's Rigging Jig.

Further objects and advantages of this invention will become apparent after considering the included drawings and description.

### BRIEF SUMMARY OF THE INVENTION

In general, a jig is a device that mechanically maintains the correct positional relationship between a piece of work and a tool, or between parts of work during assembly. An Anglers Jig is a device that mechanically maintains the correct positional relationship between pieces of terminal fishing rig during assembly, as well as tools commonly used in this process. Standard pieces of terminal fishing rig include fishing monofilament, hooks, sinkers, and bobbers. Standard tools include fishing line nippers, forceps, hook-eye threaders, hook-eye cleaners and hook point sharpeners. The invention described in this application is a multi-functional vise designed to temporarily retain parts of a terminal fishing rig as well as iron-containing tools used during assembly/modification of rig.

The invention described in this application is a multi-functional device with retainers designed to temporarily, and simultaneously retain parts of a terminal fishing rig and assembly tools in the ‘work zone’ with respect to one-another. Standard pieces of terminal fishing rig include fishing monofilament, hooks, sinkers, and bobbers. Standard tools include fishing line nippers, forceps, hook-eye threaders, hook-eye cleaners and hook point sharpeners.

The invention described in this application is designed to expedite/streamline terminal rig procedures (such as hook threading and knot tying) but can also help reduce exposure to potentially harmful materials in hook, line or sinker (by providing an alternate temporary retention spot to the mouth/lips). Finally, the Angler's Rigging Jig works for the same for right- and left-handed anglers.

### BRIEF DESCRIPTION OF THE SEVERAL VIEWS OF THE DRAWING FIGURES

FIG. 1A. Angler's Rigging Jig Version 1 Assembled Perspective View 90° Open

FIG. 1B. Angler's Rigging Jig Version 2 Assembled Perspective View

FIG. 1C. Angler's Rigging Jig Version 3 Assembled Perspective View

FIG. 2. Jig Version 1 Assembled Perspective View 90° Open

FIG. 3. Jig Version 1 Exploded Perspective View

FIG. 4. Jig Version 1 Assembled Left Side Sectional View 90° Open

FIG. 5A. Jig Version 1 Assembled Left Side View Closed

FIG. 5B. Jig Version 1 Assembled Left Side View 45° Open

FIG. 5C. Jig Version 1 Assembled Right Side View Closed

FIG. 5D. Jig Version 1 Assembled Right Side View 45° Open

FIG. 6A. Jig Version 1 Assembled Front View Closed

FIG. 6B. Jig Version 1 Assembled Front View Open 90°

FIG. 7A. Jig Version 1 Assembled Back View Closed

FIG. 7B. Jig Version 1 Assembled Back View Open 90°

FIG. 8A. Jig Version 1 Assembled Bottom View Closed

FIG. 8B. Jig Version 1 Assembled Bottom View Open 90°

FIG. 9A. Jig Version 1 Assembled Top View Closed

FIG. 9B. Jig Version 1 Assembled Top View Open 90°

FIG. 10A. Jig Version 1′ Assembled Perspective View

FIG. 10B. Jig Version 1″ Assembled Top View Open 90°

FIG. 11A. Jig Version 1′ Adjustable connector and Cover Assemblies Exploded Perspective View

FIG. 11B. Jig Version 1′ Adjustable connector and Cover Assemblies Assembled Perspective View

FIG. 12A. Jig Version 1′ Adjustable connector and Cover Assemblies Assembled-Left Side View

FIG. 12B. Jig Version 1′ Adjustable connector and Cover Assemblies Assembled-Right Side View

FIG. 12C. Jig Version 1′ Adjustable connector and Cover Assemblies Assembled-Front View

FIG. 12D. Jig Version 1′ Adjustable connector and Cover Assemblies Assembled-Back View

FIG. 12E. Jig Version 1′ Adjustable connector and Cover Assemblies Assembled-Top View

FIG. 12F. Jig Version 1′ Adjustable connector and Cover Assemblies Assembled-Bottom View

FIG. 13A. Jig Version 1″ Adjustable connector and Cover Assemblies Exploded Perspective View

FIG. 13B. Jig Version 1″ Adjustable connector and Cover Assemblies Assembled Perspective View

FIG. 14A. Jig Version 1″ Adjustable connector and Cover Assemblies Assembled-Left Side View

FIG. 14B. Jig Version 1″ Adjustable connector and Cover Assemblies Assembled-Right Side View

FIG. 14C. Jig Version 1″ Adjustable connector and Cover Assemblies Assembled-Front View

FIG. 14D. Jig Version 1″ Adjustable connector and Cover Assemblies Assembled-Back View

FIG. 14E. Jig Version 1″ Adjustable connector and Cover Assemblies Assembled-Top View

FIG. 14F. Jig Version 1″ Adjustable connector and Cover Assemblies Assembled-Bottom View

FIG. 15. Jig Version 1′″ Assembled Perspective View

FIG. 16A. Jig Version 1′″ Surface Connector and Cover Assemblies Exploded-Perspective View

FIG. 16B. Jig Version 1′″ Surface Connector and Cover Assemblies Assembled-Perspective View

FIG. 17. Jig Version 1′″ Surface Connector and Cover Assemblies Assembled-Left Side Sectional View

FIG. 18A. Jig Version 1′″ Surface Connector and Cover Assemblies Assembled-Left Side View

FIG. 18B. Jig Version 1′″ Surface Connector and Cover Assemblies Assembled-Right Side View

FIG. 18C. Jig Version 1′″ Surface Connector and Cover Assemblies Assembled-Front View

FIG. 18D. Jig Version 1′″ Surface Connector and Cover Assemblies Assembled-Back View

FIG. 19A. Jig Version 1′″ Surface Connector and Cover Assemblies Assembled-Top View.

FIG. 19B. Jig Version 1′″ Surface Connector and Cover Assemblies Assembled-Bottom View.

FIG. 20. Jig Version 1″″ Surface Connector and Cover Assemblies Exploded-Perspective View

FIG. 21A. Jig Version 1 Attachment of Additional Tool Hook Hone to Cover-Left Side View

FIG. 21B. Jig Version 1 Attachment of Hook Hone to Cover-Right Side View

FIG. 21C. Jig Version 1 Attachment of Hook Hone to Cover-Front View

FIG. 21D. Jig Version 1 Attachment of Hook Hone to Cover-Back View

FIG. 21E. Jig Version 1 Attachment of Hook Hone to Cover-Top View

FIG. 21F. Jig Version 1 Attachment of Hook Hone to Cover-Bottom View

FIG. 22A. Jig Version 1 with Locking Band Assembled Left Side View

FIG. 22B. Jig Version 1 with Locking Band Assembled Right Side View

FIG. 22C. Jig Version 1 with Locking Band Assembled Front View

FIG. 22D. Jig Version 1 with Locking Band Assembled Back View

FIG. 23A. Jig Version 1 with Locking Band Assembled-Bottom View

FIG. 23B. Jig Version 1 with Locking Band Assembled-Top View

FIG. 24A. Jig Version 1 Removal of Locking Band Assembled Left Side View 45° Open View

FIG. 24B. Jig Version 1 Addition of Locking Band Assembled Left Side View 45° Closed View

FIG. 25. Jig Version 1″″′ Longer Main Body and Cover with Additional Elements-Assembled Perspective View

FIG. 26. Jig Version 1″″″ Longer Cover with Double Hinge and Magnifying Assembly-Assembled Perspective View

FIG. 27. Jig Version 1″″″′ Surface Connector and Cover Assemblies Exploded-Perspective View

FIG. 28A. Angler's Rigging Jig Version 2 Assembled and Pin-Back Surface Connector Assembled Semi-Exploded Perspective View

FIG. 28B. Angler's Rigging Jig Version 2 Connected to Assembled Pin-Back Surface Connector Perspective View

FIG. 29. Jig Version 2 and Pin-Back Surface Connector Exploded Perspective View

FIG. 30A. Jig Version 2 Assembled and Pin-Back Surface Connector Assembled Semi-Exploded Sectional Left Side View

FIG. 30B. Jig Version 2 Assembled and Connected to Assembled Pin-Back Surface Connector Sectional Left Side View

FIG. 31A. Jig Version 2 Assembled and Pin-Back Surface Connector Assembled Left Side View

FIG. 31B. Jig Version 2 Assembled and Connected to Assembled Pin-Back Surface Connector Left Side View

FIG. 32A. Jig Version 2 Assembled and Connected to Assembled Pin-Back Surface Connector-Top View

FIG. 32B. Jig Version 2 Assembled and Connected to Assembled Pin-Back Surface Connector-Bottom View

FIG. 32C. Jig Version 2 Assembled and Connected to Assembled Pin-Back Surface Connector-Front View

FIG. 32D. Jig Version 2 Assembled and Connected to Assembled Pin-Back Surface Connector-Back View

FIG. 33A. Jig Version 2 Replacement of Elastomeric Pad with Flat Webbing Internal Single Loop-Semi-exploded Perspective View

FIG. 33B. Jig Version 2 Replacement of Elastomeric Pad with Flat Webbing Internal Single Loop-Assembled Perspective View

FIG. 34A. Jig Version 2′ Replacement of Elastomeric Pad with Flat Webbing and Replacement of Pins with Screws—Exploded Perspective View

FIG. 34B. Jig Version 2′ Fully Assembled with Flat Webbing Internal Single Loop-Perspective View

FIG. 35. Jig Version 2″ Single External Flat Webbing Loop and Use of Screws and Nuts—Exploded Perspective View

FIG. 36. Jig Version 2″ Double External Flat Webbing Loop and Use of Screws and Nuts—Exploded Perspective View

FIG. 37A. Jig Version 2″ Single External Flat Webbing Loop and Use of D-Ring—Assembled Perspective View

FIG. 37B. Jig Version 2″ Single External Flat Webbing Loop and Use of Bar-Pin—Assembled Perspective View

FIG. 37C. Jig Version 2″ Double External Flat Webbing Loop and Use D-Rings—Assembled Perspective View

FIG. 37D. Jig Version 2″ Double External Flat Webbing Loop and Use Bar-Pins—Assembled Perspective View

FIG. 38. Jig Version 2″ Double External Tubular Webbing Loops—Exploded Perspective View

FIG. 39A. Jig Version 2″ Double External Tubular Webbing Loops and Use of D-Rings—Assembled Perspective View

FIG. 39B. Jig Version 2″ Double External Tubular Webbing Loops and Use of Bar-Pins—Assembled Perspective View

FIG. 39C. Jig Version 2″ Double External Tubular Sewn Webbing Loops and Use of Bar-Pins—Assembled Perspective View

FIG. 40A. Jig Version 3 Assembled Perspective View

FIG. 40B. Jig Version 3 Assembled Perspective View

FIG. 41. Jig Version 3 Exploded Perspective View

FIG. 42. Jig Version 3 Left Side Sectional View

FIG. 43A. Jig Version 3 Assembled Top View

FIG. 43B. Jig Version 3 Assembled Bottom View

FIG. 43C. Jig Version 3 Assembled Front View

FIG. 43D. Jig Version 3 Assembled Back View

FIG. 44A. Jig Version 3 Assembled Left-Side View

FIG. 44B. Jig Version 3 Assembled Right-SideView

FIG. 45. Jig Version 3 Assembled with Single Screw Surface-Mount Assembly Exploded Perspective View

FIG. 46A. Jig Version 3 Assembled with Single Screw Surface-Mount Assembly Assembled Top View

FIG. 46B. Jig Version 3 Assembled with Single Screw Surface-Mount Assembly Assembled Bottom View

FIG. 46C. Jig Version 3 Assembled with Single Screw Surface-Mount Assembly Assembled Front View

FIG. 46D. Jig Version 3 Assembled with Single Screw Surface-Mount Assembly Assembled Back View

FIG. 47A. Jig Version 3 Assembled with Single Screw Surface-Mount Assembly Assembled Left Side View

FIG. 47B. Jig Version 3 Assembled with Single Screw Surface-Mount Assembly Assembled Right Side View

FIG. 48. Jig Version 3′ Use of Single Grommet Bumper Exploded Perspective View

FIG. 49. Jig Version 3′ Use of Double Grommet Bumper Exploded Perspective View

FIG. 50. Jig Version 3′ Use of Triple Grommet Bumper Exploded Perspective View

FIG. 51A. Jig Version 3′ Use of Single Grommet Bumper Assembled Perspective View

FIG. 51B. Jig Version 3′ Use of Double Grommet Bumper Assembled Perspective View

FIG. 51C. Jig Version 3′ Use of Triple Grommet Bumper Assembled Perspective View

FIG. 52A. Jig Version 3′ Use of Single Grommet Bumper Assembled Left Sectional View

FIG. 52B. Jig Version 3′ Use of Double Grommet Bumper Assembled Left Sectional View

FIG. 52C. Jig Version 3′ Use of Triple Grommet Bumper Assembled Left Sectional View

FIG. 53. Jig Version 3″ Use of Nuts to Mount Bumpers Exploded Perspective View

FIG. 54. Jig Version 3′″ Use of Rivets to Mount Bumpers Exploded Perspective View

FIG. 55. Jig Version 3′″ Use of Rivets to Mount Bumpers Assembled Left Sectional View

FIG. 56A. Jig Version 3 with Protective Band-Assembled Top View

FIG. 56B. Jig Version 3 with Protective Band-Assembled Bottom View

FIG. 56C. Jig Version 3 with Protective Band-Assembled Front View

FIG. 56D. Jig Version 3 with Protective Band-Assembled Back View

FIG. 57A. Jig Version 3 with Protective Band-Assembled Left Side View

FIG. 57B. Jig Version 3 with Protective Band-Assembled Right Side View

FIG. 58. Jig Version 3 with Extended Main Body and Additional Elements-Assembled Perspective View

FIG. 59. Jig Version 3 with Extended Main Body and Additional Elements-Exploded Perspective View

FIG. 60A. Jig Version 3 with Extended Main Body and Additional Elements-Left Side Sectional View

FIG. 60B. Split-shot Alignment Insert Perspective View

FIG. 60C. Split-shot Alignment Insert Top View

FIG. 60D. Hook-eye Cleaner Insert Perspective View

FIG. 60E. Hook-eye Cleaner Insert Top View

FIG. 60F. Hook-eye Threader Insert Perspective View

FIG. 60G. Hook-eye Threader Insert Top View

FIG. 60H. Thin-Top Magnetic Hook-eye Threader Two-Part Insert Perspective View

FIG. 61A. Jig Version 3 with Extended Main Body and Additional Elements-Assembled Top View

FIG. 61B. Jig Version 3 with Extended Main Body and Additional Elements-Assembled Bottom View

FIG. 61C. Jig Version 3 with Extended Main Body and Additional Elements-Assembled Front View

FIG. 61D. Jig Version 3 with Extended Main Body and Additional Elements-Assembled Back View

FIG. 62A. Jig Version 3′ with Fabricated Individual Elements Assembled Perspective View

FIG. 62B. Jig Version 3′ with Fabricated Individual Elements Assembled Left-Side Sectional View

FIG. 63A. Jig Version 3″″ with Fabricated Single Elastomer Containing Nuts Exploded Perspective View

FIG. 63B. Jig Version 3″″ with Fabricated Single Elastomer Containing Nuts and Magnets Exploded Perspective View

FIG. 63C. Jig Version 3″″ with Fabricated Single Elastomer Containing Nuts Assembled Left Side Sectional View

FIG. 63D. Jig Version 3″″′ with Fabricated Single Elastomer Containing Nuts and Magnets Assembled Left Side Sectional View

FIG. 64A. Jig Version 3″″″ Entirely Fabricated as Single Elastomer with Recesses-Assembled Perspective View

FIG. 64B. Jig Version 3″″″′ Entirely Fabricated as Single Elastomer with Magnets and Recesses-Assembled Perspective View

FIG. 64C. Jig Version 3″″″ Entirely Fabricated as Single Elastomer with Recesses-Assembled Left Sectional View

FIG. 64D. Jig Version 3″″″′ Entirely Fabricated as Single Elastomer with Magnets and Recesses-Assembled Left Sectional View

FIG. 65. Jig Version 3″″″′ Entirely Fabricated as Single Idealized Ergonomic Elastomer with Magnets and Recesses-Assembled Perspective View

FIG. 66A. Jig Version 1 Assembled Perspective View 90° Open with Spring Clip

FIG. 66B. Jig Version 1 Assembled Perspective View 90° Open with Connecting Link

FIG. 66C. Jig Version 1 Assembled Perspective View 90° Open with Carabiner Clip

FIG. 67A. Jig Version 3 Assembled Front Perspective View with Spring Clip

FIG. 67B. Jig Version 3 Assembled Front Perspective View with Carabiner Clip

FIG. 67C. Jig Version 3 Assembled Front Perspective View with Cord Ring Hitch

FIG. 68A. Jig Version 1 Assembled Perspective View Closed. How to Tie Cord Ring Hitch Step 1.

FIG. 68B. How to Tie Cord Ring Hitch Step 2.

FIG. 68C. How to Tie Cord Ring Hitch Step 3.

FIG. 68D. How to Tie Cord Ring Hitch Step 4.

FIG. 69A. Jig Version 1 Assembled Front View Closed. Attached to Adjustable-Length Safety Neck Lanyard.

FIG. 69B. Jig Version 1 Assembled Back View Closed. Attached to Adjustable-Length Safety Neck Lanyard.

FIG. 69C. Jig Version 1 Assembled Right Side View Open. Attached to Adjustable-Length Safety Neck Lanyard.

FIG. 70A. Jig Version 1 Assembled Left Side View 90° Open. Attached to Adjustable-Length Safety Neck Lanyard.

FIG. 70B. How to Tie a Sliding Cord Knot Step 1

FIG. 70C. How to Tie a Sliding Cord Knot Step 2

FIG. 70D. How to Tie a Sliding Cord Knot Step 3

FIG. 70E. How to Tie a Sliding Cord Knot Step 4

FIG. 70F. How to Tie a Sliding Cord Knot Step 5

FIG. 70G. How to Tie a Sliding Cord Knot Step 6

FIG. 70H. How to Tie a Sliding Cord Knot Step 7

FIG. 71A. How to Lengthen Adjustable-Length Safety Neck Lanyard in Work Zone. Assembled Front View Open.

FIG. 71B. How to Shorten Adjustable-Length Safety Neck Lanyard in Work Zone. Assembled Front View Open.

FIG. 72A. Jig Version 1 Assembled Top View Open 90° Adjustable Connector Perpendicular to Main Assembly

FIG. 72B. Jig Version 1 Assembled Top View Open 90° Adjustable Connector Turned Counterclockwise to turn Main Assembly to Right

FIG. 72C. Jig Version 1 Assembled Top View Open 90° Adjustable Connector Turned Clockwise to turn Main Assembly to Left

FIG. 73A. Jig Version 1 Assembled Front View with Adjustable Safety Neck Lanyard Made of Flat Webbing

FIG. 73B. Jig Version 1′″ Assembled Front View with Adjustable Safety Neck Lanyard Made of Flat Webbing

FIG. 74A. How to Tie Double-Strand Overhand Knot for Cord Attachment to a Single Point.

FIG. 74B. How to Use Cord Loop for Attachment to a Single Point Step 1

FIG. 74C. How to Use Cord Loop for Attachment to a Single Point Step 2

FIG. 74D. How to Use Cord Loop for Attachment to a Single Point Step 3

FIG. 75A. How to Tie Two Single-strand Overhand Knots Step 1 for Cord Attachment to Two Points

FIG. 75B. How to Tie Two Single Overhand Knots Step 2

FIG. 75C. How to Tie Two Single Overhand Knots Step 3

FIG. 75D. How to Tie Two Single Overhand Knots Step 4

FIG. 76. How to Attach Version 1 to Vest with cord or clip

FIG. 77. How to Attach Version 1 to Chest Waders

FIG. 78. How to Attach Version 1 to Nipper Lanyard

FIG. 79. How to Attach Version 1 to Fishing Lanyard

FIG. 80A. How to Attach Version 1′″ to a Surface

FIG. 80B. How to Attach Version 1′″ to Fishing Vest

FIG. 81. How to Attach Version 2 to Fishing Vest

FIG. 82. How to Attach Version 2 to Chest Waders

FIG. 83A. How to Attach Version 2 to Adjustable Cord Safety Lanyard

FIG. 83B. How to Attach Version 2 to Adjustable Webbing Safety Lanyard

FIG. 84A. How to Attach Version 2 to Nipper Lanyard

FIG. 84B. How to Attach Version 2 to Fishing Lanyard

FIG. 85A. How to Attach Version 3 to Adjustable Cord Safety Lanyard Front View

FIG. 85B. How to Attach Version 3 to Adjustable Cord Safety Lanyard Left Side View

FIG. 86. How to Attach Version 3 to Fishing Vest

FIG. 87A. Magnetic-Lined Tin Box with Hook Gauge and Color Chart Exploded Perspective Back Right View

FIG. 87B. Magnetic-Lined Tin Box with Hook Gauge and Color Chart Assembled Perspective Back Right View

FIG. 88A. How to use Magnetic Feature of Jig to Hold Tin Box-Front Left Perspective View

FIG. 88B. How to use Magnetic Feature of Jig to Hold Tin Box-Top View

FIG. 89A. How to use Elastomeric Slots to Hold Monofilament for Rig Adjustment front Left Perspective View

FIG. 89B. How to use Elastomeric Slots to Hold Monofilament for Rig Adjustment with Tin Box Attached to Magnets Front Left Perspective View

FIG. 90A. How to use Magnetic Feature of Jig to Hold hooks and lures

FIG. 90B. How to use Magnetic Feature of Jig to Hold Iron-containing tools like Forceps and Nippers

FIG. 90C. How to use Hook Hone

FIG. 91A. How to Place Strands of Monofilament into Elastomeric Slots Back Right Perspective View

FIG. 91B. How to Remove Strands of Monofilament from Elastomeric Slots Back Right Perspective View

FIG. 92A. How to Place Loop of Monofilament into Elastomeric Slots Back Right Perspective View

FIG. 92B. How to Remove Loop of Monofilament from Elastomeric Slots Back Right Perspective View

FIG. 93A. How to Dock Rig for Adjustment From the Left Side-Back Left Perspective View

FIG. 93B. How to Dock Rig for Adjustment From the Right Side-Back Right Perspective View

FIG. 93C. How to Thread Hook From the Right Side-Back Right Perspective View

FIG. 94A. How to Tie Monofilament to Hook Using Improved Clinch Knot Step 1-Back Right Perspective View

FIG. 94B. How to Tie Monofilament to Hook Using Improved Clinch Knot Step 2-Back Right Perspective View

FIG. 94C. How to Tie Monofilament to Hook Using Improved Clinch Knot Step 3-Back Right Perspective View

FIG. 95A. How to Tie Monofilament to Hook Using Improved Clinch Knot Step 4-Back Right Perspective View

FIG. 95B. How to Tie Monofilament to Hook Using Improved Clinch Knot Step 5-Back Right Perspective View

FIG. 95C. How to Tie Monofilament to Hook Using Improved Clinch Knot Step 6-Back Right Perspective View

FIG. 96A. How to Tie Monofilament to Hook Using Improved Clinch Knot Step 7-Back Right Perspective View

FIG. 96B. How to Remove Tag End of Knot-Back Right Perspective View

FIG. 96C. How to Apply Floatant to Fly-Back Right Perspective View

FIG. 97A. How to Attach Dropper Monofilament Step 1-Back Right Perspective View

FIG. 97B. How to Attach Dropper Monofilament Step 2-Back Right Perspective View

FIG. 97C. How to Attach Dropper Monofilament Step 3-Back Right Perspective View

FIG. 98A. How Attach Dropper Monofilament Step 4-Back Right Perspective View

FIG. 98B. How Remove Tag from Dropper Knot-Back Right Perspective View

FIG. 99A. How to Attach Dropper Hook Step 1-Back Right Perspective View

FIG. 99B. How to Attach Dropper Hook Step 2-Back Right Perspective View

FIG. 99C. How to Attach Dropper Hook Step 3-Back Right Perspective View

FIG. 100A. How to Join Two Strands of Monofilament (How to Attach Tippet-Front Left Perspective View

FIG. 100B. How to Join Two Strands of Monofilament-Back Right Perspective View

FIG. 101A. How to Join Two Strands of Monofilament with a Blood Knot Step 1—Back Right Perspective View

FIG. 101B. How to Join Two Strands of Monofilament with a Blood Knot Step 2—Back Right Perspective View

FIG. 101C. How to Join Two Strands of Monofilament with a Blood Knot Step 3—Back Right Perspective View

FIG. 102A. How to Join Two Strands of Monofilament with a Blood Knot Step 4—Back Right Perspective

FIG. 102B. How to Remove Tags from a Blood Knot—Back Right Perspective

FIG. 102C. How Dock Rig for Next Adjustment-Back Right Perspective

FIG. 103A. How to Attach Split Shot to Monofilament Step 1—Back Right View

FIG. 103B. How to Attach Split Shot to Monofilament Step 2—Back Right View

FIG. 103C. How to Attach Split Shot to Monofilament Step 3—Back Right View

FIG. 103D. How to Attach Split Shot to Monofilament Step 3—Back Right View

FIG. 103E. How to Attach Split Shot to Monofilament Step 3—Back Right View

FIG. 104A. How to Attach Split Shot to Monofilament Step 4—Back Right View

FIG. 104B. How to Attach Split Shot to Monofilament Step 5—Back Right View

FIG. 104C. How to Attach Split Shot to Monofilament Step 5—Top View

FIG. 105. How to use Forceps to Squeeze Split shot onto Monofilament

FIG. 106A. How to Attach Split Shot to Monofilament Step 6—Back Right View

FIG. 106B. How to Attach Split Shot to Monofilament Step 7—Back Right View

FIG. 106C. How to Attach Split Shot to Monofilament Step 7—Back Right View

FIG. 107A. How to use Hook Eye Cleaner to Clean Eye of hook Left Perspective View

FIG. 107B. How to use Hook Eye Cleaner-Idealized Insert Enlarged Perspective View

FIG. 107C. How to use Hook Threader to Thread Monofilament through eye of hook Perspective View

FIG. 107D. How to use Hook Threader to Thread Monofilament through Eye of Hook Enlarged Perspective View

FIG. 107E. How to use Hook Threader to Thread Monofilament through Eye of Hook Enlarged Top View (Lure not shown for clarity)

### REFERENCE NUMERALS IN DRAWINGS

150. Anglers Rigging Jig Version 1
160. Anglers Rigging Jig Version 2
170. Anglers Rigging Jig Version 3
200. Main Body
202. Cover
204. Cover Tongue
206. Main Body Groove
208. Dowel Pin
210. Unthreaded hole through groove of main body
212. Unthreaded hole through tongue of cover
214. Hinge Assembly
216. Radius
218. Rounded-over or Chamfered Edges on Main Assembly and Cover
220. Bend in Cover
222. Elastomeric bumper
224. Machine screw
226. Washer
228. Threaded hole in Surface of Main Body
229. Unthreaded hole in Surface of Main Body
230. Disc-shaped Magnet
232. Recess in Bumper
234. Disc-shaped insert
236. Flat-ring shaped insert
238. Main Assembly
240. Set screw
242. Threaded hole in cover (opposite magnet when closed)
244. Magnetic Latch Cover Assembly
246. Adjustable Connector Assembly
248. Elastomeric Tubular Bushing/Sleeve
250. Oval-shaped split-ring
252. Round-shaped split ring
254. Hole through top cover
256. Hole through side of cover
258. Spring Clip
260. Connecting link
262. Carabiner
264. Cord
266. Ring-hitch knot
268. Adjustable-length safety lanyard assembly
269. Human neck
270. Break-away safety clasp
272. Sliding cord knot
273. Points in adjustable-length lanyard cord adjacent to sliding knots
274. Double-strand Overhand Knot
276. Loop in cord
278. Single point of attachment
280. Single-strand double-overhand knot
282. Fishing vest
284. Chest waders
286. Nipper neck lanyard
288. Nippers
290. Multi-purpose fishing lanyard
292. Threaded holes on ends of main body 200′
294. Unthreaded hole through main body 200′
296. Pin
297. Two-point pin
298. Rigid backing
300. Elastomeric pad
301. Elastomeric disc
302. Pin-mount assembly
304. Surface penetrated by pins or screws
306. Hex wrench
308. Flat webbing
310. Webbing Adjustment buckle
312. Threaded holes in cover
314. Unthreaded holes in elastomeric pad and rigid backing
316. Double Screw-mount assembly
317. Single Screw-mount assembly
318. Unthreaded hole through main body
320. Knurled knob
322. Conventional surface mount D-ring
324. Eye bolt
326. Single Pin-mount assembly
328. Unthreaded holes in cover
329. Threaded holes in cover
330. Hook sharpener
332. Magnifying lens
334. Locking elastomeric band
336. Hole in webbing
338. Top Assembly
340. Machine Nut
342. Conventional D-ring
344. Conventional Locking Bar-pin
346. Tubular Flat webbing
348. Stich in webbing
350. Grommet bumper
352. Rivet
354. Protective sleeve/band
356. Fabricated split-shot holding insert
357. Central concavity in split-shot aligner
358. Fabricated hook-eye threader insert
358′. Thin iron-containing hook-eye threader insert
359. Central concavity in hook-eye threader
359′. Cone-shaped concavity in hook-eye threader
360. Fabricated hook eye cleaner insert
361. Centrally located pin in hook-eye cleaner
362. Single-piece Magnet bumper
364. Single-piece Split-shot alignment bumper
366. Single-piece Hook-threader bumper
368. Single-piece hook-eye cleaner bumper
370. Single-piece elastomer with multiple recesses and nuts
370′. Single-piece elastomer with magnets, recess and nuts
372. Single-piece fabrication including main body
372′. Single-piece fabrication including main body and magnets
374. Idealized single-piece fabrication including main body and magnets
376. Rigging box
378. Tin or other iron-containing hinged-lid box
380. Sheet magnet
382. Adhesive-backed label
384. Terminal rig
386. Standard floating or sinking Fly line (distal end of terminal rig)
388. Tag end of monofilament (proximal end of terminal rig)
388′. Tag end of additional monofilament (proximal end of hook-bend connection)
388″. Distal end of additional monofilament
390. Tapered leader
392. Nail knot
394. Monofilament fishing line or Tippet
394′. Loop of monofilament or tippet
396. Blood knot or equivalent line-to-line knot
398. Fishing fly hook lure
400. Improved Clinch Knot or equivalent line-to-hook-eye knot
400′. Improved Clinch Knot or equivalent line-to-hook-bend knot
400″. Improved Clinch Knot or equivalent line-to-hook-eye of second lure
402. Forceps or pliers
406. Elastomeric slot formed between elastomeric bumpers
408. Eye of hook
410. Wraps of monofilament
412. Loop in improved clinch knot
414. Additional Loop in improved clinch knot
416. Lubricant like saliva
418. Bend of hook
420. Floatant-water repellent liquid
422. Loop in monofilament for line-to-hook bend connection
424. Clinch knot (half-blood knot)
426. Loop in clinch knot
428. Split-shot sinker

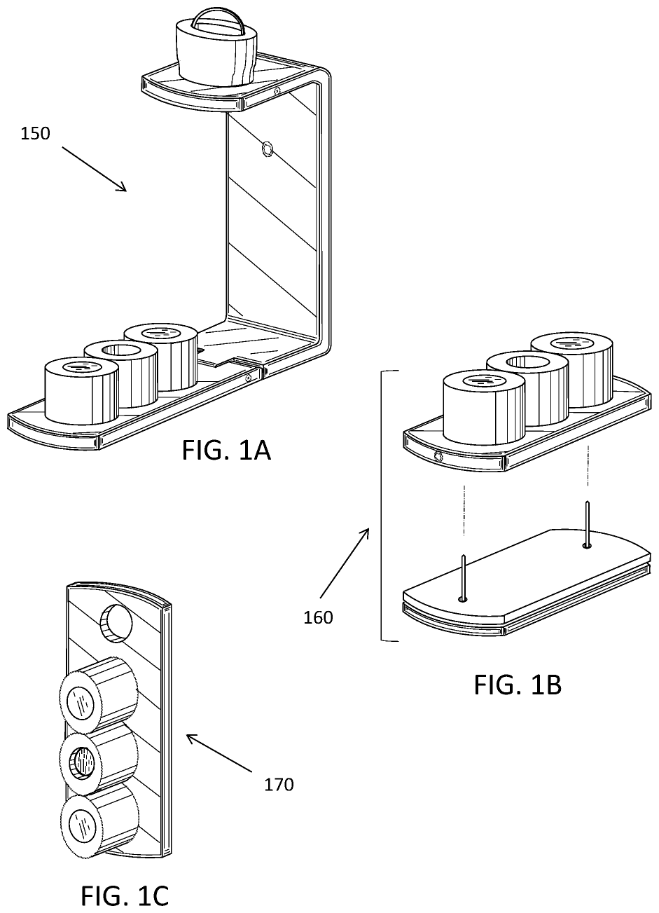

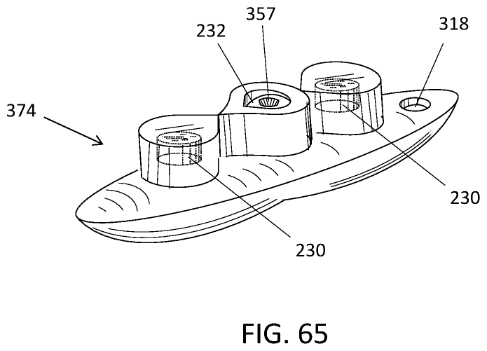

### DETAILED DESCRIPTION OF THE INVENTION (FIG. 1-FIG. 65)

The invention relates to the field of fishing, specifically devices that help anglers build and adjust a fishing rig by temporarily retaining and orienting hooks, lines, sinkers and other tools/tackle, as well as assist in tasks such as hook threading and knot tying/untying.

The invention is comprised of a rigid, flat main body the approximate width and length of an adult human thumb. To this main body, three cylindrical elastomeric recessed bumpers are individually and permanently attached with a machine screw and washer. These bumpers are attached to main body in a row, such that the sides of middle bumper slightly contact the two outside bumpers. Surfaces where bumpers contact each other create elastomeric slots that gently hold and align delicate monofilament of a variety of sizes without damaging line, and keep it out of the mouth.

The unfilled recess in middle bumper functions as a split-shot holder to keep potentially toxic sinkers out of the mouth and lips. Furthermore, terminal rig monofilament that is temporarily held in adjacent slot can be looped around and aligned with split in shot for easier attachment and removal. Cylindrical magnets are permanently affixed within recesses of both outside bumpers and function as temporary holding spots for lures and other tools commonly used to adjust terminal rig including forceps, pliers, nippers, hook threaders, knot tiers, and tin boxes.

The main body can be further attached to a cover made of the same material and width as main body and is C-shaped when viewed from side. The main body and attachments fit inside C-shape cover to protect magnets and monofilament grip slots when not in use. A set-screw is permanently inserted on inside of cover (opposite magnet attached to main body), and functions as a closure latch. One end of C-shaped cover is attached to one end of main body with a machined tongue-and-groove joint and hinge pin. This hinge enables user to ‘unfold’ main body 90° from cover like a pocket jackknife, in the ‘work zone’.

This main-body-hinged-to-cover apparatus represents the basic embodiment of one of three versions of the invention. Stored in a pocket and held in hand when making rigging adjustments provides some aid. However, hands-free operation is most efficient way to use the device, and for this reason, an adjustable connector split-ring assembly is built into C-shaped cover at end opposite hinge. This enables user to attach device to fishing vest, etc., and unfold main body 90° from cover into a bench-like surface.

Retractable lanyards are often used to attach fishing tools to a vest etc., but they are insufficient for this invention as they are too weak and do not properly maintain location or orientation in the work zone. Thus, a variety of other attachment designs are described.

A device best described as an Angler's Rigging Jig is illustrated. Although operationally similar, Jig 150 (Version 1; FIG. 1A), Jig 160 (Version 2; FIG. 1B), and Jig 170 (Version 3; FIG. 1C) differ in how they attach to a location near the anglers ‘work zone’. Description of each Version is provided including several methods for attachment of each of these Versions near the work zone. The work zone is located between nose and belly button, easily accessed by both hands, with shoulders relaxed and things in focus. The location where one would hold a book to read is where Angler performs rig adjustments and is the ‘work zone’.

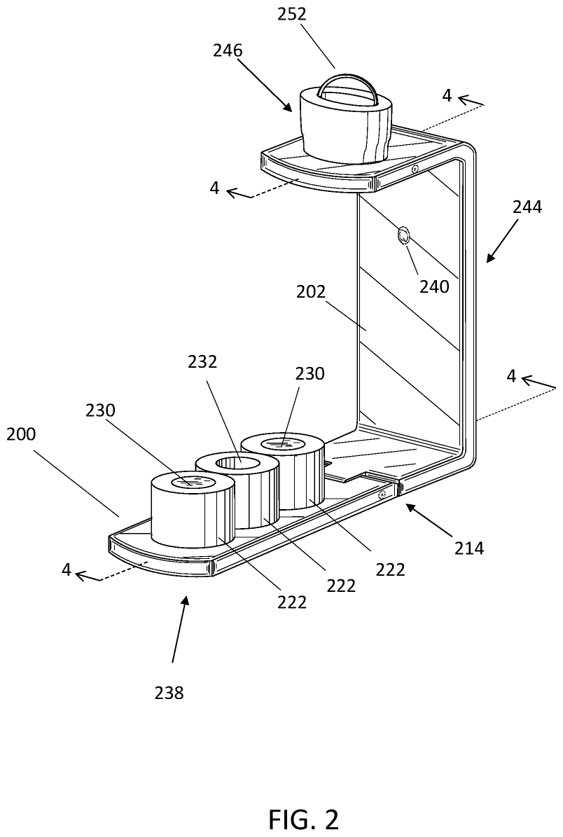

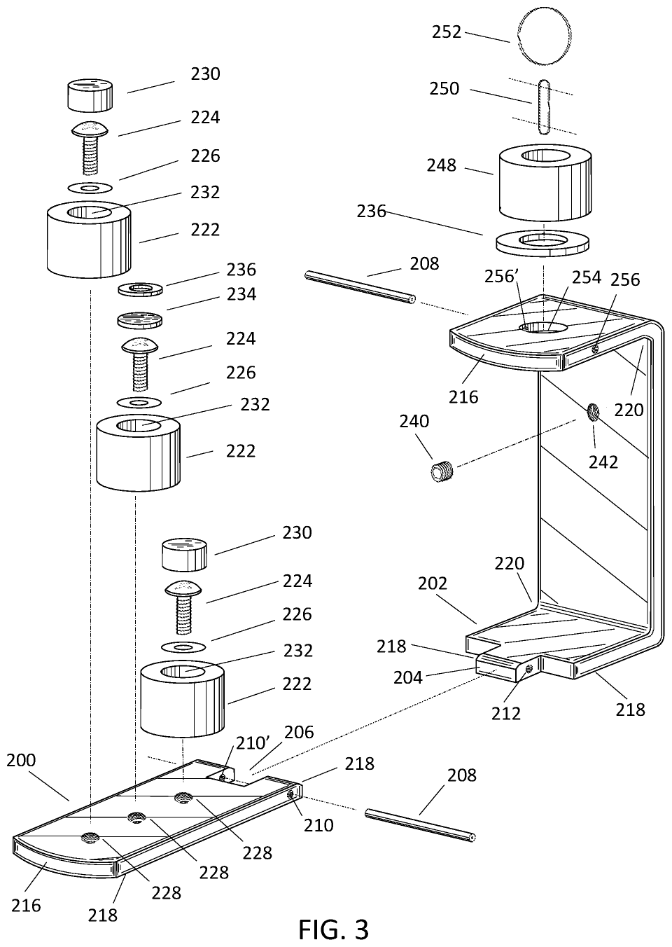

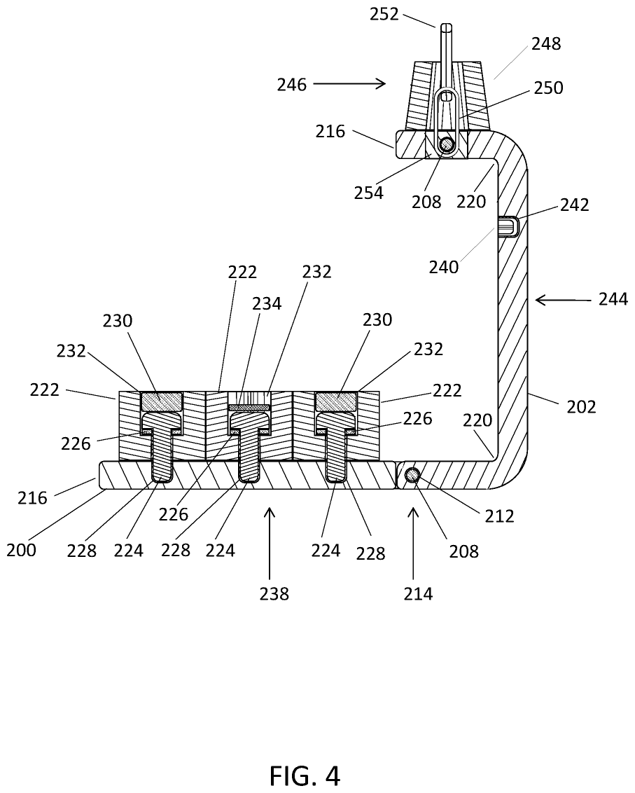

Anglers Jig 150 (Version 1) Description: A main body 200 and cover 202 are fabricated from a light-weight high-strength rigid material such as plastic, aluminum or carbon fiber but other materials may also be used (FIG. 2-FIG. 4). Main body and cover may be fabricated from different materials. Main body and cover are preferentially fabricated from material that is water-resistant, UV-resistant and capable of maintaining integrity when exposed to a wide range of weather and temperature extremes throughout an entire year. Main body and cover are preferentially fabricated from non-reflective material, or treated/covered to produce matte outer-finish to eliminate reflections that can both scare fish as well as shine into eyes of angler using the device. Main body and cover are attached to one another by a tongue 204 and groove 206 joint but other kinds of joints and attachment methods may be used.

Jig 150 (Version 1) main body 200 and cover 202 are held together using a stainless-steel dowel pin 208, although other methods may be used connect them. To connect main body and cover, a dowel pin 208 is first inserted into un-threaded hole 210 through groove of main body. Then, with cover tongue 204 and main body groove 206 properly fit together, dowel pin 208 is further inserted through un-threaded hole 212 through tongue of cover and then further inserted through hole 210′ in main body. The diameter of dowel pin is such that it fits tightly in hole and length of pin is slightly shorter than the width of main body, which allows a small amount of adhesive to be applied to outermost ends to retain pin, although other methods such as knurled end may be used to retain pin.

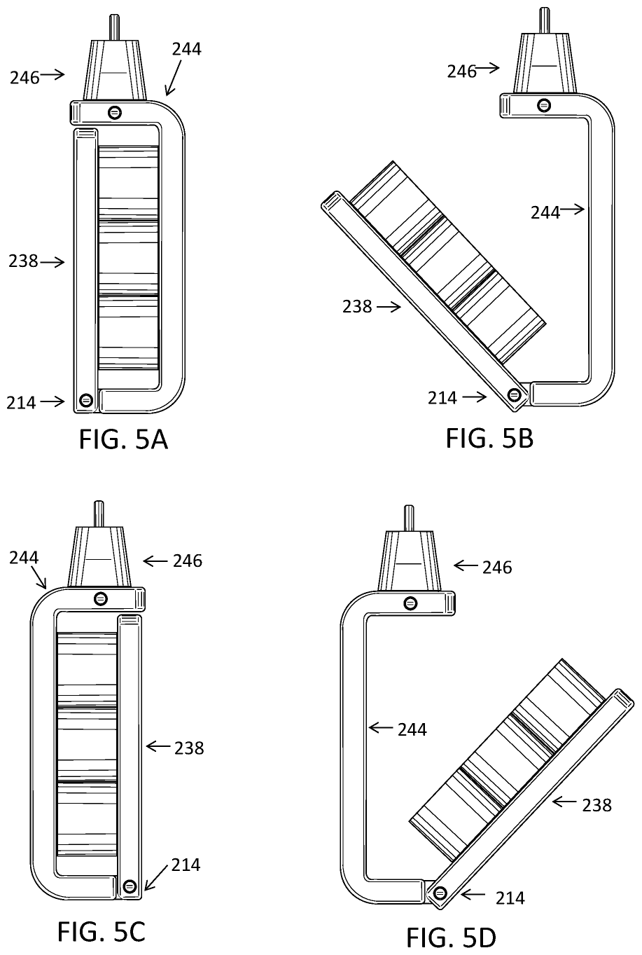

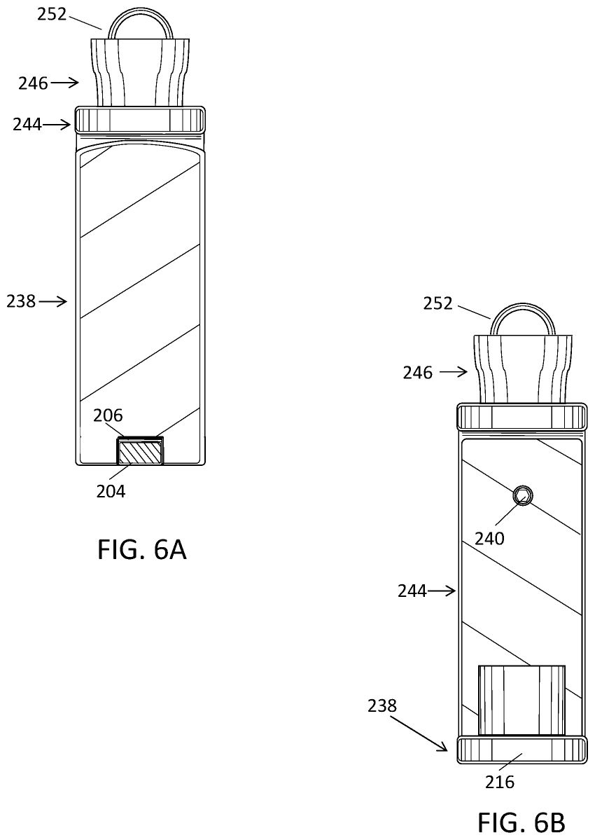

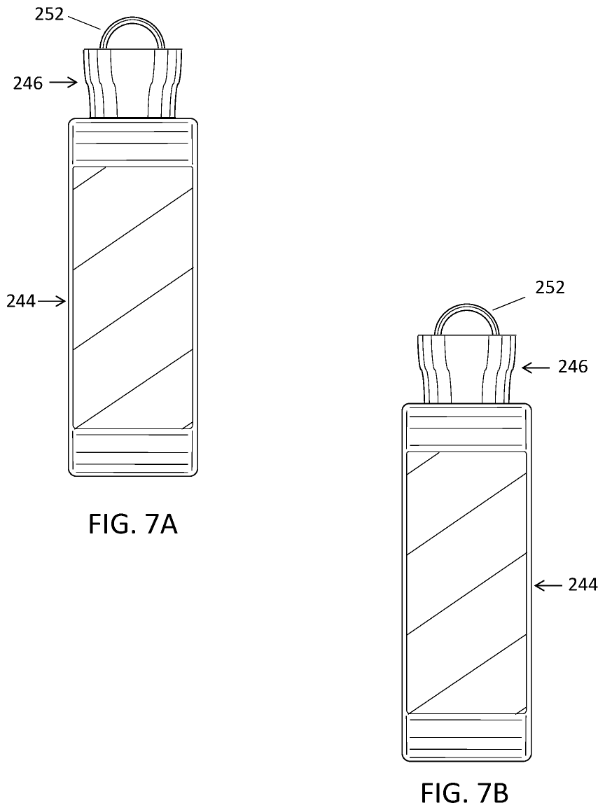

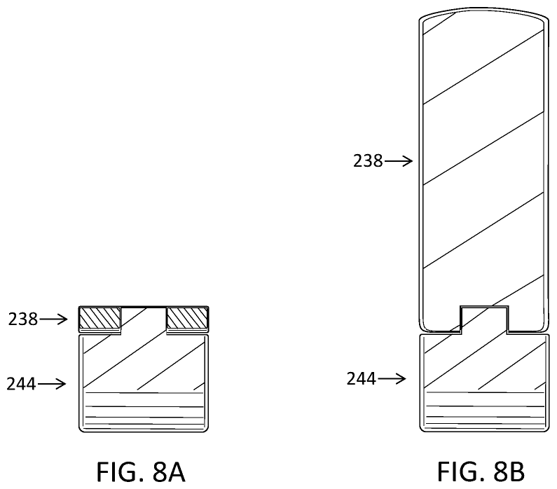

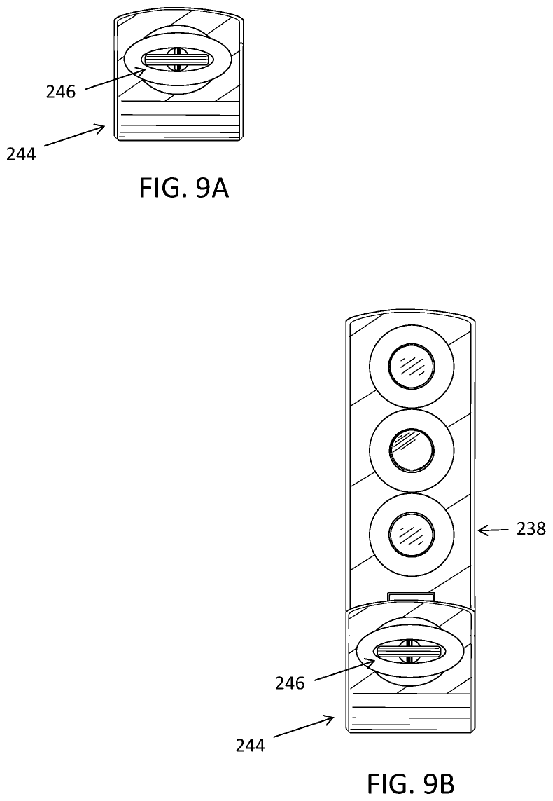

Thus, dowel pin 208 is inserted through hole 210 in main body 200 that runs contiguously with a hole 212 in cover 202. This tongue-204-groove-206-dowel-pin-208 assembly functions as a hinge 214, allowing main body (and attachments) to fold out from cover (FIG. 5-FIG. 9). The ends of both main body and cover opposite hinge are finished with a slightly rounded radius 216 and edges are slightly chamfered or rounded-over 218 although other methods may be used to finish ends and edges. Cover is C-shaped when viewed from side with approximately 90° bends 220 along width of bottom and top thus allowing main body (including attachments) to fit inside cover when folded closed. Other main body and cover shapes may also be used.

Cylindrical elastomeric recessed bumpers 222 are individually attached to the main body 200. Elastomeric bumpers are preferentially fabricated from a non-reflective material that is water-resistant, UV-resistant and capable of maintaining integrity and flexibility when exposed to a wide range of weather conditions and temperature extremes throughout the year. Bumpers are attached to main body with machine screws 224 and washers 226 although other methods of attachment may be used (see below). Permanent adhesive may be used. Alternately, individual components can be removed and replaced interchangeably by user (see below). Screw heads may be different than shown. Bumpers 222 are attached in a straight row, to threaded holes 228 in main body, such that adjacent bumpers slightly contact one-another, although other conformations may be used.

Two cylindrical disc magnets 230 are permanently affixed using epoxy or other adhesive within recesses 232 of the two outside bumpers. Magnets are preferentially fabricated from neodymium but other high-strength ferromagnetic materials may also be used. Cylindrical magnets preferentially have a non-reflective outer surface that is water-resistant, UV-resistant and capable of maintaining integrity and flexibility when exposed to a wide range of weather conditions and temperature extremes throughout the year. Cylindrical magnets fit within recesses such that they are slightly below top surface of corresponding bumper to protect the magnet, but other alignments may also be used. For example, recesses in cover could be used to ‘accept’ tools that protrude from surface of corresponding bumper. Other shaped magnets could also be used. Magnets are permanently affixed to recesses of bumpers using epoxy or other adhesive, although other methods may be used. For example, magnets fabricated with a hole can be attached using machine screws. Magnets fabricated with a hook-eye threader can also be used.

Recess 232 in middle bumper 222 does not contain a magnet. Instead, the exposed head of machine screw 224 is covered with epoxy or other adhesive. A disc-shaped and/or ring-shaped insert 234 may be placed in recess 232 that may or may not be permanently affixed within recess using adhesive. Disc 234 and ring insert 236 are preferentially fabricated from non-reflective rigid material such as metal, plastic, or rubber. Disc and ring are slightly larger than the diameter of recess. The height of disc and ring-shaped insert is such that a partial, user-adjustable recess remains in middle bumper.

The ‘main assembly’ 238 (FIG. 2-FIG. 4) is an assembly of elements that consists of main body 200 with attached elastomeric bumpers 222, disc magnets 230, machine screws 224, washers 226, disc 234 and/or ring-shaped 236 insert. Main assembly 238 may be attached to a cover, or not. Main assembly 238 may hang free or be attached to a stationary surface.

Cover 202 is attached to main assembly 238 by hinge assembly 214 (FIG. 2-FIG. 4). A set screw 240 is inserted into a threaded hole 242 on inside of cover, located opposite magnet 230 when in closed position. The attraction between magnet 230 and attached set screw 240 functions as a latch to keep main assembly 238 and cover 202 temporarily connected and closed when not in use. The cover 202 and set screw 240 are a combination of elements referred to as the ‘magnetic latch cover’ 244 assembly. Additional set screws in additional holes opposing other magnets may also be used.

Anglers Jig 150 (Version 1) Attachment Variations: An ‘adjustable connector assembly’ 246 (FIG. 2-FIG. 4) consists of an elastomeric tubular bushing 248, an oval-shaped split ring 250, a round-shaped split ring 252, washer 236, and dowel pin 208. Adjustable connector assembly 246 is constructed by first attaching round split ring 252 to oval split ring 250 such that round split-ring is located within top inside of oval ring. Then, the bottom inside of oval ring is inserted through top of elastomeric tubular bushing and further through an un-threaded hole 254 in top of cover. This attachment assembly is then permanently connected to the cover by inserting dowel pin 208 through hole 256 through side of cover and further through bottom of oval ring and further through hole 256′ in cover. The diameter of dowel pin is such that it fits tightly in hole and length of pin is slightly shorter than the width of main body which allows a small amount of adhesive to be applied to outermost ends to retain pin, although other methods may be used to retain pin. Other methods may be used to attach one or more split-rings. Rings are preferentially made of stainless steel and matte (non-reflective) finish. Elastomeric tubular bushing 248 is fabricated from same or different material as elastomeric bumper 222. Bushing may be made of other material than an elastomer.

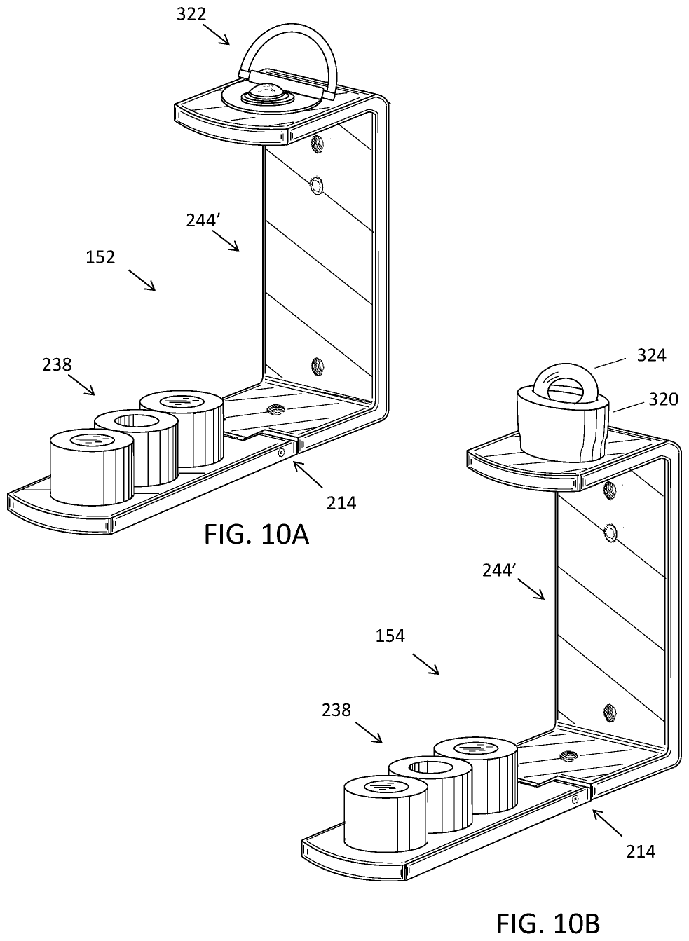

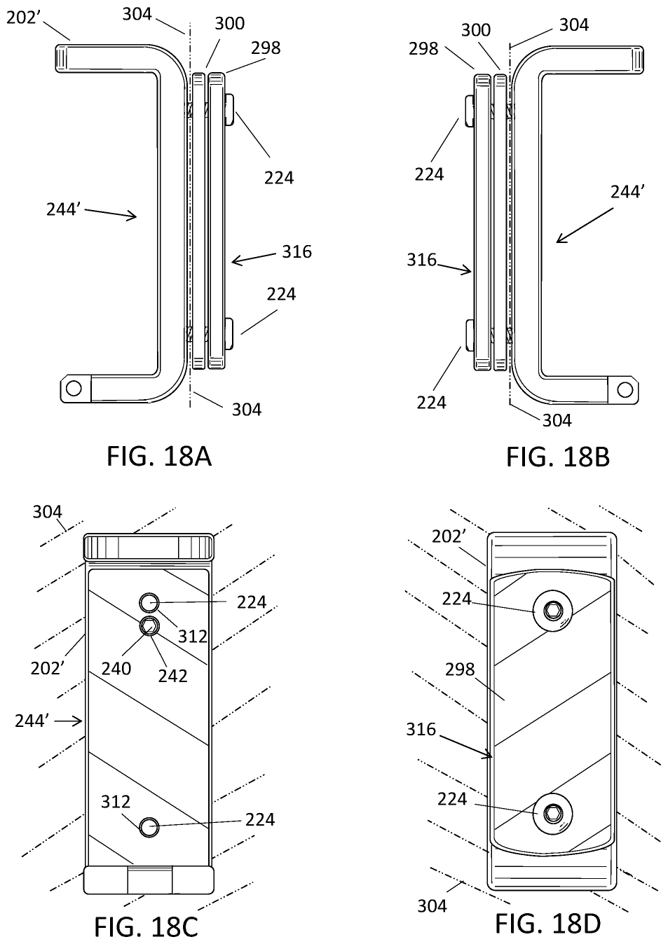

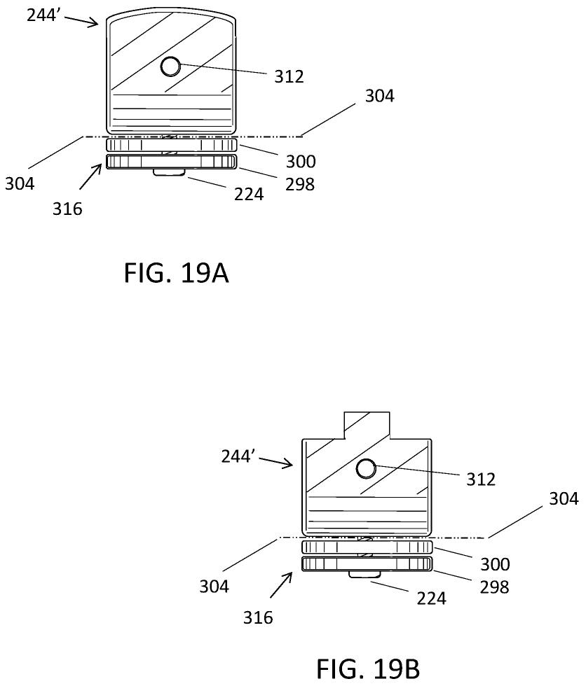

Other ways of attaching main assembly 238 near angler's ‘work zone’ to provide hands-free use can include hinge assembly 214 and magnetic latch cover assembly 244, and not include the adjustable connector assembly 246. For example, a slightly modified cover 202′ including one or more threaded holes 312 is designed to provide more ways to attach main assembly 238 near work zone (FIG. 10-FIG. 20).

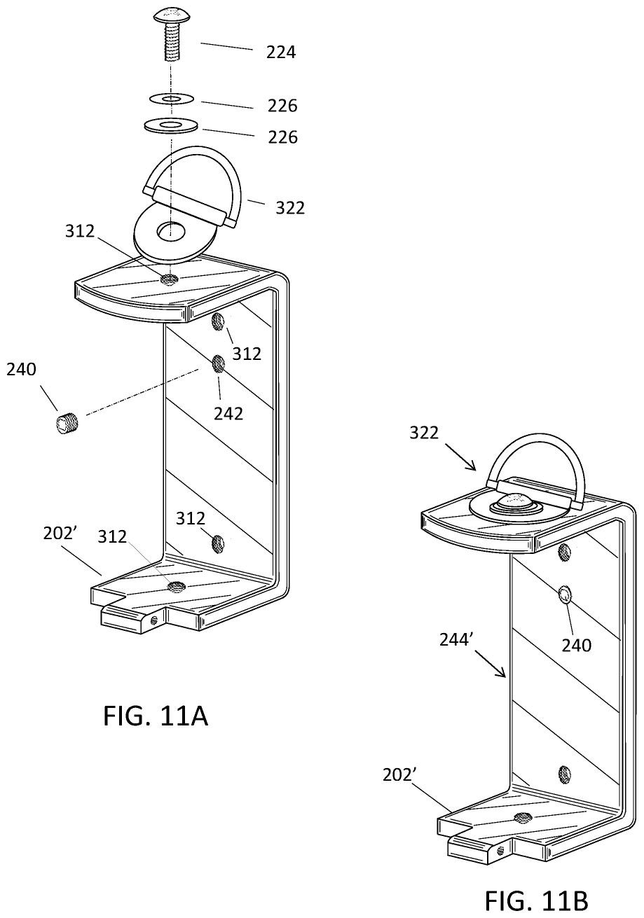

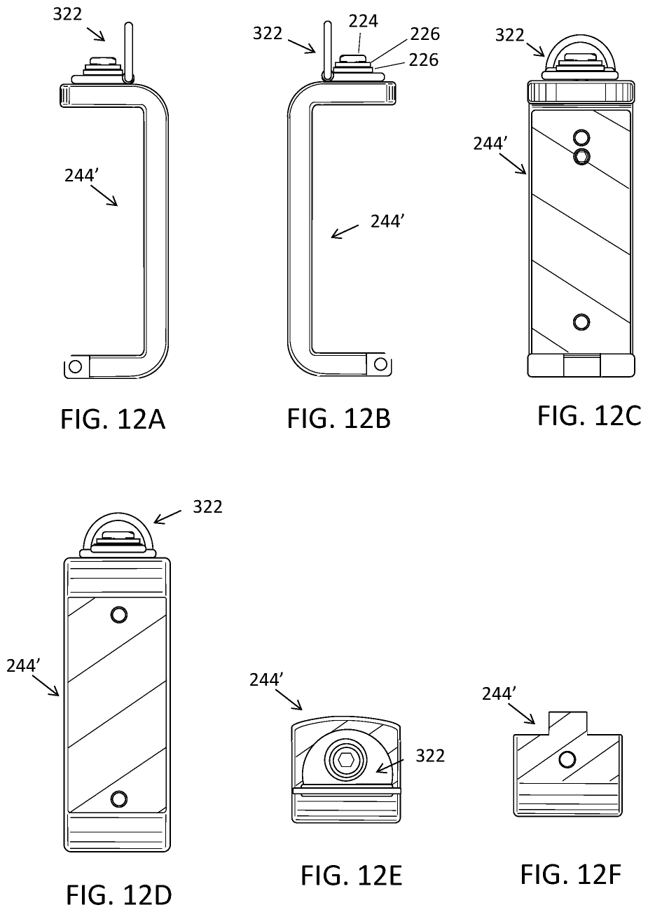

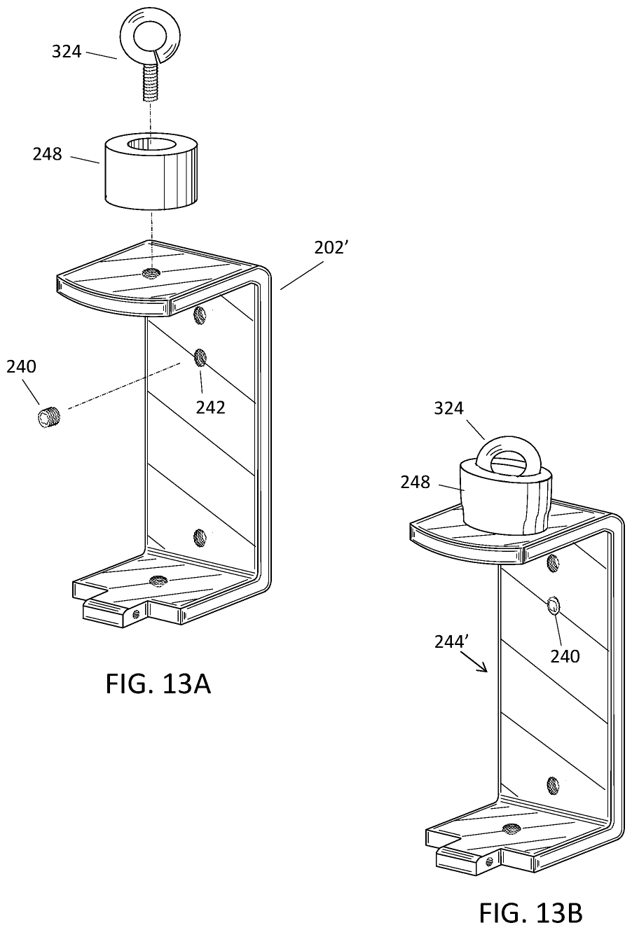

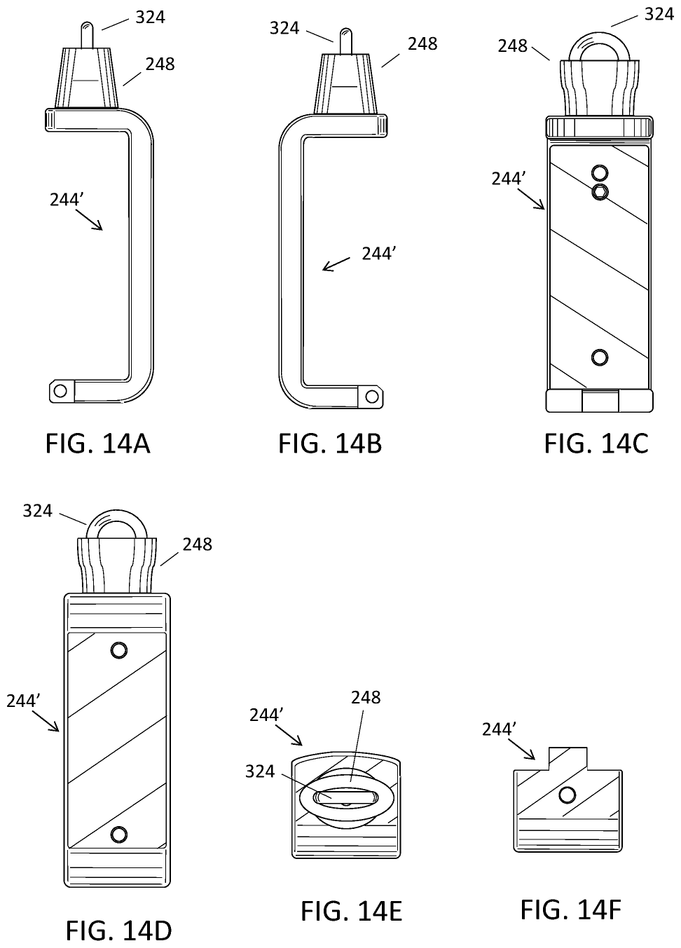

A ‘modified magnetic latch cover’ 244′ is an assembly of elements consisting of a modified cover 202′ with threaded hole 242 and set screw 240 (aligned with magnet of main assembly) and one or more holes, preferentially threaded holes 312 (FIG. 11). Modified magnetic latch cover 244′, connected to hinge assembly 214 and main assembly 238, can be attached near angler's work zone in a variety of ways. For example, a conventional surface-mount D-ring 322 can be mounted to threaded hole 312 in top of cover 244′ using screw 224 and washers 226 (FIG. 10A, FIG. 11, FIG. 12) or an eye bolt 324 and elastomeric bushing 320 can be inserted in threaded hole 312 in top of cover 244′ (FIG. 10B, FIG. 13, FIG. 14). Surface-mount ring 322 and eye bolt 324 may be shaped differently than shown. Surface-mount D-ring 322 and eye bolt 324 attach to connectors 258, 260, 262, and 264 as detailed for round-shaped split ring 252 of connector assembly 246.

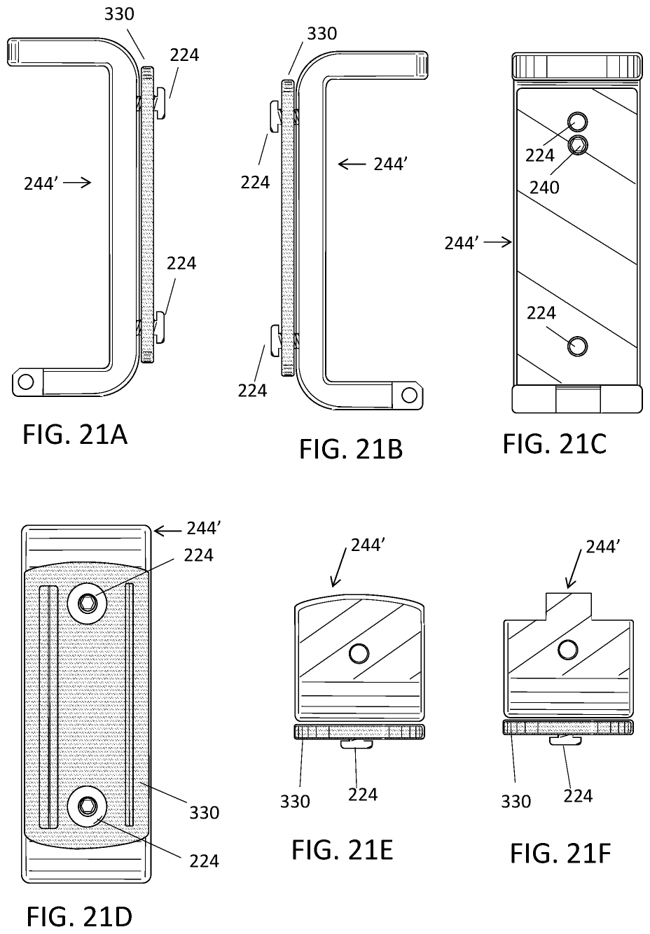

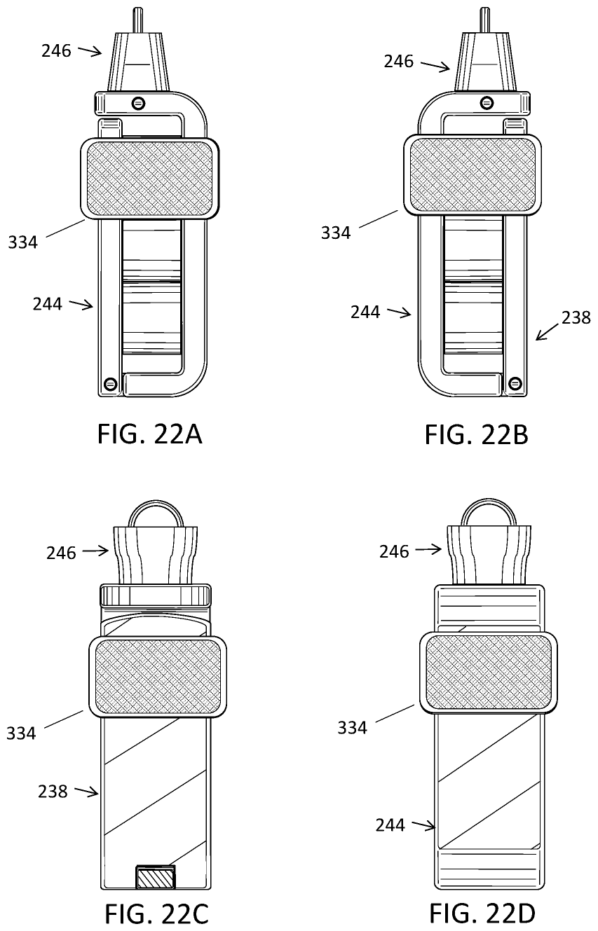

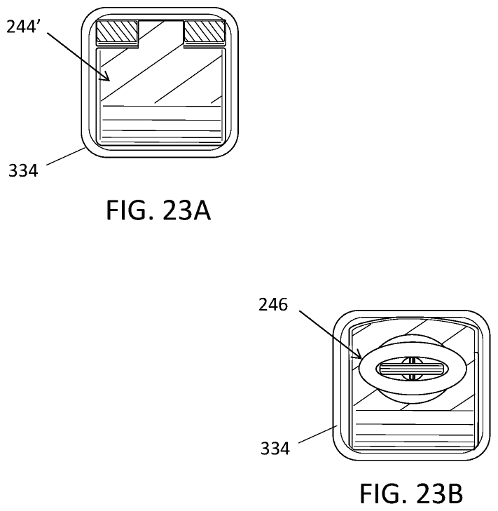

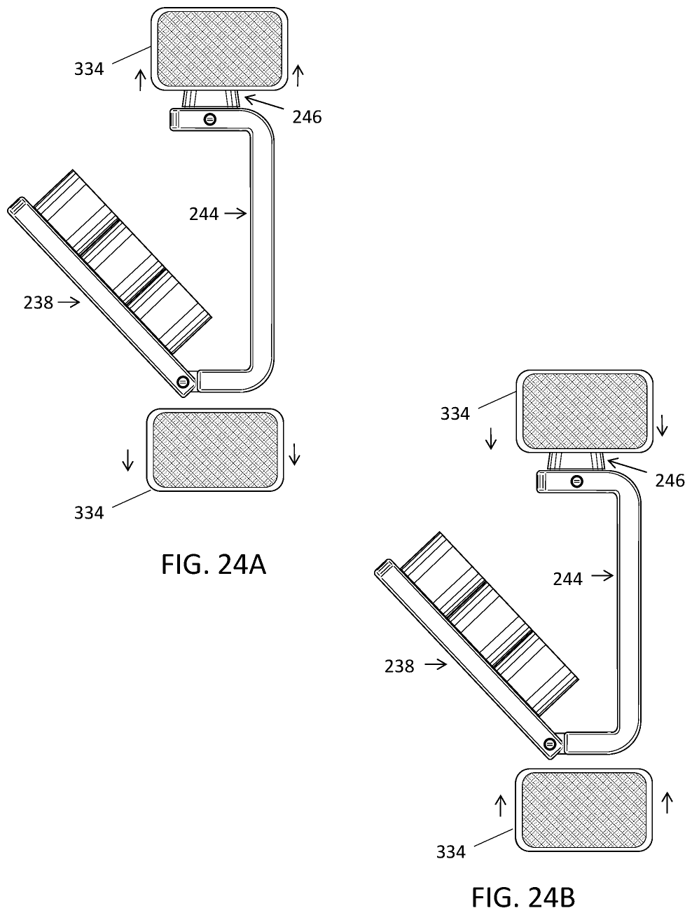

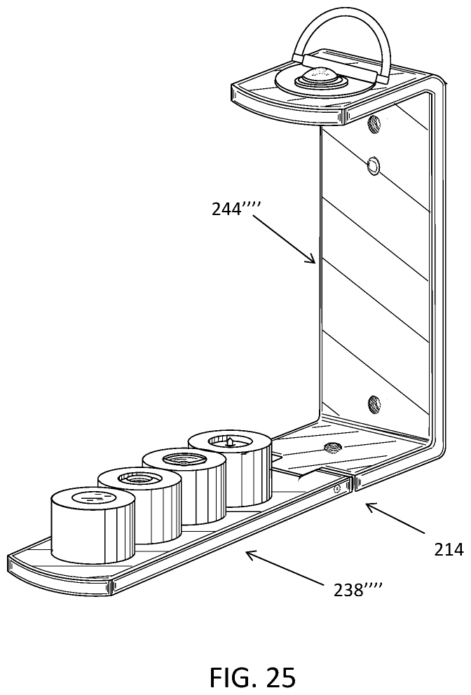

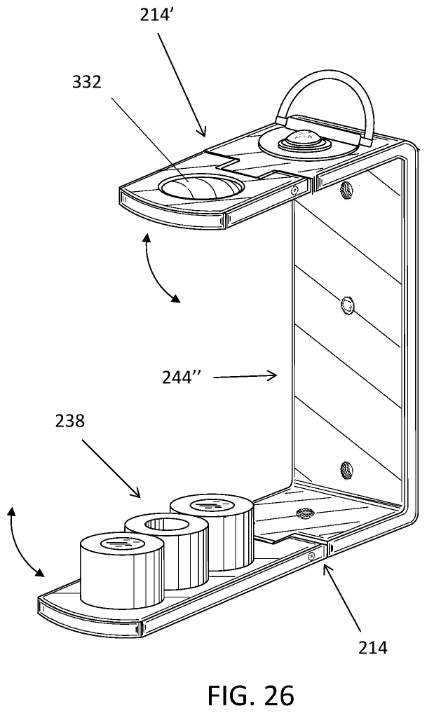

Additional holes 322 on top, side, or bottom of cover 202′ may be used for mounting other elements. For example, threaded holes 312 provide mounting points for attachment of additional angling tools including a conventional hook sharpener 330 (FIG. 21), hook-eye threader, hook-eye cleaner, nipper, forceps, sinkers, or floatant dispenser. Additional threaded holes 228 in surface of longer main body 200′″ provide mounting points for attachment of additional tools (explained in further detail below) that increase overall functionality of Jig (FIG. 25). A longer modified cover 244″″ can house an extended main assembly 238″″′ (FIG. 25). Furthermore, a longer modified cover can include a second hinge assembly 214′ for additional tools such as a magnifying lens 332 (FIG. 26). A band or sleeve made of elastomeric material can prevent Jig 150 from unintentionally opening (FIG. 22-FIG. 24).

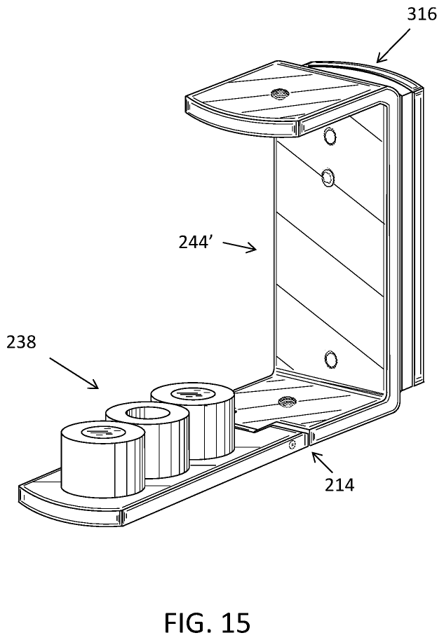

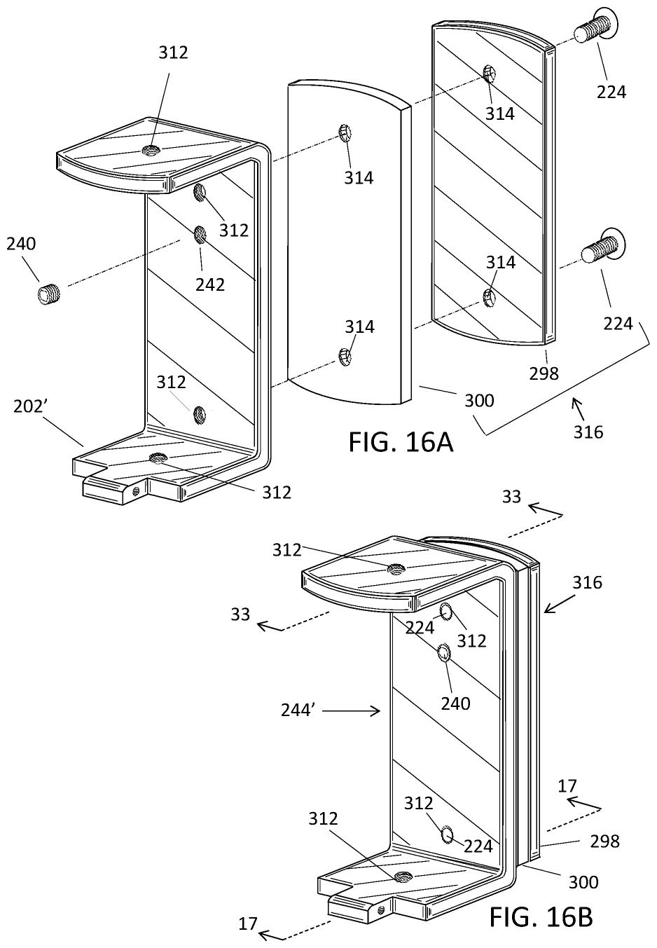

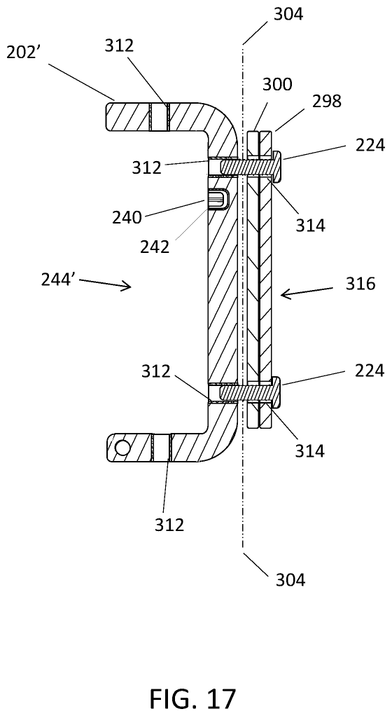

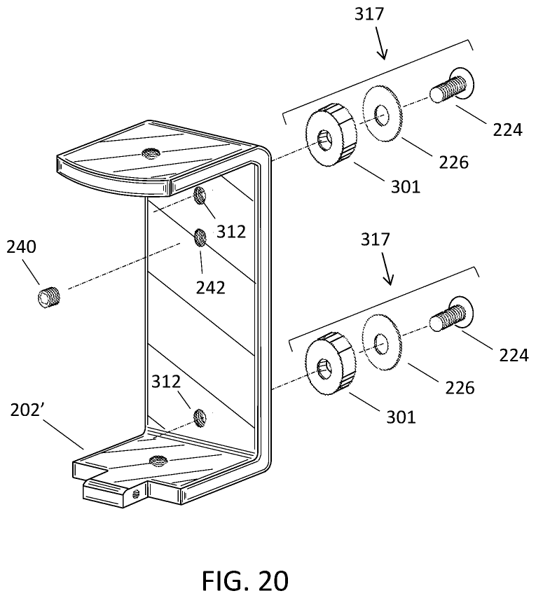

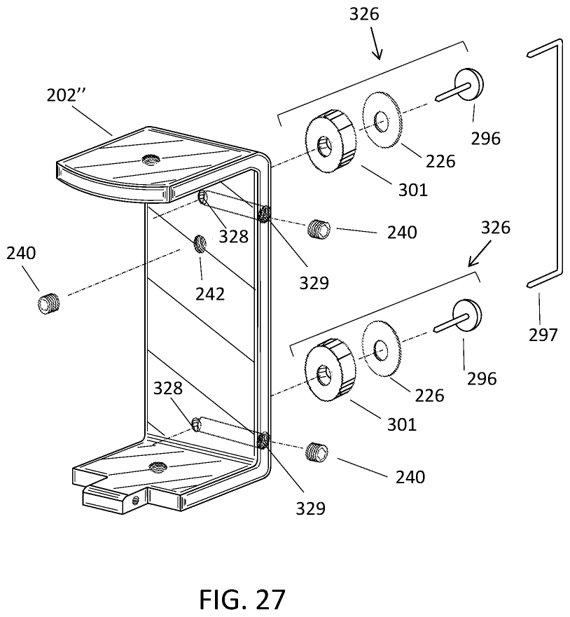

Additional holes 322 on top, side, or bottom of cover 202′ may be used for mounting to a surface location near work zone. For example, a ‘double-screw mount assembly’ 316 is an assembly of elements consisting of machine screws 224, rigid backing 298, and elastomeric pad 300 (FIG. 15-FIG. 16). Screws 224 can be slightly pointed on end for easier penetration. Rigid backing and elastomeric pad have unthreaded holes 314 aligned with threaded holes 312 in modified cover 202′. Along with hinge assembly 214 and main assembly 238, modified magnetic latch cover 244′ can be attached to surface 304 with screw mount assembly 316 (FIG. 17-FIG. 19). Assembly 316 can be replaced by ‘single-screw mount assembly’ 317 that includes screw 224, washer 226 and elastomeric disc 321 (FIG. 20). Assembly 316 can also be replaced by ‘single pin-mount assembly’ 326 when cover is slightly modified (FIG. 27). Specifically, cover 202″ includes unthreaded holes 328 aligned with threaded holes 329. Set screws 240 in threaded holes 329 will hold pins 296 for mounting to a surface. An idealized double-point pin 297, can replace pins 296 (FIG. 27).

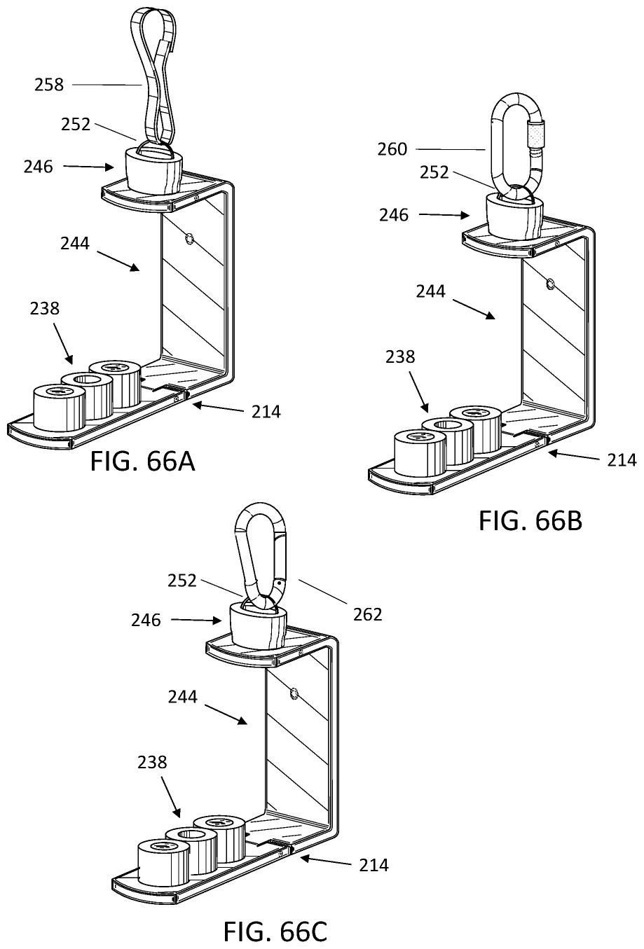

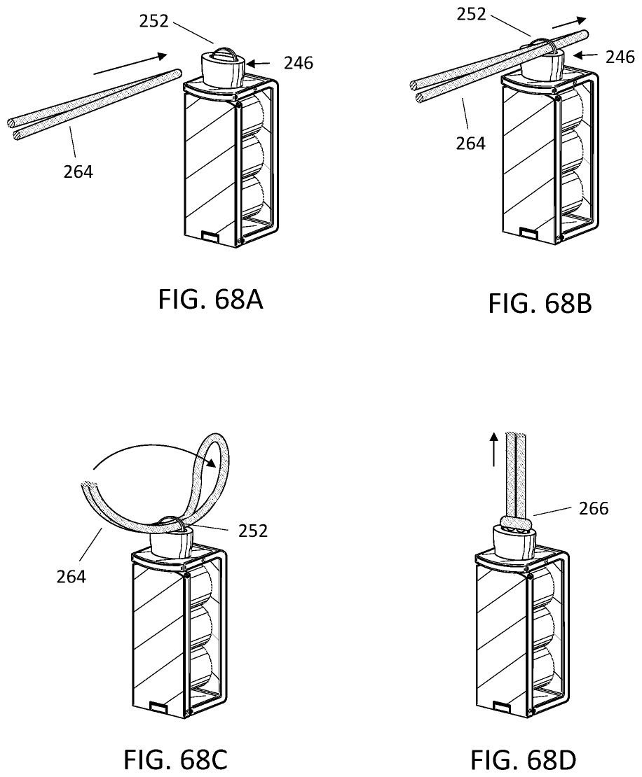

Attachment of Jig 150 to a location such that the main body opens to a horizontal bench-like surface is ideal method of use. Round-shaped split ring 252 of Jig 150 (Version 1) provides a point of attachment for spring-clip 258, connecting link 260, carabiner 262, (FIG. 66) or cord 264 (FIG. 68). Clips and cord are preferentially matte-finished weather resistant. Other clips and methods for attachment may be used. A ring hitch knot 266 is a knot that is preferred to attach cord to ring hitch as ring hitch knot 266 maintains orientation from a hanging position (FIG. 68). A combination of this round-shaped split ring 252 attachment point and the structure of overall device enables it to hang open 90° such that the main assembly 238 is parallel with the ground, like a miniature bench.

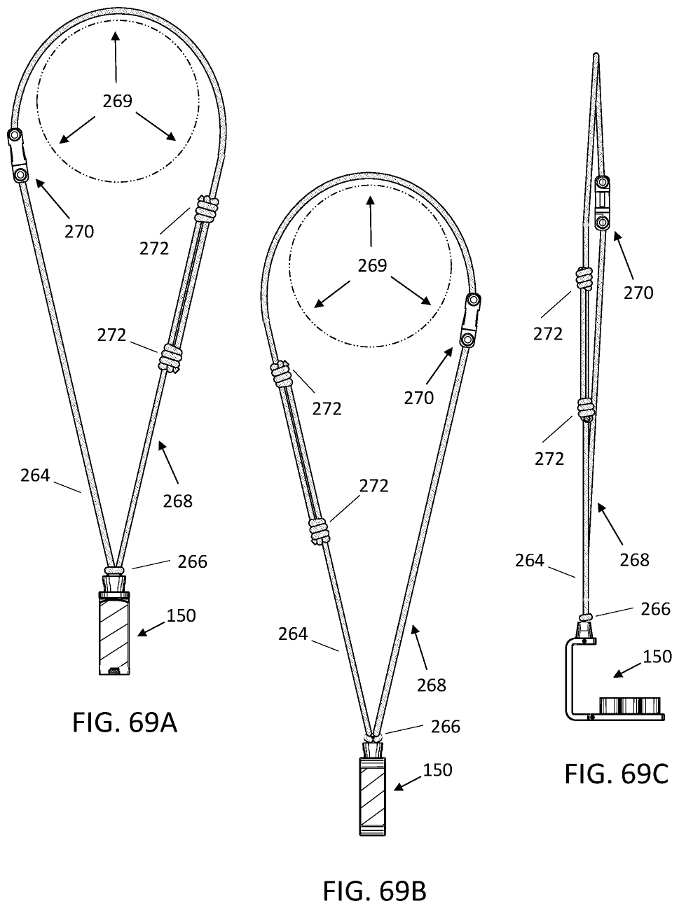

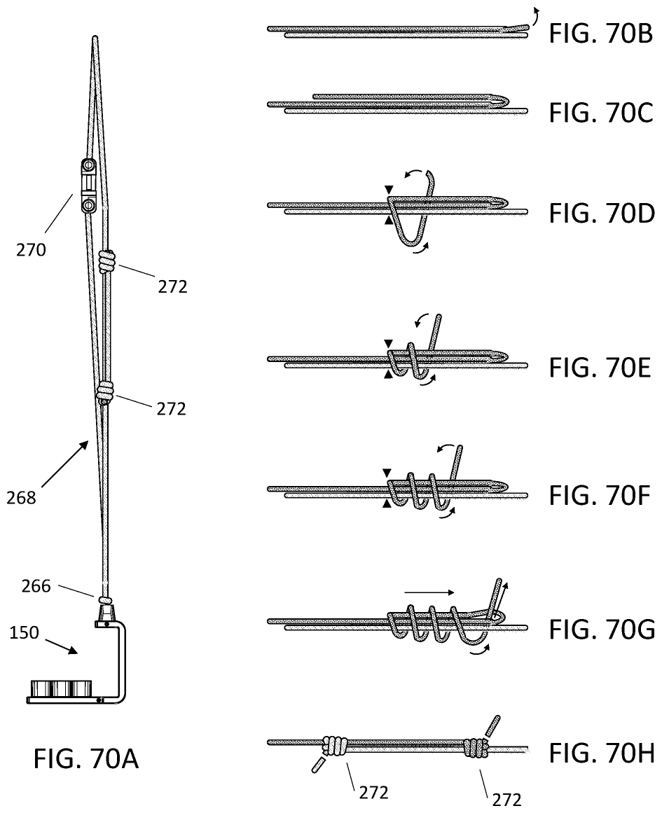

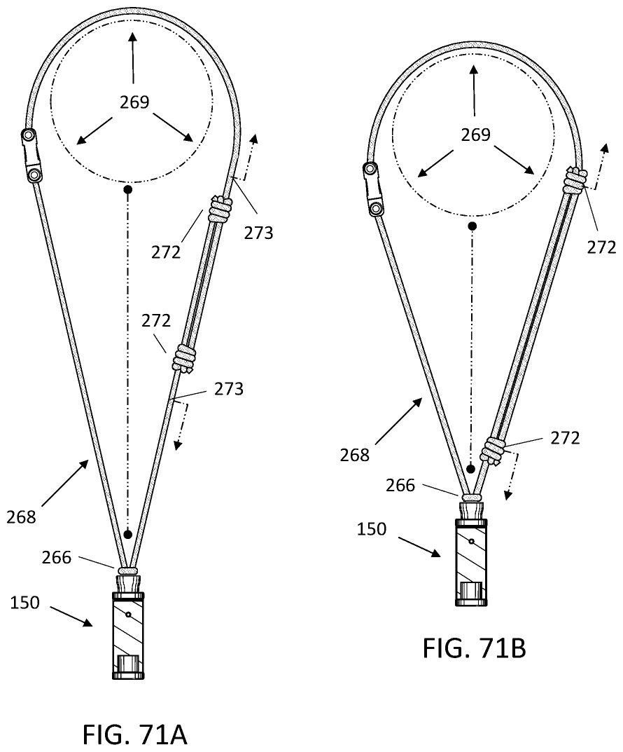

An ‘adjustable-length safety lanyard’ 268 is an assembly of elements consisting of a length of cord 264 (preferentially 550-lb paracord), a commercially-available breakaway safety clasp 270 and two sliding cord knots 272 (FIG. 69-FIG. 71). The human neck 269 is indicated. Length of lanyard 268 is increased by holding cord at points 273, and pulling apart (FIG. 71A). Length of lanyard 268 is decreased by holding cord at sliding knots 272 and pulling apart (FIG. 71B).

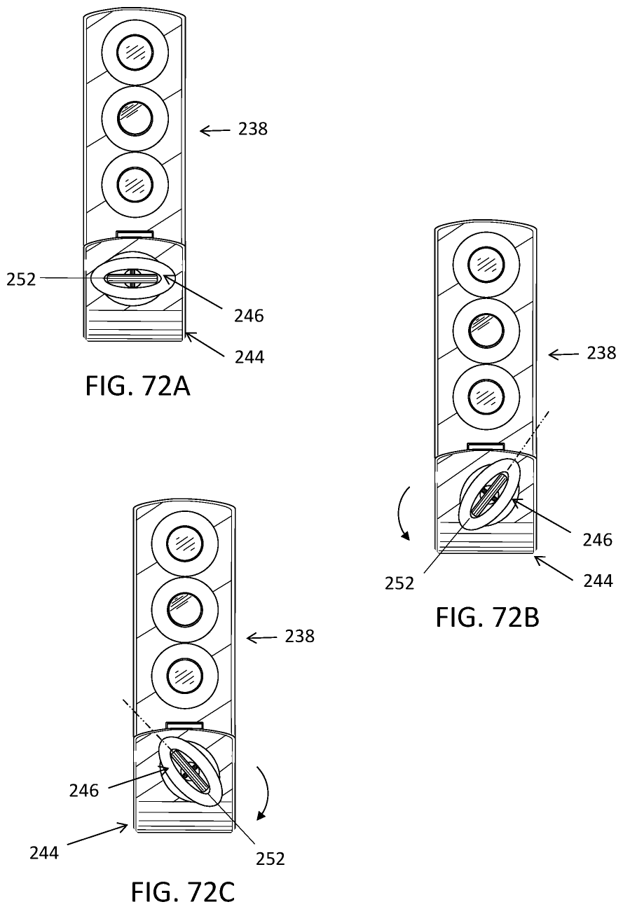

When split ring 252 on top of adjustable connector 246 is perpendicular to main assembly 238, main assembly 238 opens straight out (FIG. 72A) and is the ideal left-to-right orientation (when viewed from top) for operation of Anglers Jig 150. However, Jig 150 may not always maintain this orientation where main body 238 may open and lean to the left or right when viewed from top. This can happen when attachment point or part of equipment causes open Jig 150 to lean one way or another and results in main body 238, along with hook, line and/or sinker to become disorganized and difficult to align with one-another. Adjustable connector 246 is designed to correct this. If main assembly 238 is leaning left (counter-clockwise) when viewed from top (FIG. 72B) then rotate connector 246 in same direction (counter-clockwise). Accordingly, if main assembly 238 is leaning clockwise, then turn connector 246 clockwise to correct (FIG. 72C). Conventional surface-mount D-ring 322 (FIG. 10A, FIG. 11, FIG. 12) or eye-bolt 324 (FIG. 10B, FIG. 13, FIG. 14) combined with modified cover 202′, have similar left-right orientation correction function as connector 246.

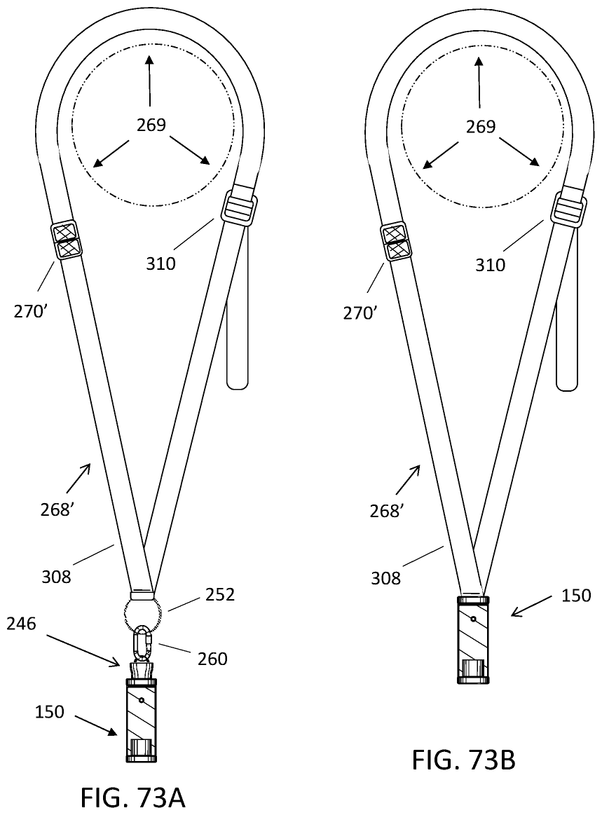

Like cord 264, flat webbing 308 can be fabricated into a modified adjustable safety lanyard 268′ where conventional webbing safety break-away buckle 270′ and conventional webbing adjustable buckle 310 can be used to place Jig in work zone (FIG. 73). Jig 150 can be mounted to webbing lanyard 268′ by adjustable connectors (FIG. 73A) and with screw-mount (316, 317) and pin-mount (326) assemblies (FIG. 73B).

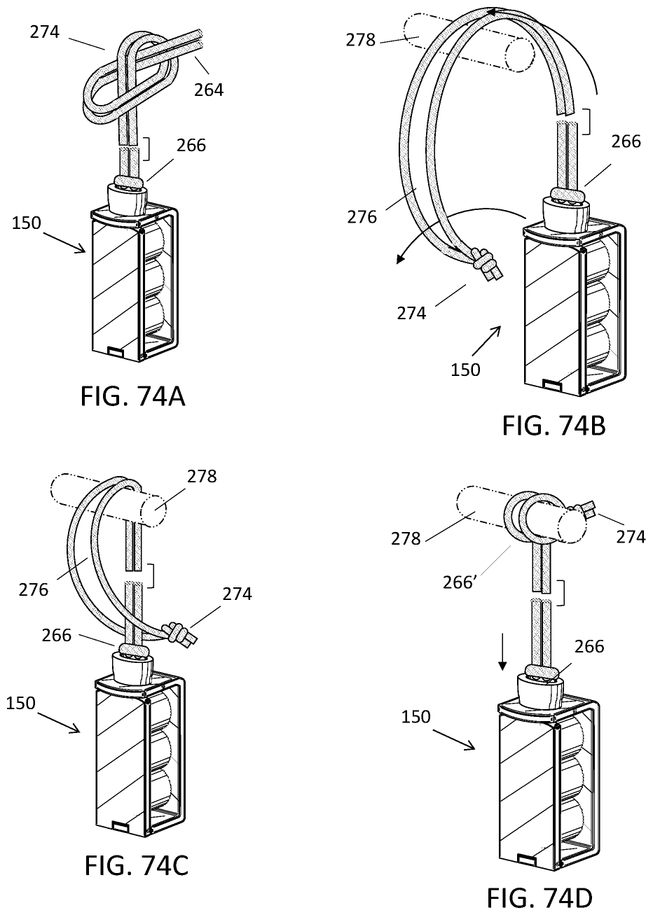

Cord can be used in other ways than an adjustable-length safety lanyard. For example, a length of cord tied to round-shaped split ring 252 with ring-hitch knot 266 can then be attached to a single point 278 by tying a double-strand overhand knot 274 in end of cord, resulting in a loop 276 (FIG. 74). This loop in cord 276 can then be used to attach to single point 278 with a hitch knot 266′ (FIG. 74). Ring-hitch knot 266 and point-hitch knot 266′ are essentially the same knot but are distinguished here to clarify their independent use of attachment to round split-ring 252, or single point 278, respectively. Single point 278 is any solid point of attachment that near angler's ‘work zone’. Examples of solid points include d-ring, sewn loop, o-ring, belt loop, strap, or other hitch spot on gear that is worn by angler or not worn, but in close proximity such as a chair rail, bucket handle, boat frame/railing.

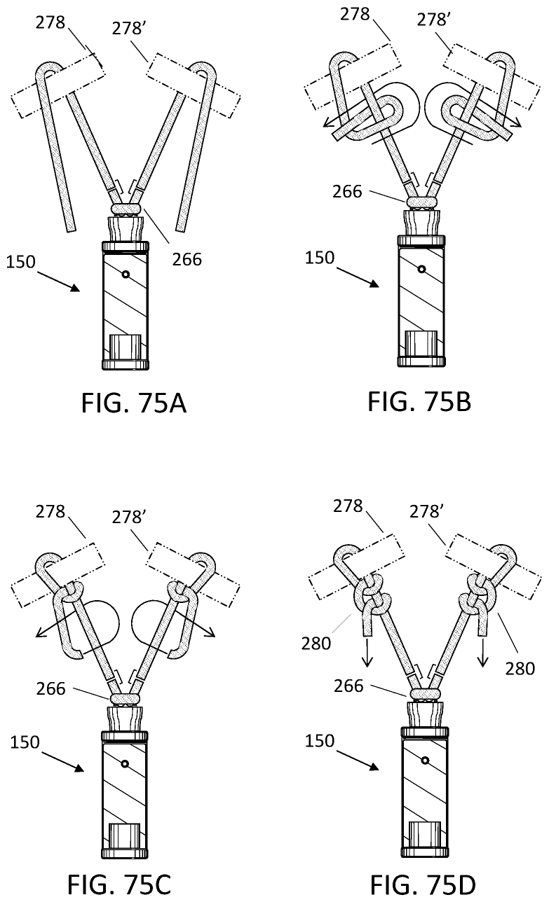

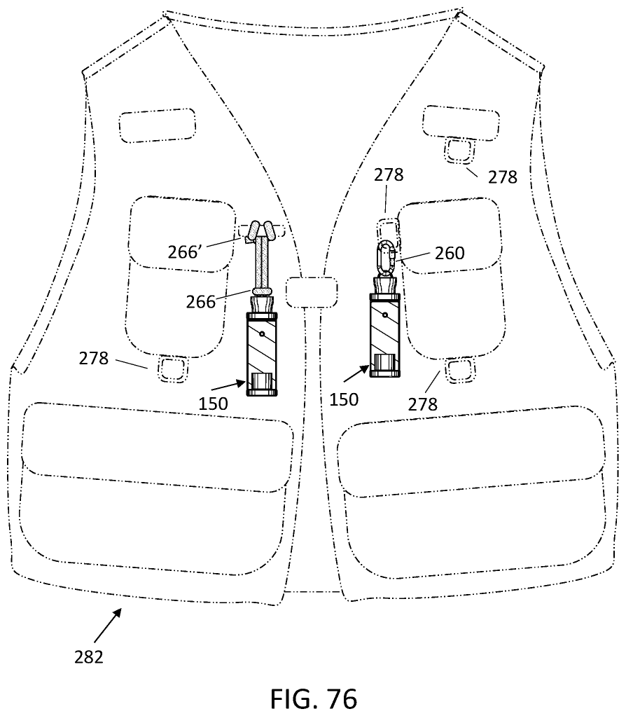

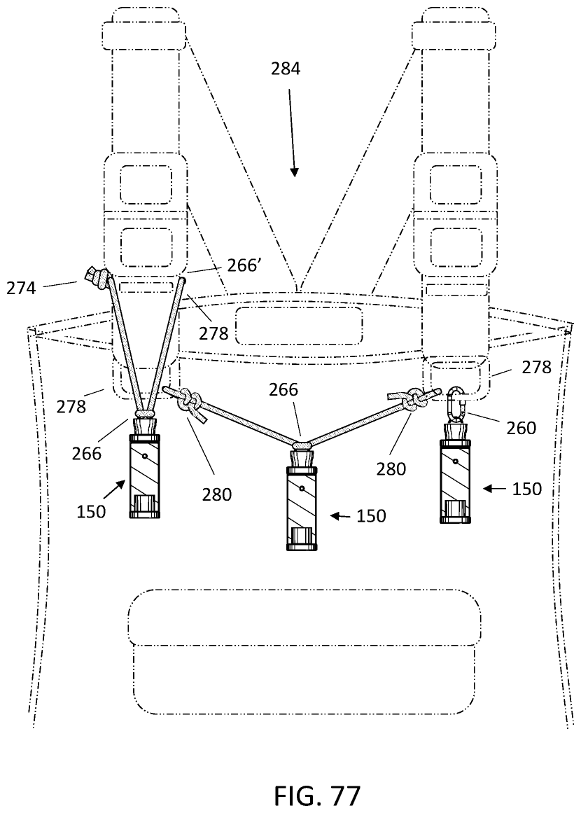

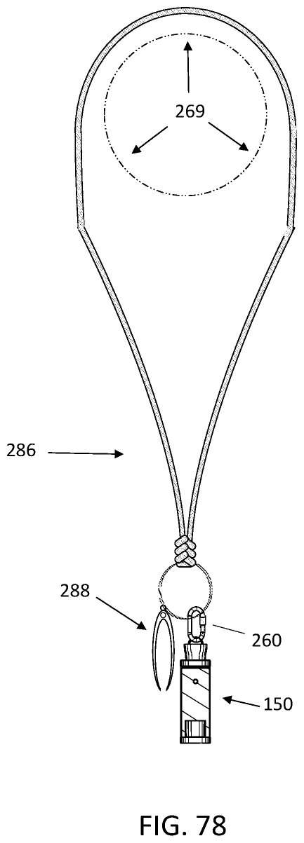

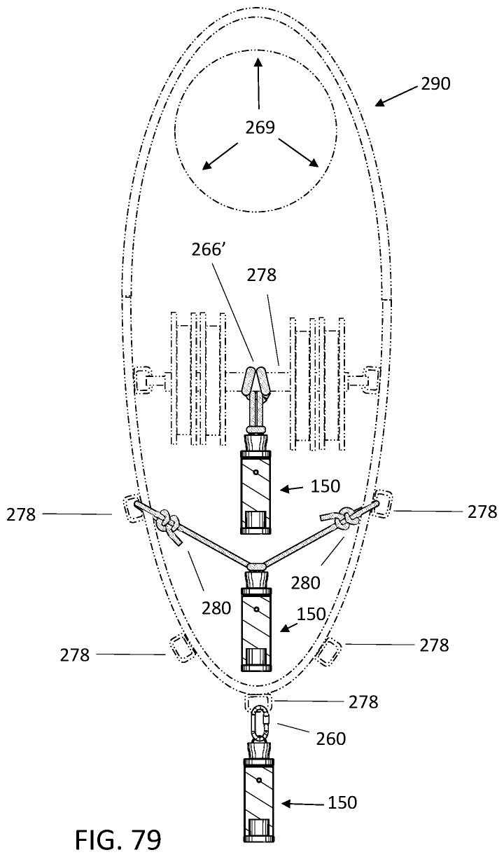

Another method for using cord is by attaching to two single points, 278, 278′ using a single-strand double-overhand knot 280 at each point (FIG. 75). Other knots may be used to attach cord to one or more points. For example, using two sliding cord knots 272 in loop 276 provides adjustable length when attached. Examples of some single-point and double-point attachments to a standard fishing vest 282 (FIG. 76), chest waders 284 (FIG. 77), conventional nipper neck lanyard 286 (FIG. 78), and conventional multi-purpose fishing lanyard 290 (FIG. 79) are shown.

A connector that enables angler to move Jig around in work zone has advantages. For example, clips (258, 260, 626), cord (264), and neck lanyards (268, 268′) allow increased range of motion. This can be advantageous for many rig adjustments as Jig and attached components can be easily moved into focus, into right lighting, out of rain, tilted and rotated freely to align hook, line, and sinker with one-another.

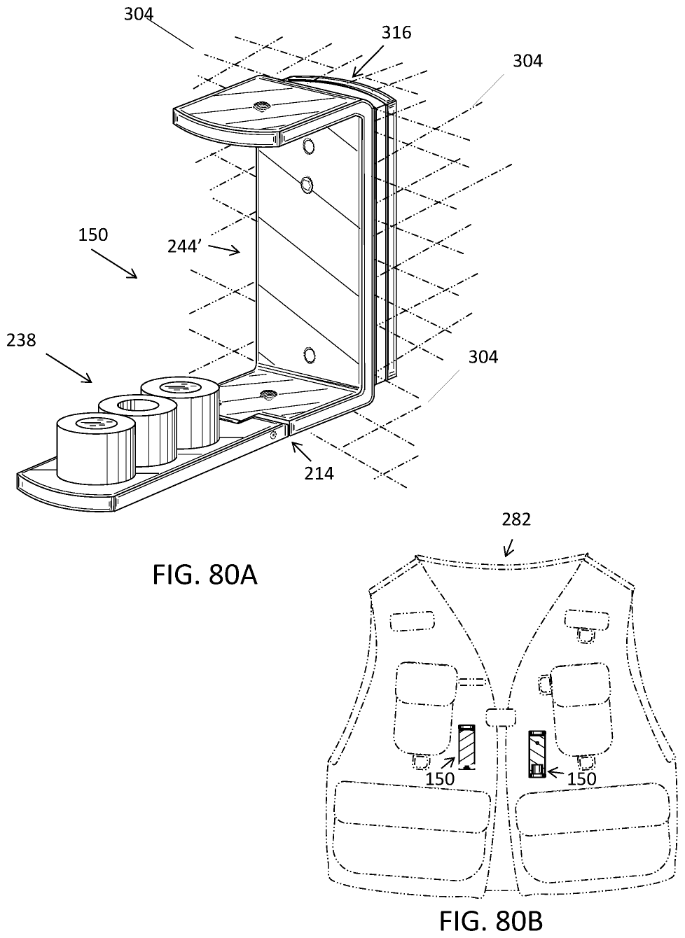

However, some anglers may find it more beneficial if Jig was somehow fastened to a surface. Double-screw assembly 316 (FIG. 15-FIG. 19) single screw assembly 317 (FIG. 20) and pin-mount assembly 326 (FIG. 27) are methods for connecting Jig 150 to surface 304 capable of penetration by screws or pins (FIG. 80A), including fishing vest 282 (FIG. 80B) and flat or tubular webbing (FIG. 73B).

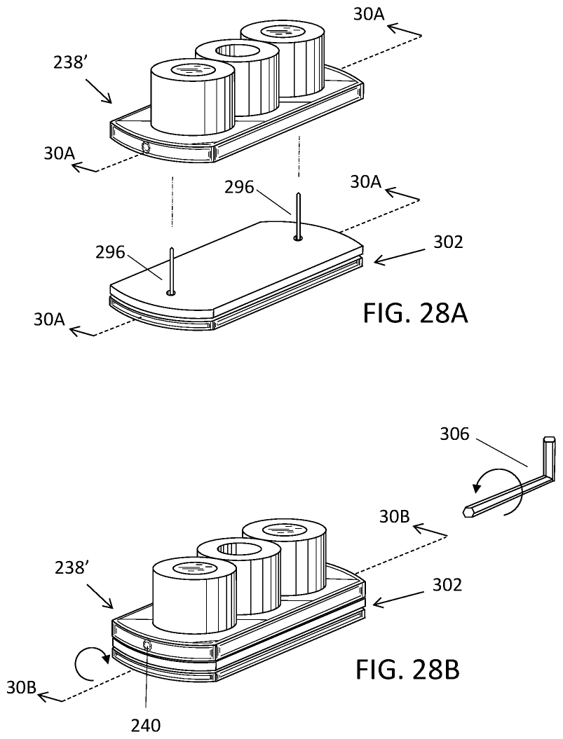

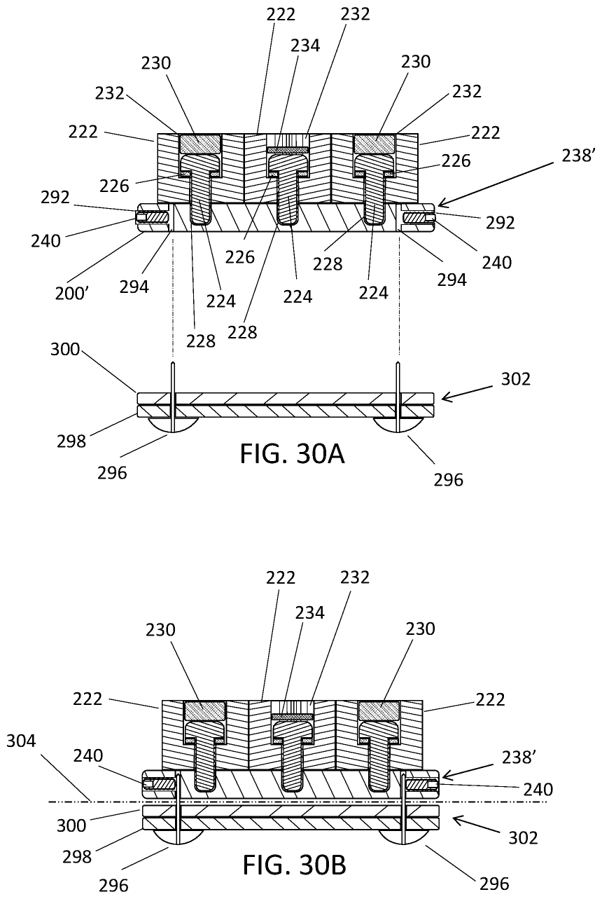

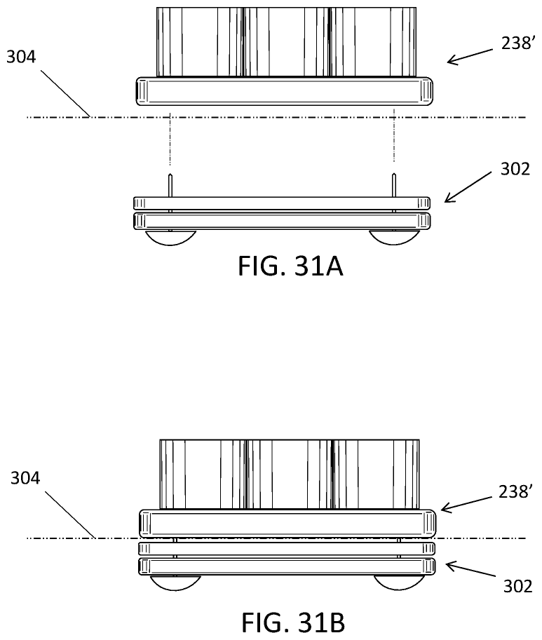

Anglers Jig 160 (Version 2). Other ways of attaching main assembly 238 near angler's ‘work zone’ to provide hands-free use may not include hinge assembly 214, magnetic latch cover assembly 244, or adjustable connector assembly 246. For example, a slightly modified main body 200′ can provide a means of mounting main assembly to surface 304 (FIG. 28-FIG. 32). Jig 160 (Version 2) is basically an uncovered Jig 150 (Version 1) main assembly mounted directly to surface 304, or used with cord and/or webbing to provide a variety of additional ways to connect to surface 304 and attachment points 278.

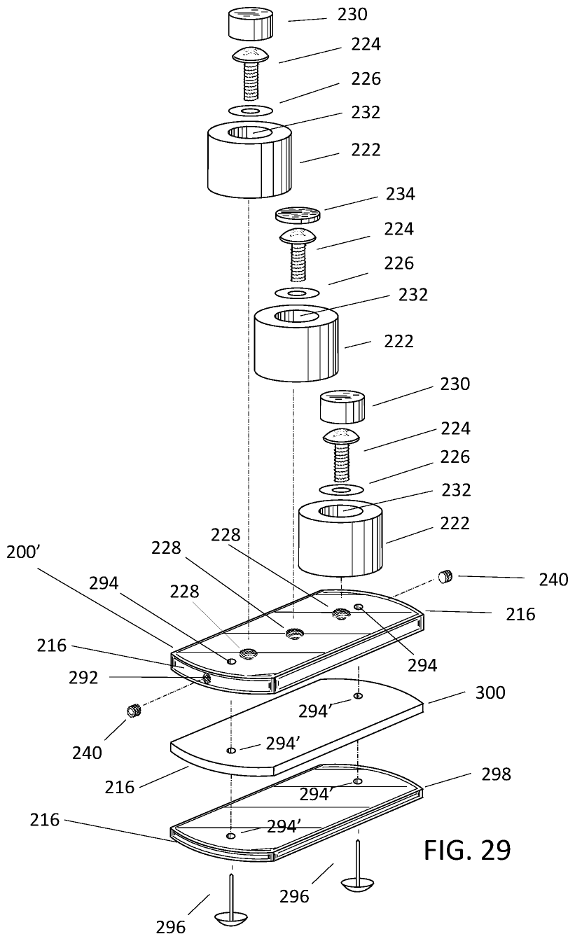

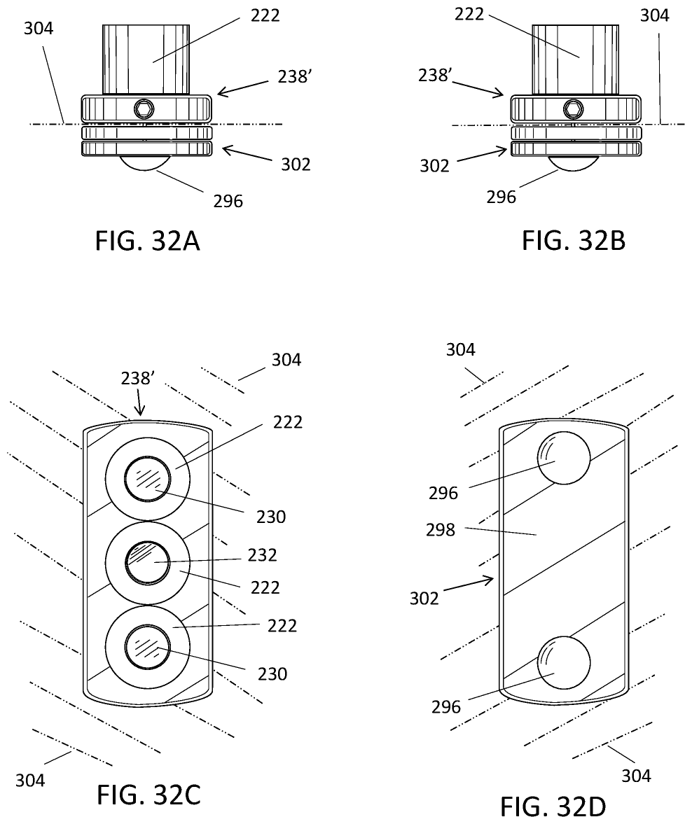

Instead of a hinge assembly connection 214 to magnetic latch cover 244 (and adjustable connector assembly 264), Jig 160 employs a modified main body 200′ with radius 216 on both ends, threaded hole 292 on both ends (to accept set screw 240), and additional non-threaded holes 294 through main body (to accept pins 296) (FIG. 28-FIG. 29). Jig 160 can be securely attached to surface 304 near work zone or to flat webbing 308 with hex wrench 306 (FIG. 28). Mounting supports may include a rigid backing 298 and elastomeric pad 300 each with holes 294′ (to accept pins 296) that align with holes 294 in slightly modified main body 200′ and with radius 216 on ends (FIG. 29). Backing 298 is fabricated from a light-weight high-strength rigid material such as plastic, aluminum or carbon fiber but other materials may also be used. A ‘pin-mount assembly’ 302 consists of pins 296 that fit through holes 294′, of rigid backing 298 and elastomeric pad 300 that are aligned with holes 294 in modified main body 200′ (FIG. 28.-FIG. 32). A ‘modified main assembly’ 238′ consists of main body 200′, two set screws 240, attached elastomeric bumpers 222, disc magnets 230, machine screws 224, washers 226, disc 234 and/or ring-shaped 236 insert.

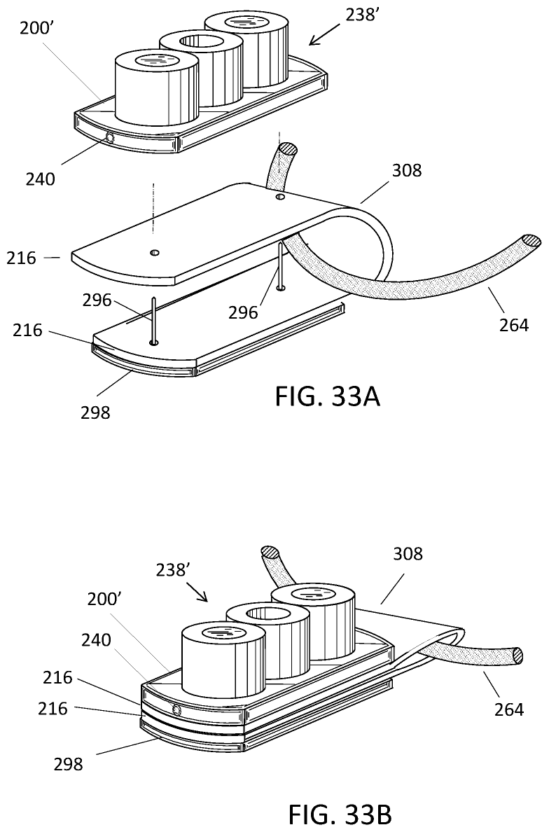

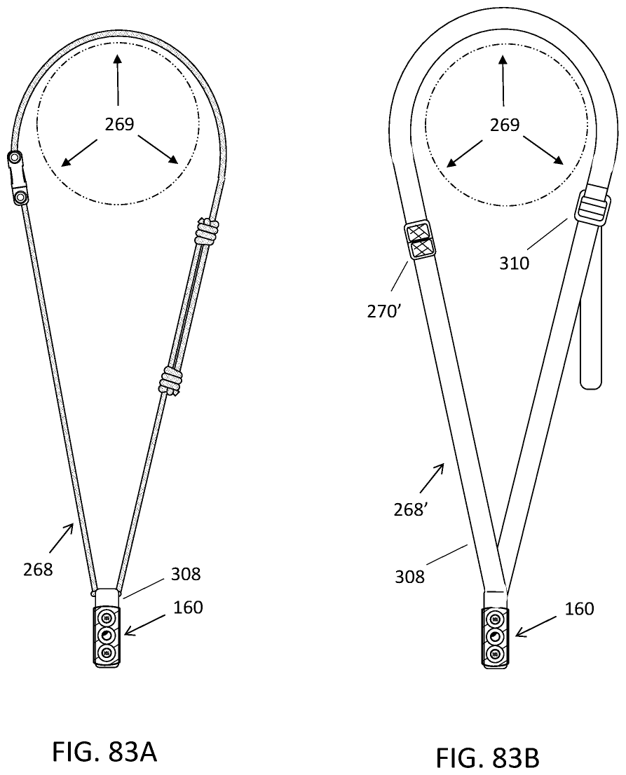

Elastomeric pad 300 may or may not be included depending on thickness of surface 304. Elastomeric pad 300 can be replaced with a loop of flat webbing 308 having radius 216 on ends, and thus provide means for connecting to cord 264 (FIG. 33). A short loop of flat webbing 308 provides a strong attachment to adjustable-length safety lanyard 268 (FIG. 83A). A longer loop of flat webbing 308 provides an alternate method for construction of a modified adjustable-length safety lanyard assembly 268′ including a commercially available break-away safety clasp 270′ and webbing adjustment buckle 310 (FIG. 83B).

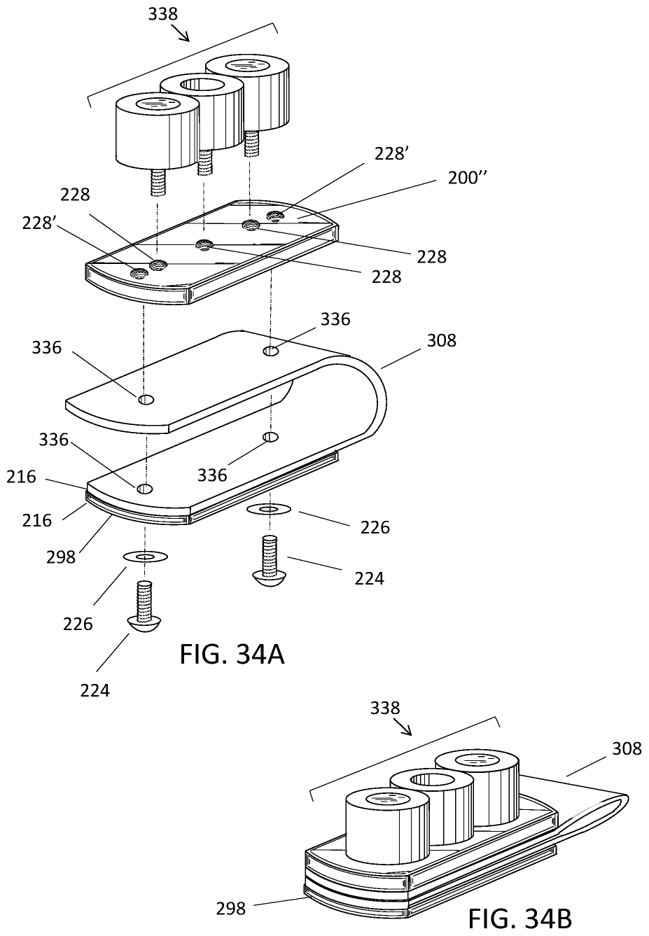

Another way to connect a loop of flat webbing is by slight modification of backing 298 and main body 200″ to accommodate screws rather than pins (FIG. 34). Threaded holes 288′ can accept screws 244 through holes 336 in webbing 308 (FIG. 34). The combination of elements including bumpers 222, screws 224, washers 226, magnets 230 and disc-shape insert 234 or flat-ring shape insert is referred to as ‘top assembly’ 338 to simplify further description.

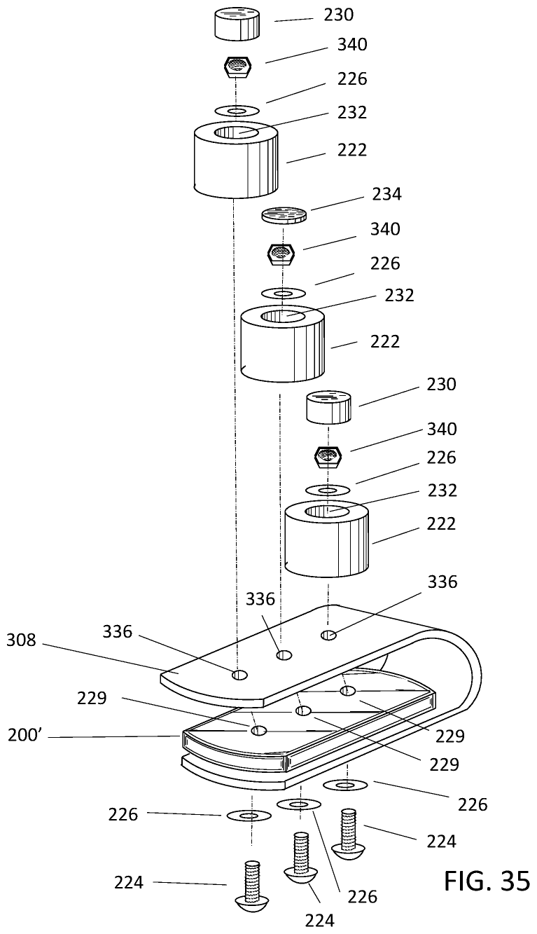

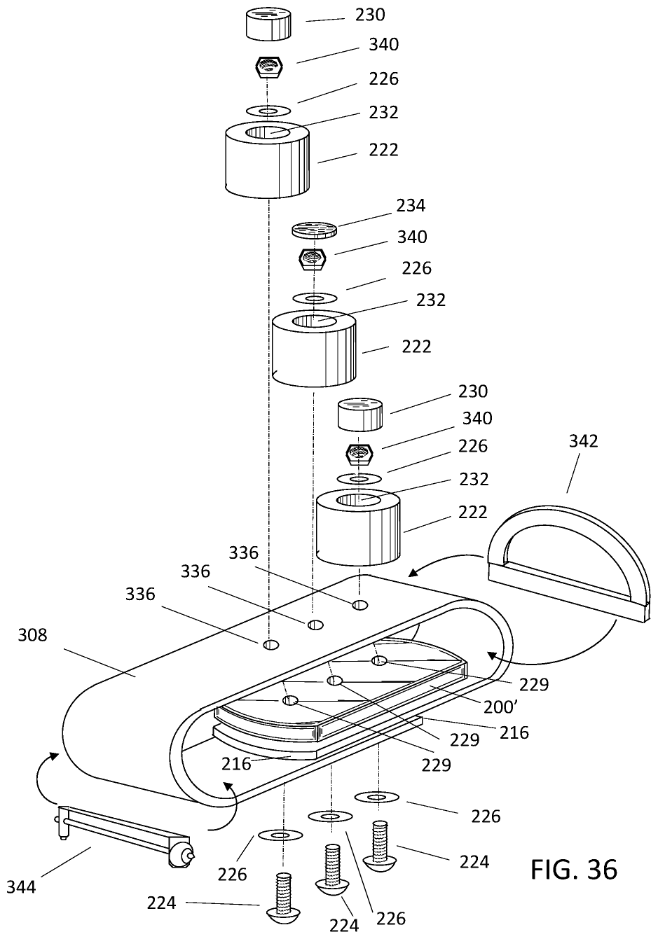

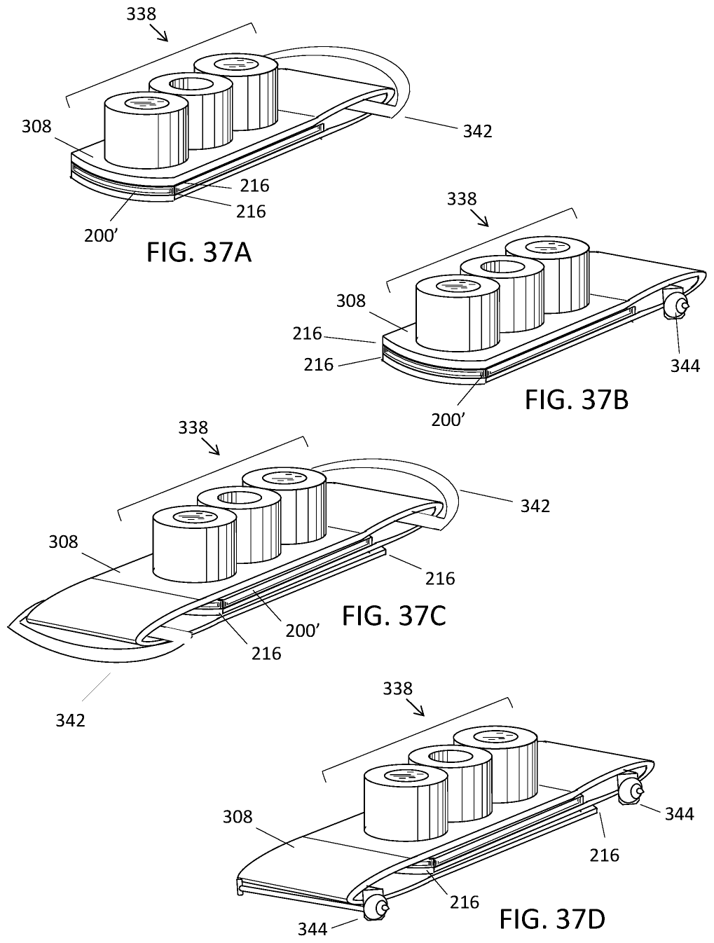

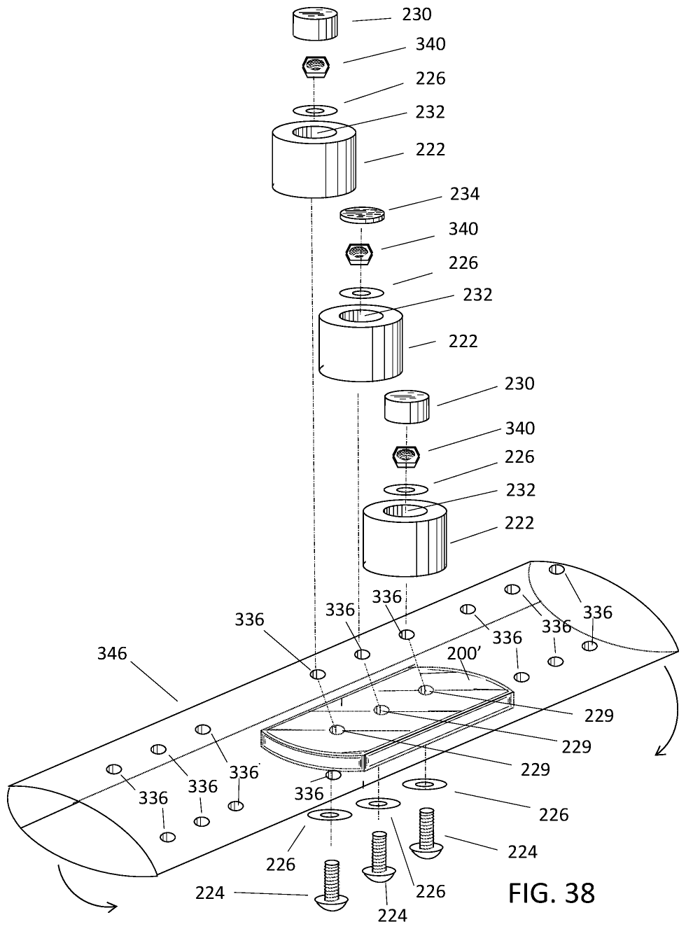

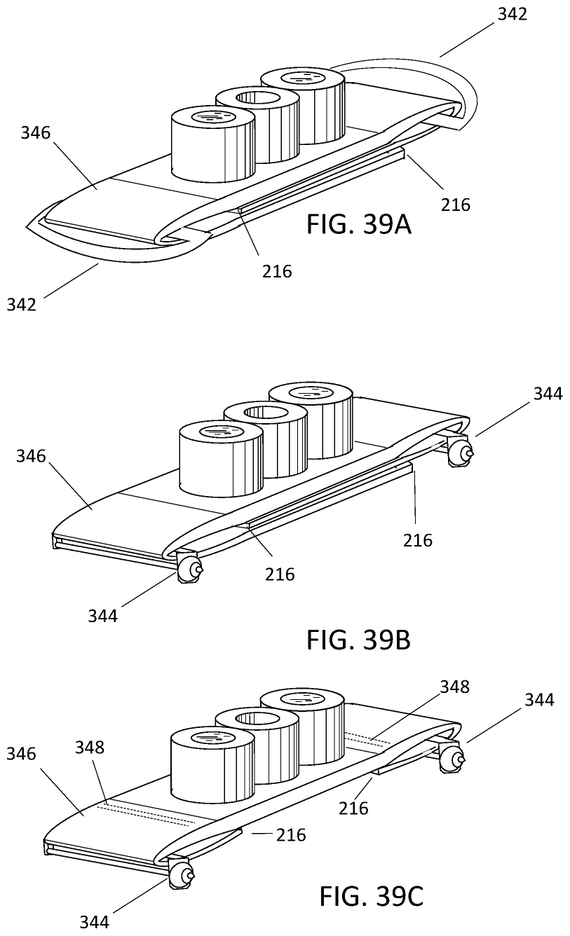

Another way to connect a loop of flat webbing is by inserting nuts 340 inside bumpers 222 and screws 224 (FIG. 35). A loop of webbing 308 with three holes 336 on top of and three holes 336 on bottom of webbing loop. Screws 224 are fed through washers 226, through holes 336 on bottom of webbing loop (not visible in FIG. 35), through holes 229 in modified main body 200′, through holes 336 in top of webbing loop, through bottom of bumpers 222 through washers 226 and finally, threaded onto nuts 340. Magnets 230 and disc 234 are then inserted in recess 232 and attached using adhesive. These components can be attached to a longer section of webbing 308 for generation of loops on both ends of Jig (FIG. 36). Insertion of conventional D-ring 342 or bar-pin 344 during assembly can provide additional ways for angler to connect Jig near work zone (FIG. 36-FIG. 37). These components can also be attached to a section of flat tubular webbing 346 where holes 336 in both sides of webbing tube are used to attach D-rings or bar pins after main body 200′ is inserted (FIG. 38-FIG. 39).

This alternate method of attaching bumpers 222 using nuts 340 can be applied to all Anglers Jig Versions. All Jig Versions can be made with nuts 340 and unthreaded holes 229 as shown (FIG. 35-FIG. 38). All Jig versions can also be constructed using nuts 340 and unthreaded holes 229 but inverted, where machine screws 224 pass through bumper recess and are held to main body 200 by nuts rather than threaded holes 228. Instead of two loops of tubular web attached to bottom of jig using screws 224 (FIG. 39A, FIG. 39B), a stich 348 using heavy duty thread can hold webbing loop containing d-ring 342 or bar-pin 344 (FIG. 39C). A metal grommet can also be attached to webbing as an alternate point of connection.

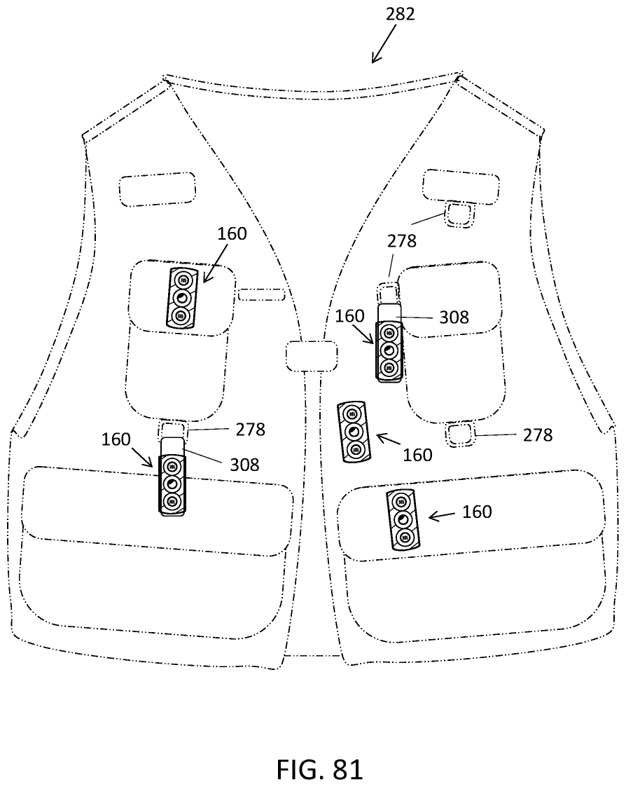

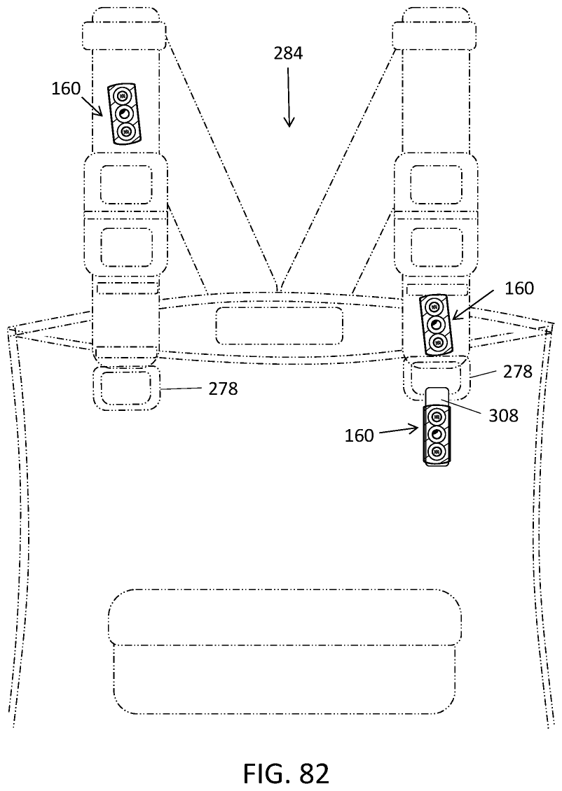

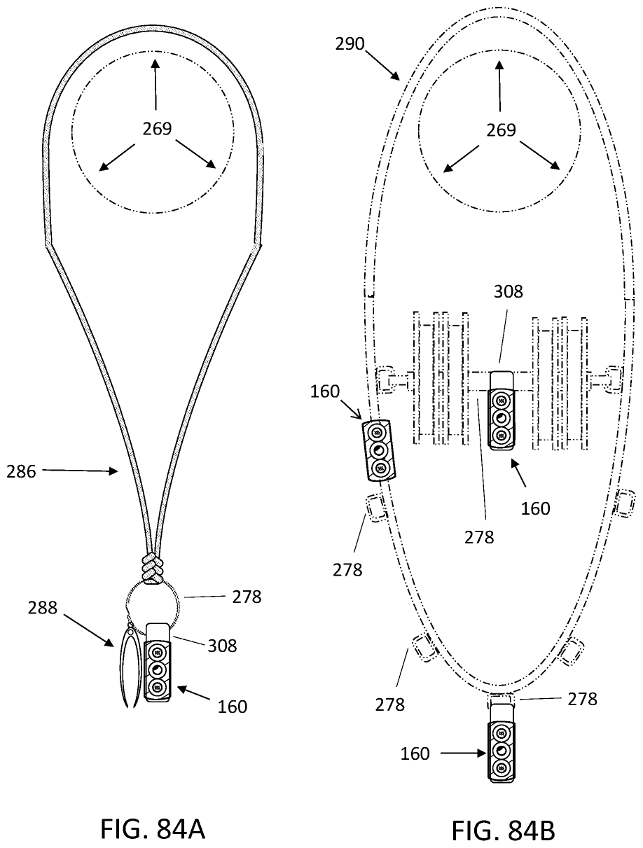

Jig 160 (Version 2) can be securely attached to a suitable surface near work zone using pin mount assembly 302. For example, penetration of surface directly, or hanging from a point of attachment 278 by a short loop of flat webbing 308, of a fishing vest 282 (FIG. 81), chest waders 284 (FIG. 82), adjustable safety lanyard 268 (FIG. 83A), flat webbing lanyard 268′ (FIG. 83B), nipper lanyard 286 (FIG. 84A), or multi-purpose fishing lanyard 290 (FIG. 84B).

Anglers Jig 170 (Version 3). Other ways of attaching main assembly near angler's ‘work zone’ to provide hands-free use may not include hinge assembly 214, magnetic latch cover assembly 244, or adjustable connector assembly 246.

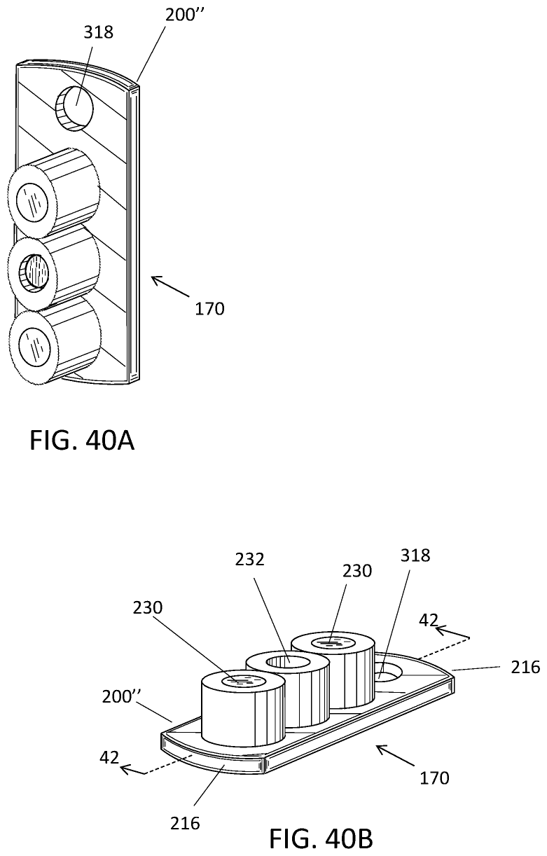

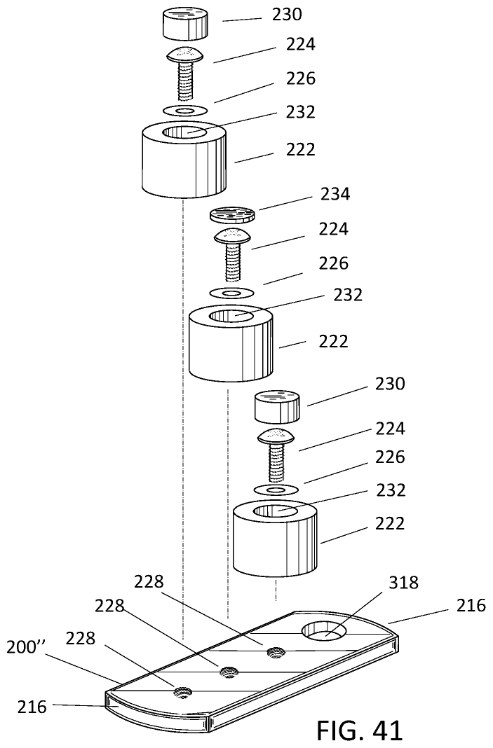

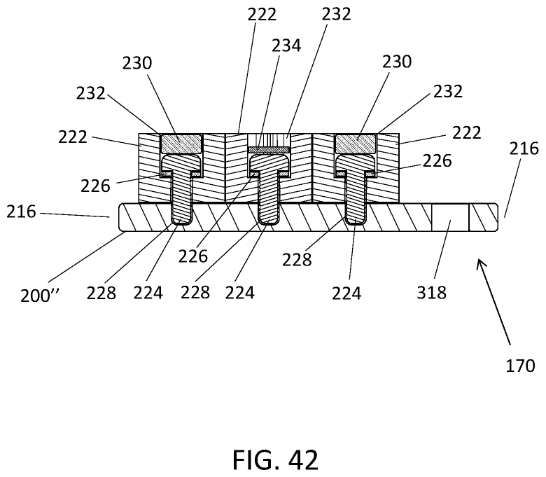

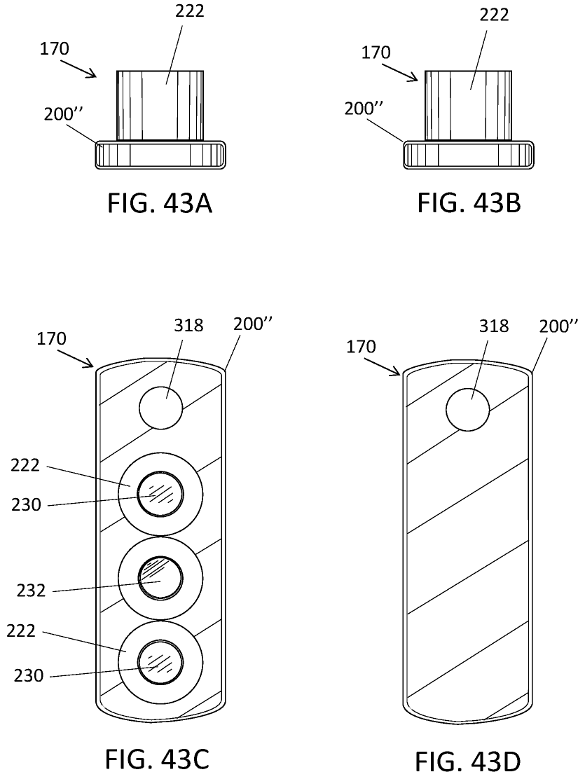

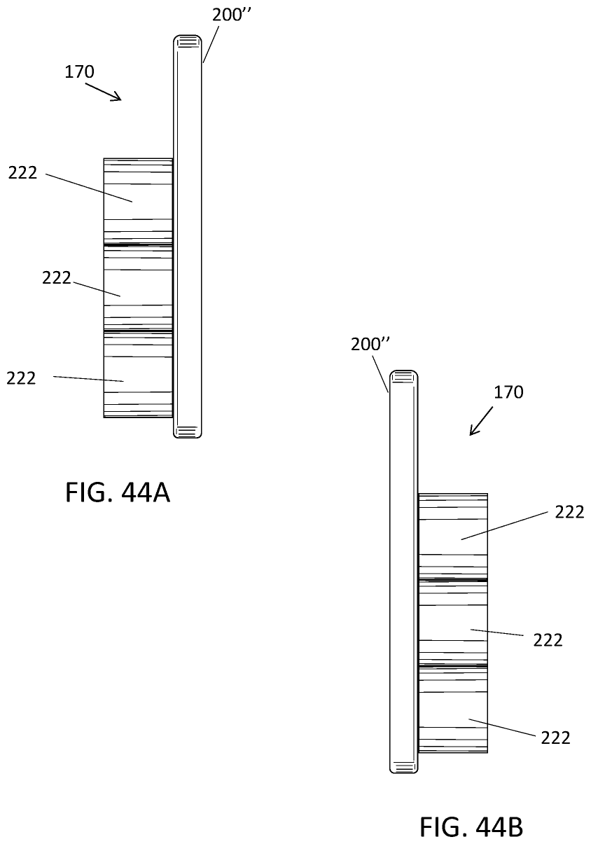

Jig 170 is comprised of modified main body 200″, elastomeric bumpers 222, machine screws 224, washers 226, magnets 230, disc-shaped insert 234 and may also include ring-shape insert 236 (FIG. 40-FIG. 44). Modified main body 200″ is slightly longer with radius 216 on both ends, and unthreaded hole 318 on one end (FIG. 40-FIG. 44).

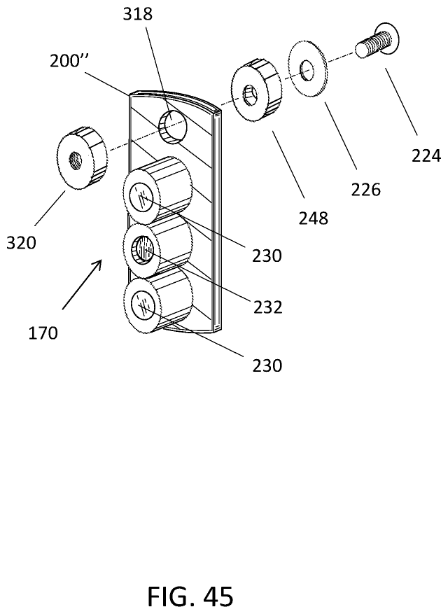

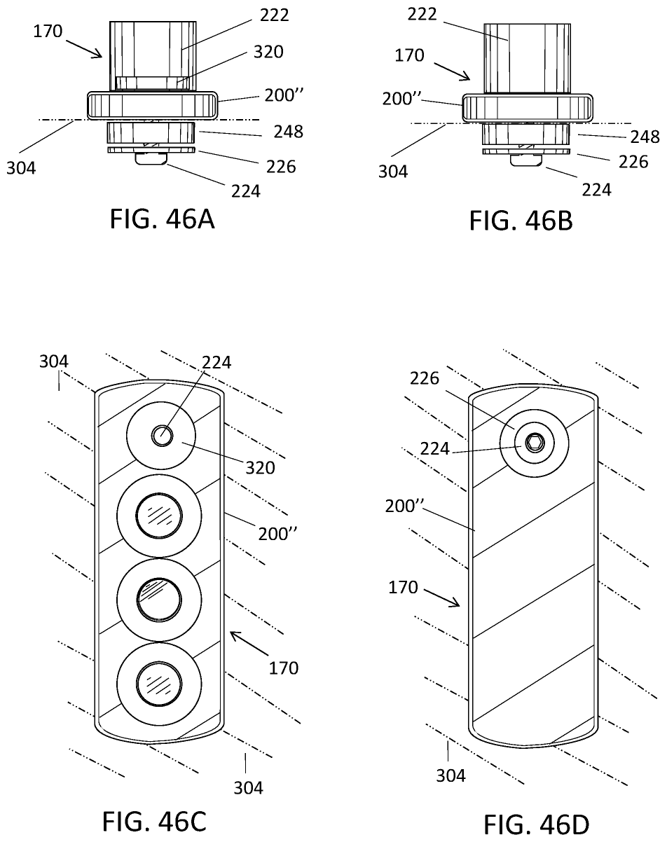

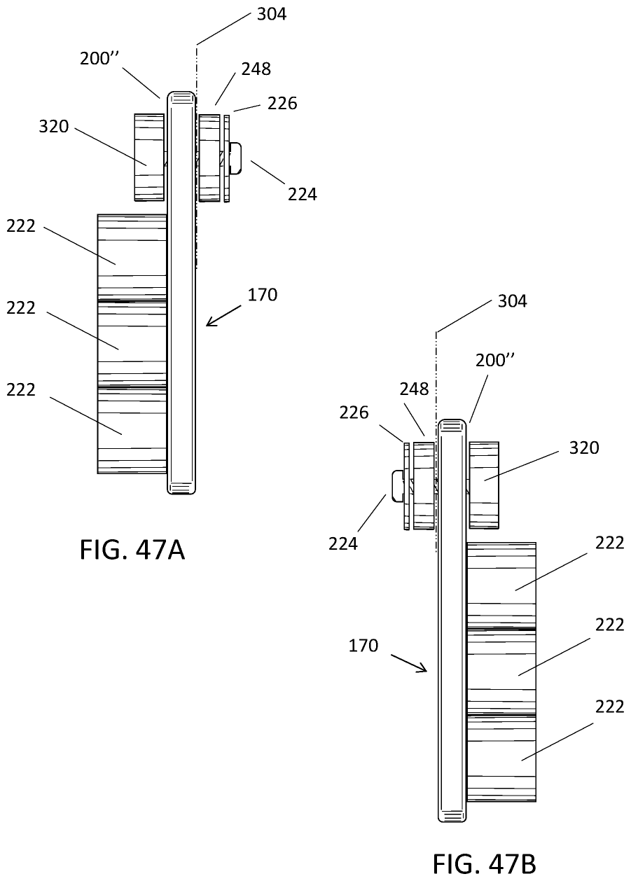

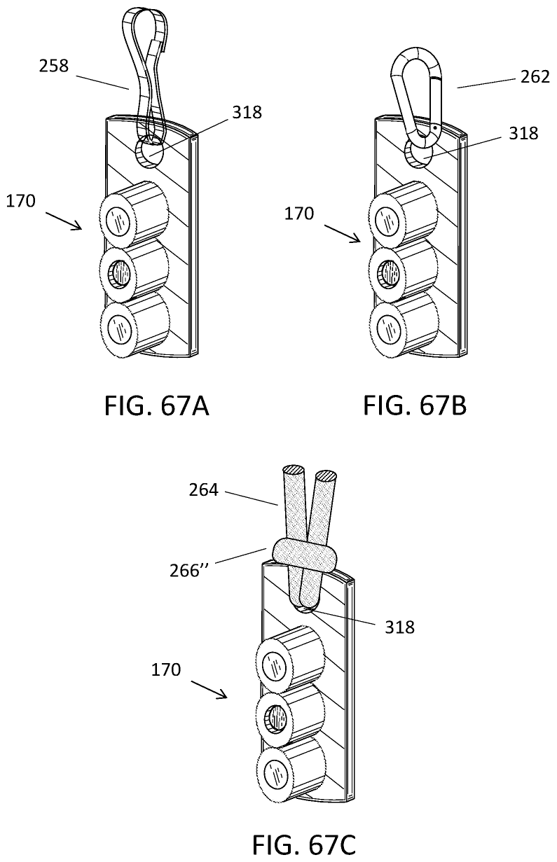

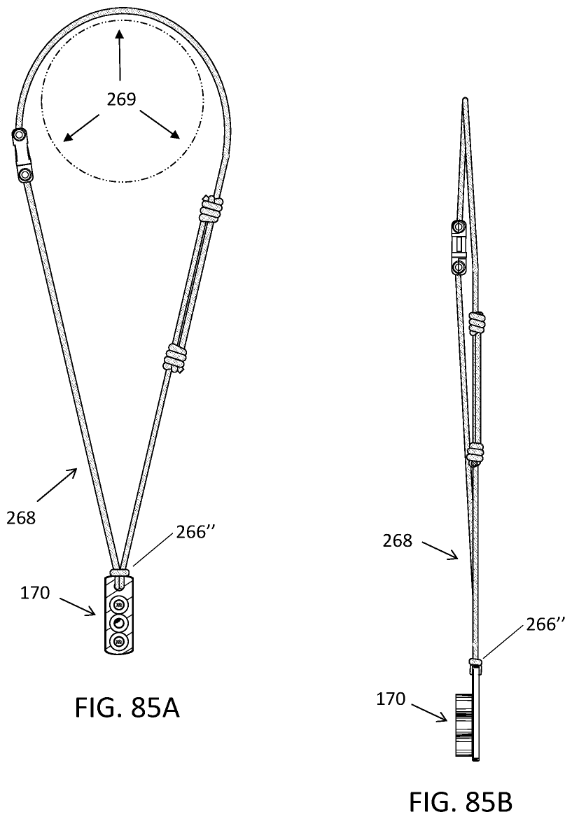

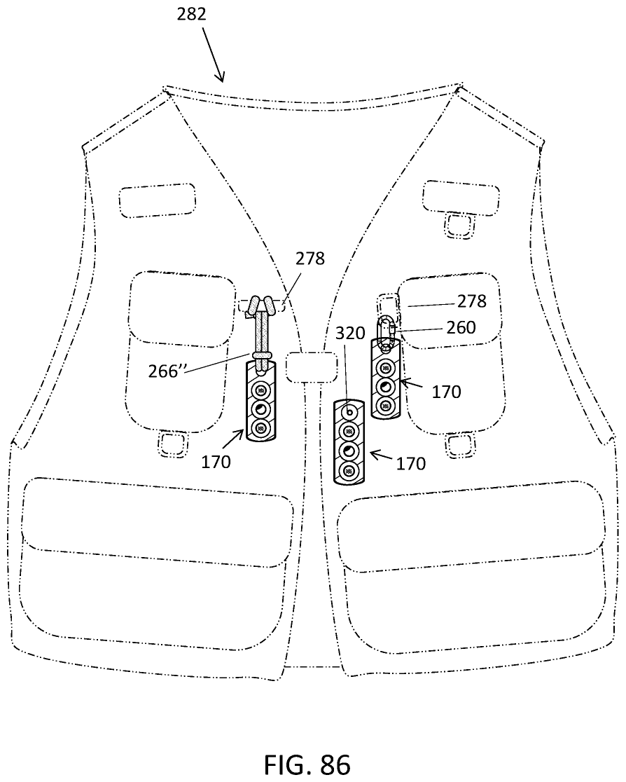

Jig 170 can be attached to single points of attachment 278 by methods including spring clip 258 (FIG. 67A) carabiner 262 (FIG. 67B) and cord 264 (FIG. 67C). A knurled knob 320 can be used in conjunction with rubber bushing 248, washer 226, and machine screw 224, to attach Jig 170 to surface 304 (FIG. 45-FIG. 47). Hitch knot 266″ can be used to attach Jig 170 to adjustable safety lanyard 268 (FIG. 85). Hitch knot 266″, knurled knob 320 and clips like connecting link 260 or carabiner 262 can be used to attach Jig 170 to point of attachment 278 on fishing vest 282 (FIG. 86), chest waders 284, nipper lanyard 286 or other suitable location.

Variability of all Jig Versions. Three basic Jig Versions are described above. The following description includes variations on elements that can be applied to all three Versions. The main objective of these element variations is to simplify construction. The basic Jig 170 is used to illustrate this variability but can also be applied to Jig 150 and 160 versions.

Threaded holes 228 and unthreaded holes 229 may or may not go entirely through main body 200″.

Order of bumpers can be varied and include different combinations of magnet, split-shot alignment, threader, and hook eye cleaner (or other). For example, rather than 2 magnets and a split-shot aligner, a single magnet with threader and hook-eye cleaner can be used. Ideally, individual components can be changed/included by user to suit individual anglers preference.

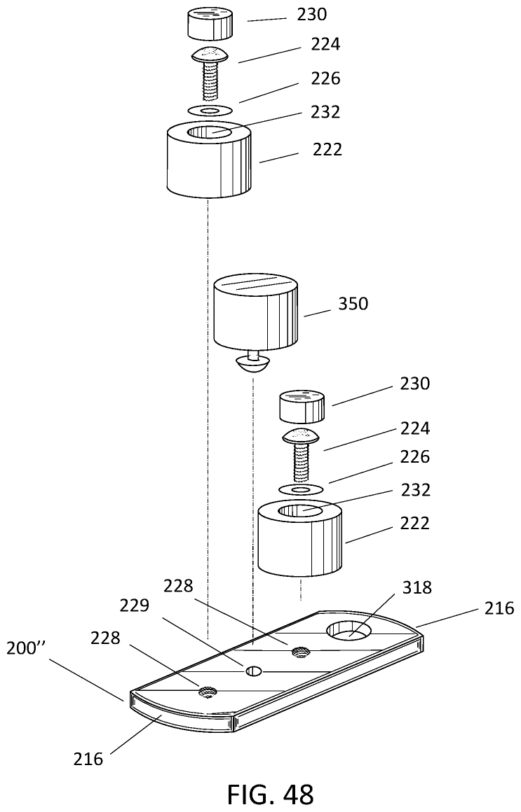

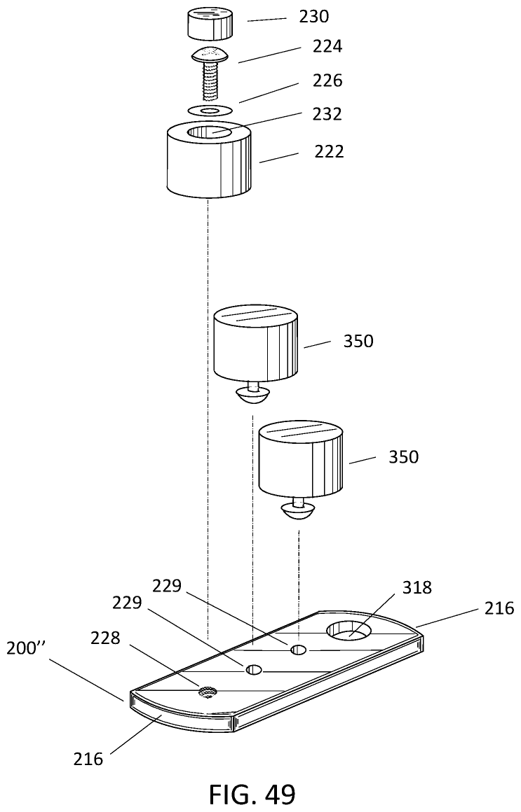

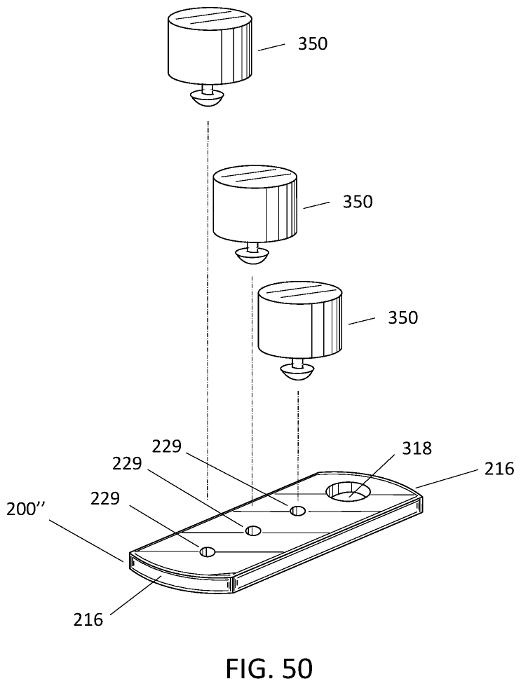

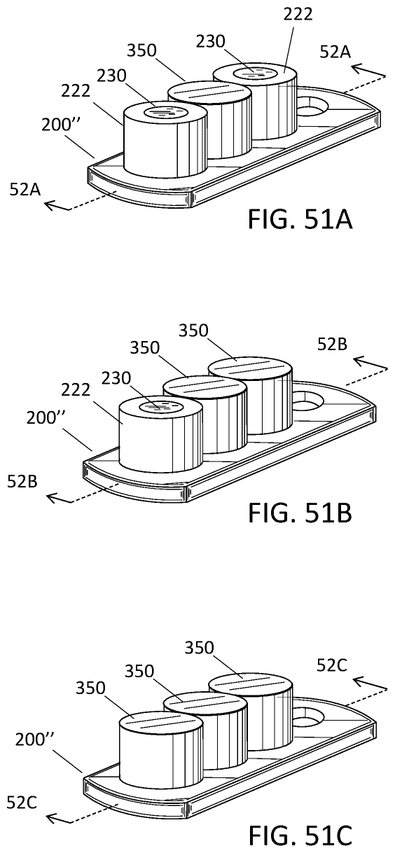

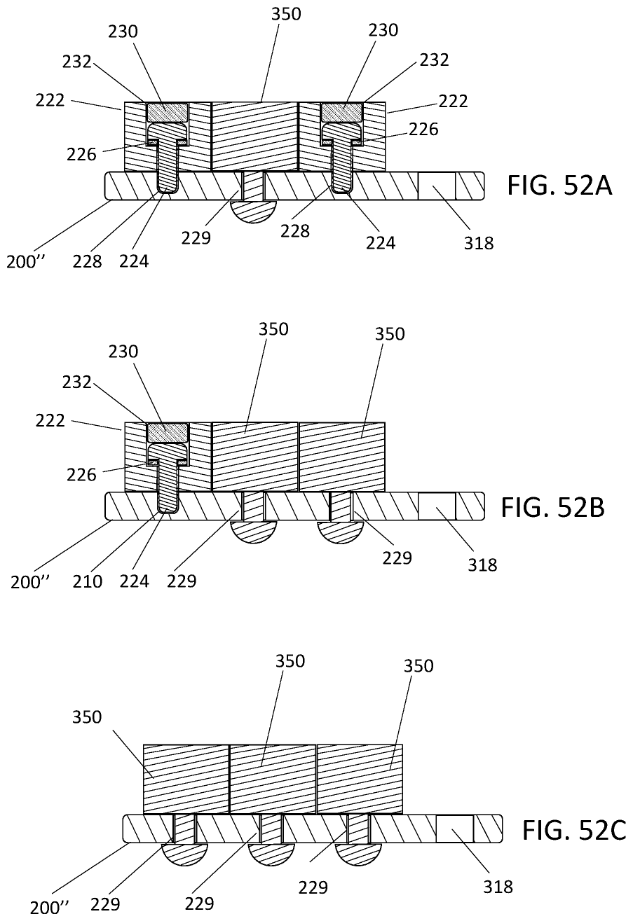

Individual elastomeric components other than bumpers can also be used, for all Jig Versions. For example, one or more grommet bumpers 350 can individually replace one or more recessed bumpers 222, including mounting screw 224 and washer 226 (FIG. 48-FIG. 52). Threaded holes 228 can be replaced with unthreaded holes 229 for each grommet bumper. Grommet bumpers may or may not contain recess for inserts. Any shape elastomeric part can be used.

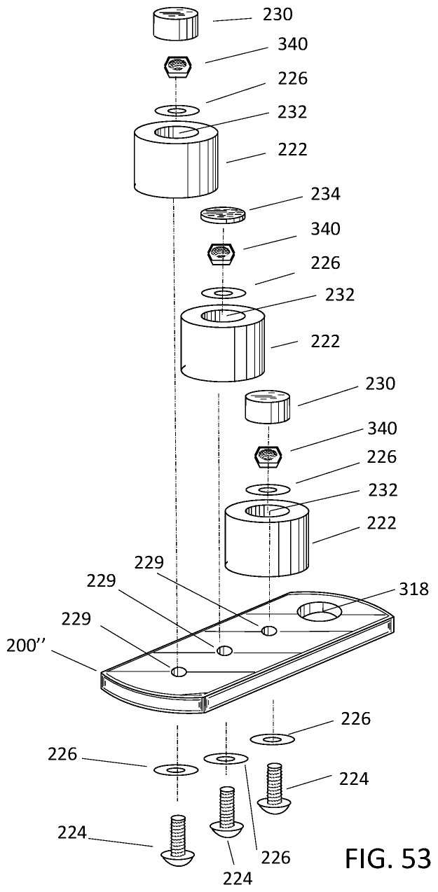

Machine nuts 340 can used be as an alternate method for attaching bumpers or other components in all Versions. For example, threaded holes 228 of main body 200″ can be replaced with unthreaded holes 229, and nut 340 inserted within bumper recess accepts screw 224 (FIG. 53). In addition, screws 224 can be replaced with threaded rod if main body 200″ has threaded holes 229, essentially creating a threaded post for attaching desired component with machine nut 340, and being able to easily remove and replace components.

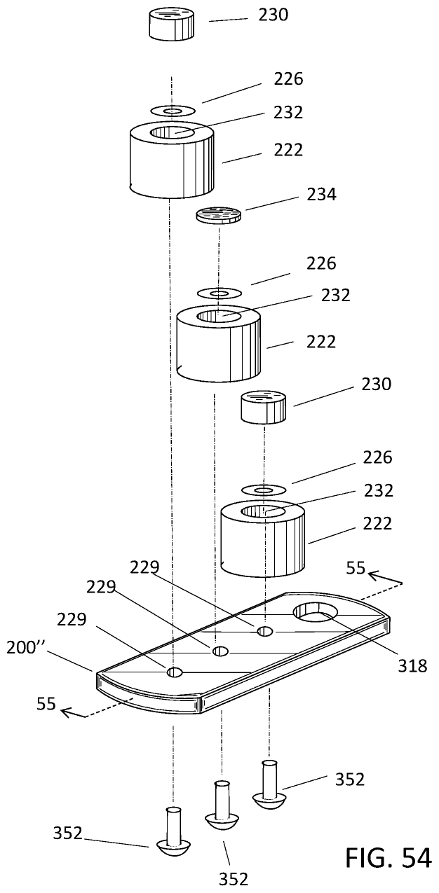

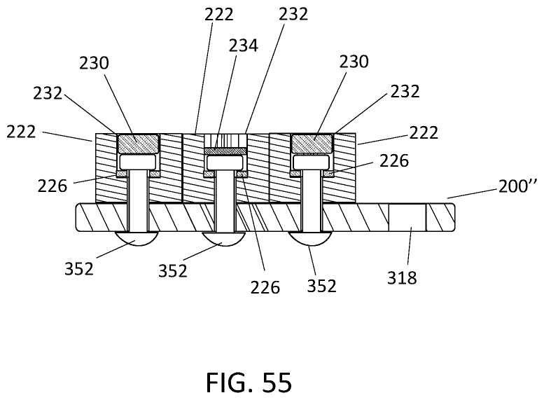

Rivets 352 including tubular rivets (shown here) and blind rivets can be used as an alternate method for attaching bumpers 222 to main body 200″ (FIG. 54-FIG. 55). Rivets 352 can be inserted from bottom of main body 200″ as shown (FIG. 54-FIG. 55) or inverted, where rivets 352 are first inserted into bumper recess 232 and then into main body 200″.

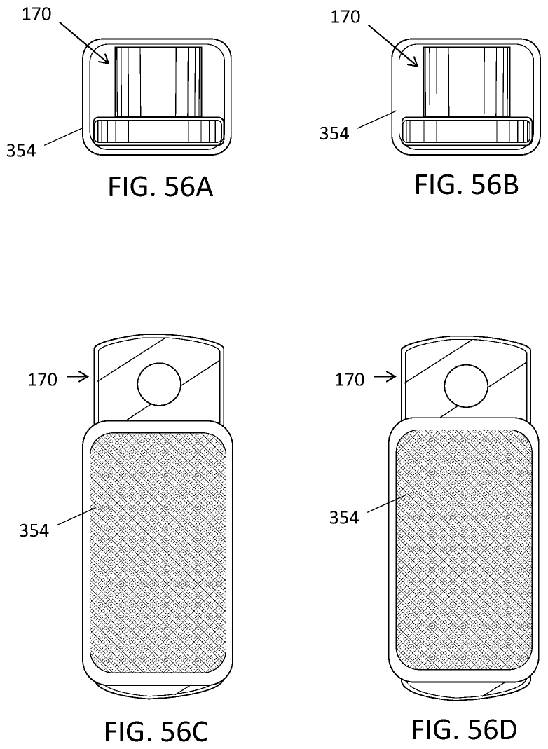

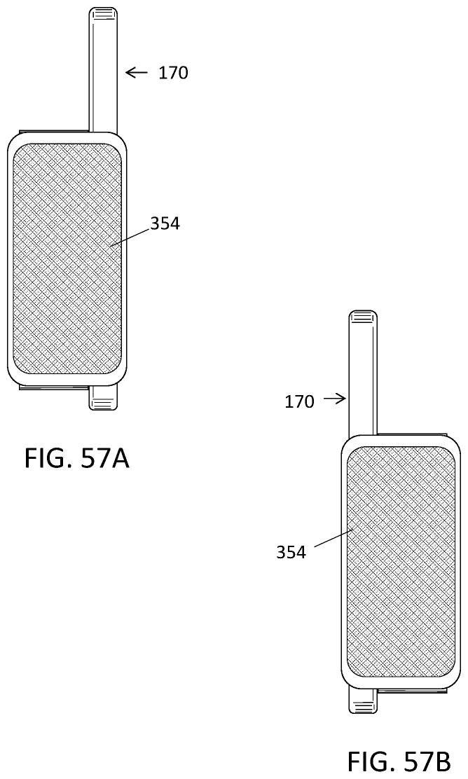

A sleeve/band 354 can cover main body components and protect from damage as well as unintentional interaction with magnets (FIG. 56-FIG. 57). Sleeve 354 can be made of rigid material and include set-screw for magnetic latch or be made of an elastomer or other material that stays temporarily attached to Jig 170.

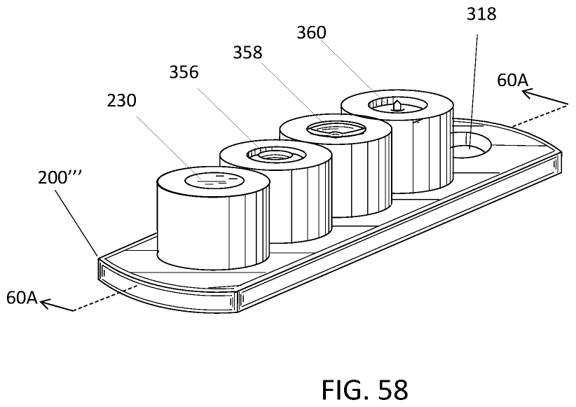

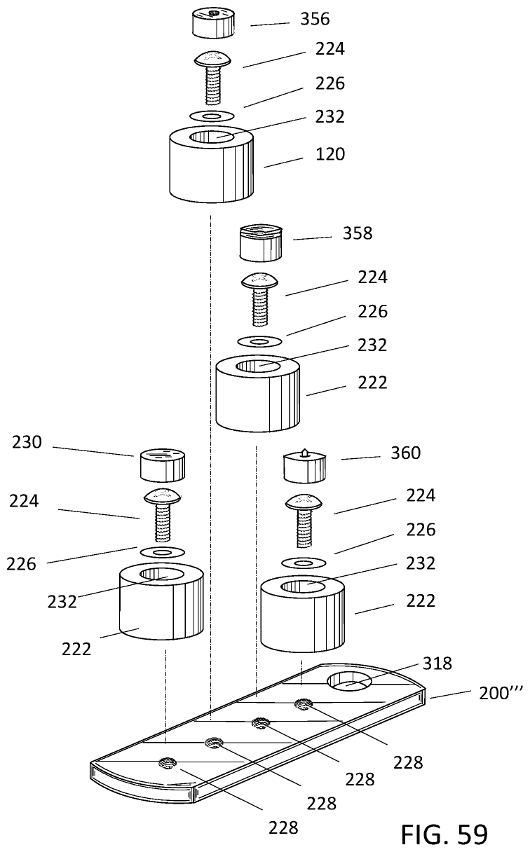

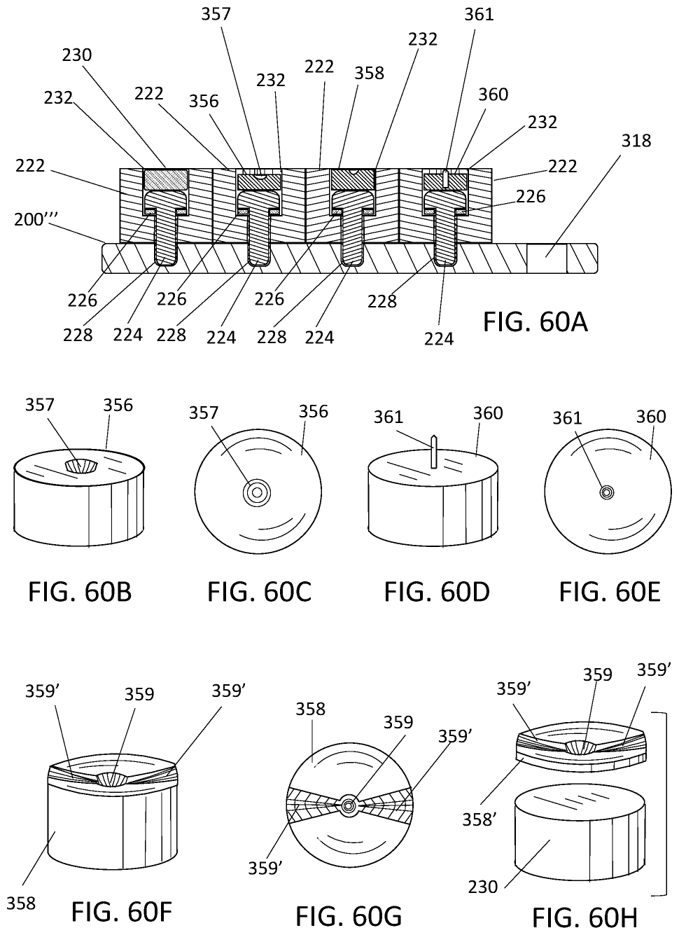

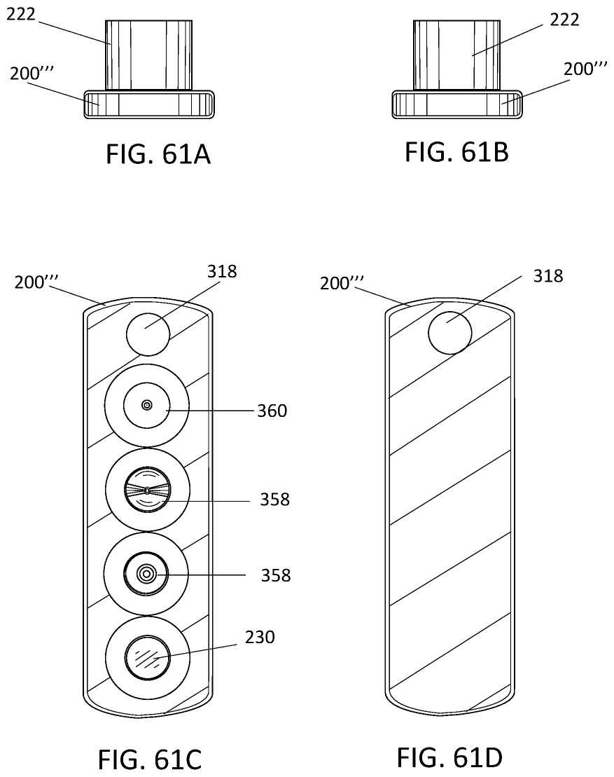

All Jig Versions can accommodate additional elements/tools that fit in recess 232 of bumpers 222. Although additional elements can be added to any main body, extended main body 200′″ is used here to simplify explanation (FIG. 58). As detailed above, magnet 230 in recess 232 of bumper 222 holds hooks and other iron-containing tools. Disc-shaped insert 234 and flat ring-shaped insert 236, along with recess 232 assist angler by holding and aligning split-shot. An additional insert is an idealized split-shot holder 356 molded or machined into a cylindrical shape, with a central concavity 357, from rigid or elastomeric material, for holding and aligning round or oval-shaped non-magnetic split-shot (FIG. 58-FIG. 61). An additional insert is a hook-threader 358 molded or machined into a cylindrical shape, from rigid or elastomeric material, including a central concavity 359 that fits eye of small hooks perpendicular to a cone-shaped concavity 359′, for guiding monofilament into hook-eye (FIG. 60F-FIG. 60G). A modified hook-eye threader 358′ is iron-containing with central concavity 359 flanked by cone-shaped concavity 359′ for guiding monofilament into hook eye, and is affixed to magnet 230 in recess, creating a magnetic-threader insert (FIG. 60H). An additional insert is a hook-eye cleaner 360 molded or machined into a cylindrical shape, including a centrally-mounted pin 361 that fits into eye of small hooks (FIG. 60D-FIG. 60E).

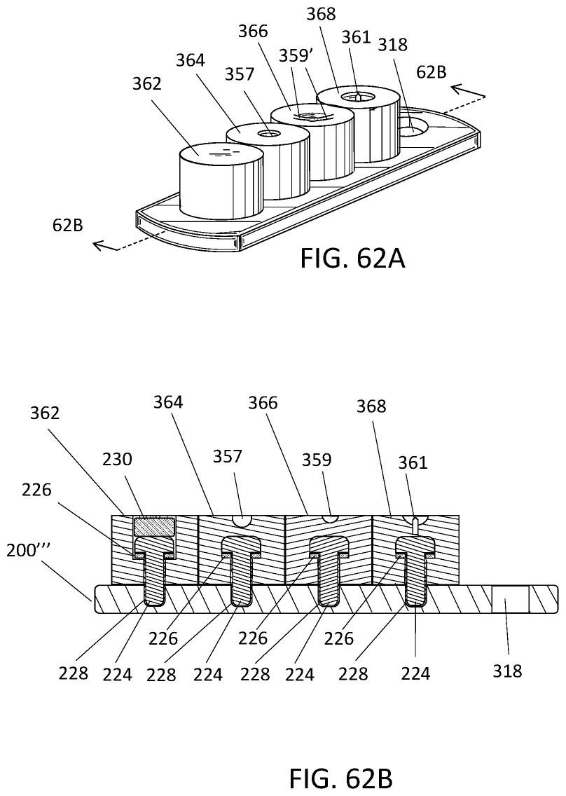

Further simplification of all Jig versions can include combination of individual parts fabricated as a single piece. For example, bumper 222, washer 226, screw 224, and magnet 230 can be molded into a single elastomeric ‘magnet bumper’ 362 (FIG. 62). This one-piece magnet bumper 362 can be screwed into hole 228 of main body, and although enclosed by elastomer, magnet 230 still functions as a magnet. In a similar fashion, bumper 222, washer 226, screw 224 and split-shot alignment insert 356 can be combined and fabricated as a single piece ‘split-shot alignment bumper’ with concavity 357 that can be screwed into hole 228 of main body. In a similar fashion, bumper 222, washer 226, screw 224 and hook-eye threader insert 358 (or thin hook-eye threader insert 358′ and magnet 230) can be combined and fabricated as a single piece ‘split-shot alignment bumper’ that can be screwed into hole 228 of main body. In a similar fashion, bumper 222, washer 226, screw 224 and hook-eye cleaner insert 360 can be combined and fabricated as a single piece ‘hook-eye cleaner bumper’ 368 that can be screwed into hole 228 of main body. Ideally, individual components can be changed/included by user to suit individual angler's preference.

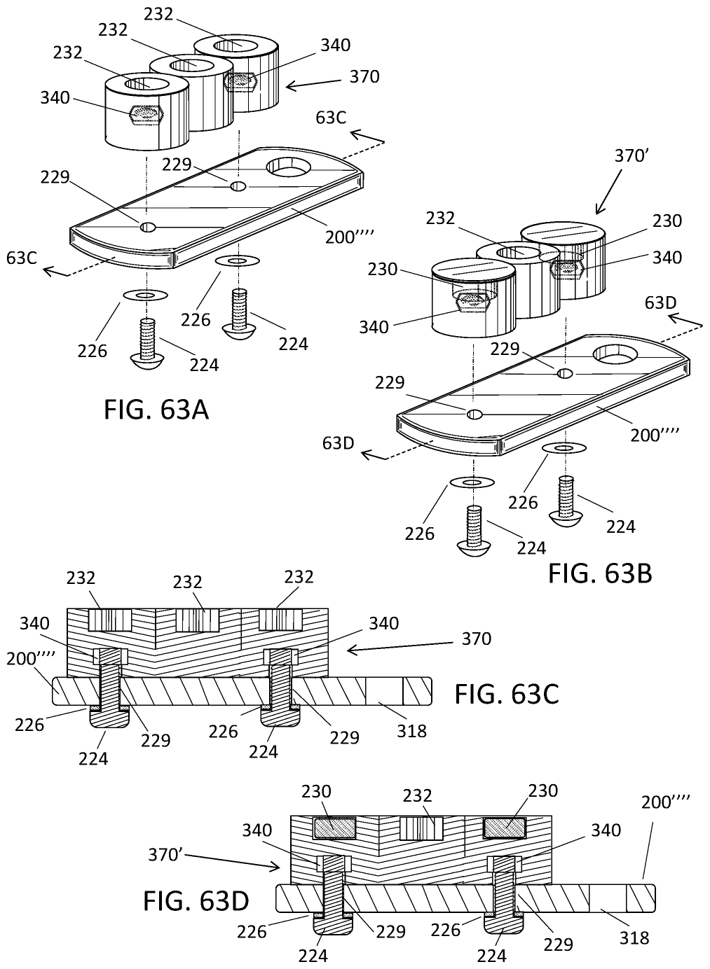

Further simplification of all Jig Versions can include combination of individual parts fabricated as a single piece. For example, rather than fasten bumpers 222 or grommet bumpers 350 or single-piece components like magnet bumper 362 to main body, elastomeric parts can be combined and fabricated as a single piece (FIG. 63). Single piece elastomer 370 can include recesses for inserts (FIG. 63A, FIG. 63C) or have recesses fabricated with described inserts including magnet bumper 362, split-shot alignment bumper 364, hook-threader bumper 366, hook-eye cleaner bumper 368, or other (FIG. 63B, FIG. 63D). These combined elastomeric parts can include nuts 340 to fasten to main body 200″″ using machine screws 224 and washers 226 (FIG. 63).

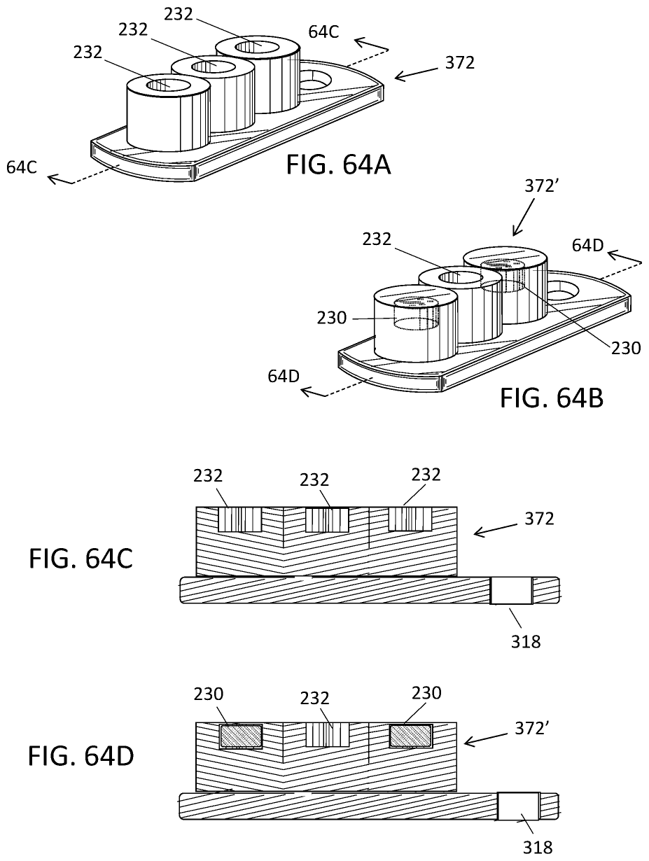

Further simplification of all Jig Versions can include combination of individual parts fabricated as a single piece. For example, rather than fasten components to main body, main body and components can be fabricated as one piece (FIG. 64). This single-piece fabrication can include just recesses, subsequently filled with inserts (FIG. 64A) or have recesses fabricated with described inserts including magnet bumper 362, split-shot alignment bumper 364, hook-threader bumper 366, hook-eye cleaner bumper 368, or other (FIG. 64B). An idealized single-piece fabrication 374 including magnets, split-shot alignment concavity 357 and ergonomic design (FIG. 65) can be used for all Jig Versions.

Elastomeric components referred to throughout application can be made entirely of an elastomer. Elastomeric components can also be partially elastomeric. For example, fabricated component(s) can include elastomer only where elastomeric slot is formed. The design described here utilizes round elastomeric recess bumpers, primarily for their ease of attachment and durability. However, the slot formed between bumpers is important for operation of line retainer(s). Line retaining slots can be formed in a variety of ways other than between round elastomeric bumpers.

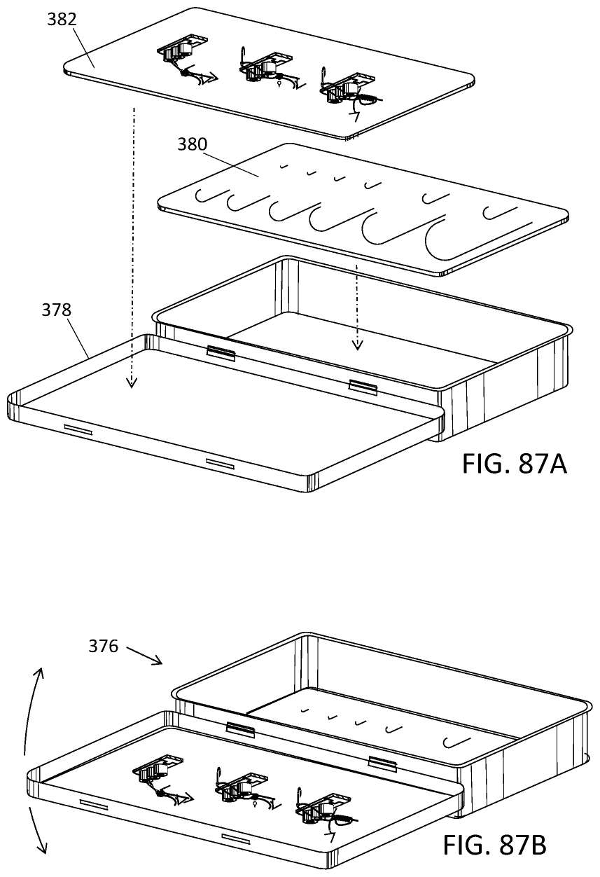

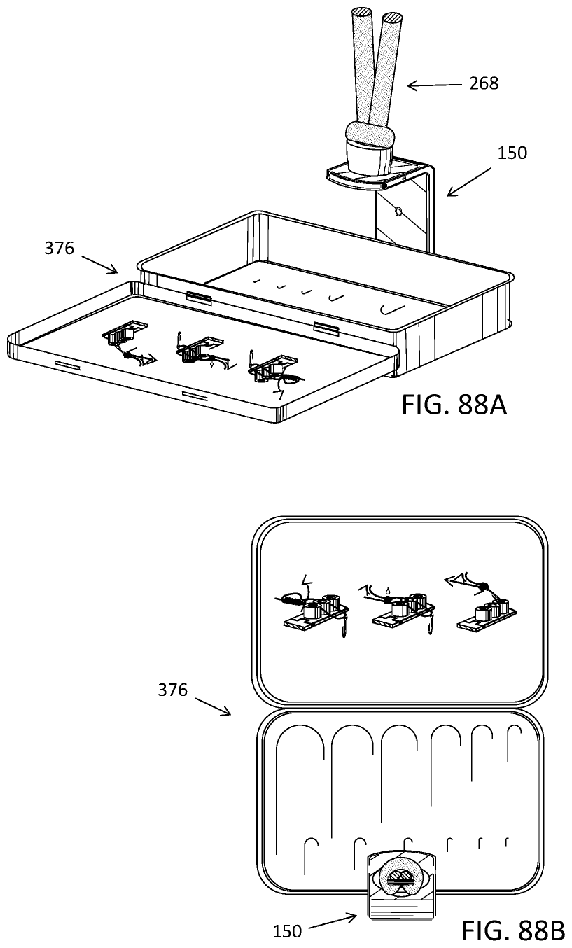

A rigging box 376 is a combination of elements comprised of a tin hinged-lid box 378, a sheet magnet 378 die-cut to fit in box bottom, and a label or pouch 382 with adhesive-backing is cut to fit inside lid of box (FIG. 87). Tin box 376 can be temporarily attached to magnets 230 (FIG. 88) of all Jig Versions.

### Operation of Invention (FIG. 66-FIG. 107)

In general, a jig is a device that mechanically maintains the correct positional relationship between a piece of work and a tool, or between parts of work during assembly.

Anglers attach a variety of components (including hook, line, and sinker) in a variety of combinations, to place lures on, or at some specified depth below, the surface of water. The collective assembly of these components can be referred to as the ‘terminal rig’, or simply, ‘rig’. An example of a very simple rig is fishing line connected to a hook (using a suitable knot) with some bait on the hook. Modification of this rig by attaching a sinker to the fishing line (near the hook) helps angler place lure at specified depth in water. Further modification of this rig can include attachment of a bobber to line (at specified distance from sinker) helps maintain a specified depth. Common adjustments of this rig can include movement of bobber, removal of unintended knots, addition/removal of sinkers and changing lures.

A major problem for anglers is that lures, line and sinkers can be difficult to manipulate when tying knots and assembling a well-built rig. This is especially true when using a ‘fly fishing’ technique where relatively small and delicate lures, line and sinkers are often required for success. Without a spot to temporarily hold these items, anything dropped is easily lost in the wind, water, or shoreline rocks and sand. Anglers commonly perform rig modifications/adjustments in a ‘work zone’ located between nose and belly button, easily accessed by both hands, with shoulders relaxed and things in focus. The work zone is an area similar to which one would hold a book with both hands to read it.

As both hands are required for rig modifications/adjustments, the human mouth and lips are frequently used to temporarily hold hook, line and sinker. The lips are frequently used to hold line (while connected to rod and reel) such that a portion of the rig hangs in the ‘work zone’ so it can be easily manipulated/adjusted. Both hands are then used to retrieve, manipulate and stow lure boxes, sinker dispensers, and spools of line as well as operate nippers and forceps, thread hooks and tie knots etc. The lip method is also commonly used to temporarily hold other tackle including lure, additional line, and even potentially toxic lead-containing sinkers. As the lips are used for many rig adjustment/knot tying procedures, actions like speaking, drinking and eating are difficult or impossible.

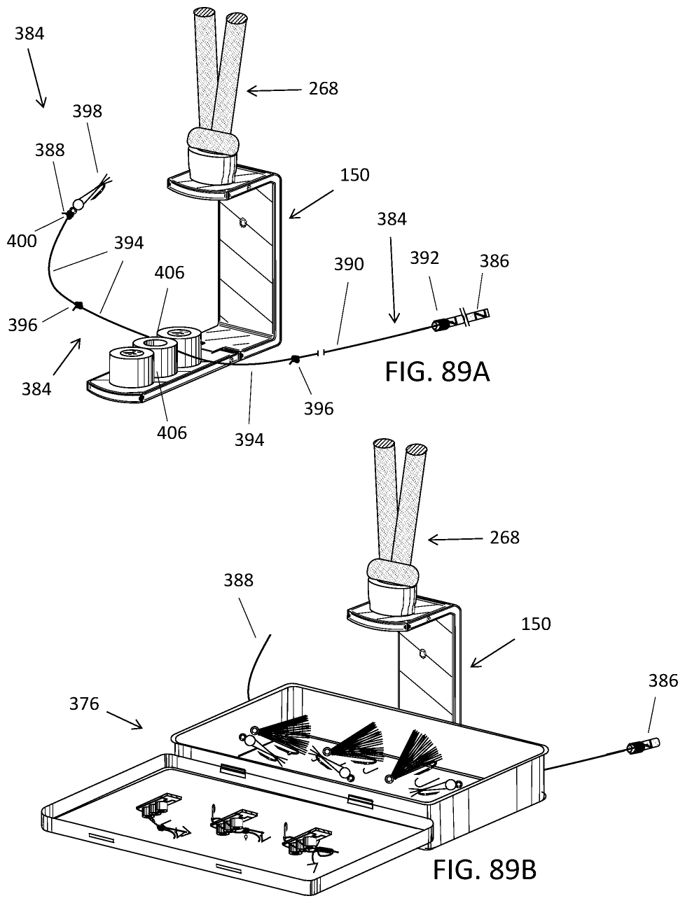

An Anglers Jig is a device that mechanically maintains the correct positional relationship between a piece of work and a tool, and between parts of work during assembly of a fishing rig (FIG. 89-FIG. 107). Although Version 1 Jig 150 is used for this operational description, it is applicable to all Jig Versions (with the exception of sinker attachment using surface-mounted Jigs, described below). To simplify operational description, some drawings show only a portion of Jig 150 where it is cut-off near bottom bend of cover. Shading on main body and cover portion has been removed to simplify readers' ability to visualize mono 394 through step-wise construction of knots.

Standard pieces of terminal rig 384 include tapered leader 390, fishing monofilament 394, hooks 398, sinkers, bobbers, and a variety of other pieces beyond the scope of this device description. For this operational explanation, a standard fly-fishing ‘terminal rig’ 384 consists of the region between fly line 386 and the extreme terminus ‘tag end’ 388, including all connected pieces (FIG. 89).

A standard method for ‘terminal rig’ construction is to attach a tapered leader 390 to end of fly line 386 using a standard nail-knot 392 or equivalent (FIG. 89A). Standard tapered leader is translucent fishing line material that is large diameter on one end and gradually tapered to a smaller diameter. Monofilament fishing line, having a constant diameter can be referred to as ‘tippet’ or ‘mono’ 394, is attached to the end of tapered leader with a blood knot 396, or other line-to-line knot. Fishing fly hook 398 is tied to mono 394 using an improved clinch knot 400, or other line-to-hook knot (FIG. 89A). Fly line 386 and tag end 388 are extreme distal (farther) and proximal (closer) ends of terminal rig, respectively (FIG. 89B).

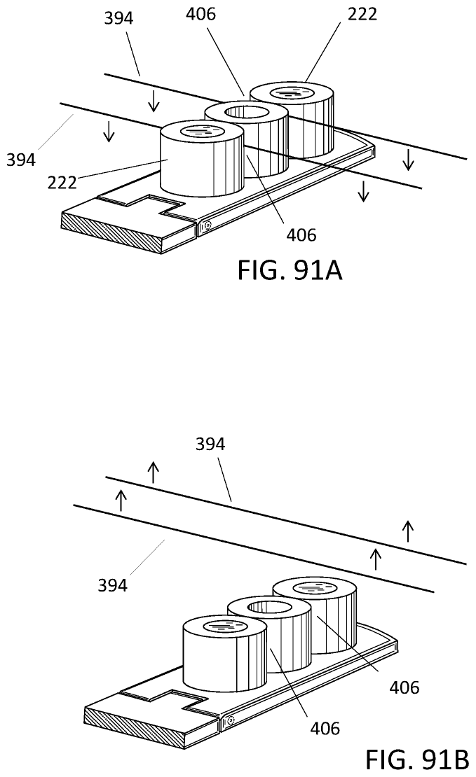

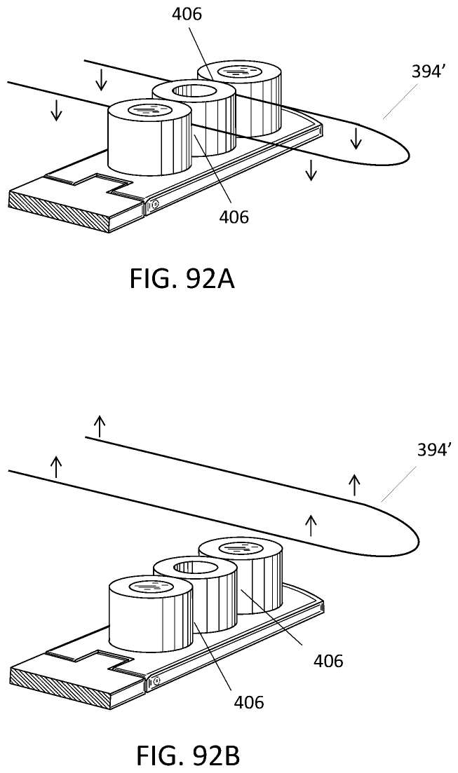

Operational Feature 1: Line Retainer. Elastomeric slots 406 formed between bumpers 222 temporarily hold tapered leader 390 and strands of monofilament 394 during rig modification/adjustments. To retain one or more strands of monofilament, hold mono strand 394 between bumpers 222 above slot 406 and gently press mono a short distance into slot (FIG. 91A). Multiple strands of mono can be stacked on one-another in the slot. Mono 394 strands are removed from slot by gently pulling from bottom-up, towards top of bumpers 222 (FIG. 91B). A loop of mono 394′ can be retained by pressing into adjacent slots 406 (FIG. 92A) and removed by gently pulling toward bumper tops (FIG. 92B).

Slots 406 between round-shaped bumpers 222 gently hold monofilament 394 without damage if inserted from top-down. Insertion of, and subsequent pulling of monofilament left-to-right when in the slot will heat-damage mono 394 and is not a recommended procedure. Contact point where round-shaped bumpers 222 slightly touch one-another provides a durable yet extremely narrow slot 406 that minimizes potential for heat damage to monofilament.

Initially, the correct positional relationship between angler and Angler's Jig should be established, with consideration of angler's dominant hand. Angler usually casts rod and performs rig modifications with dominant hand. Angler commonly holds rod and reel under dominant-hand armpit prior to performing rig modifications. Angler commonly uses dominant-hand to perform rig modification procedures requiring the most dexterity.

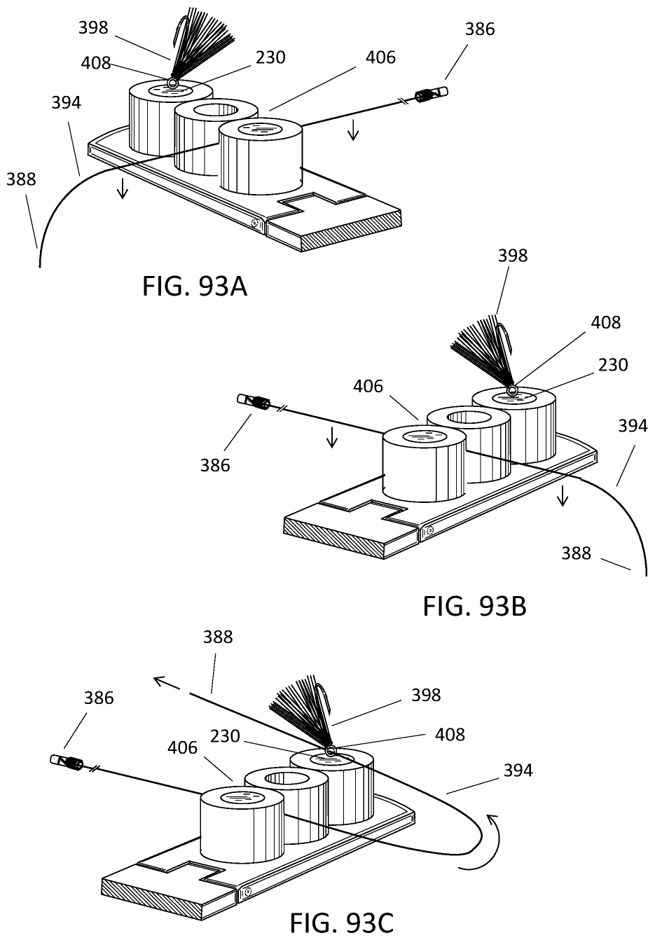

Rather than retaining line in mouth during rig adjustments, left-hand dominant angler would likely benefit from a left-side exit of tag end 388 from proximal slot 406 (FIG. 93A), and right-handed angler would benefit from right-side exit of tag end 388 from proximal slot (FIG. 93B). This initial ‘docking’ positioning of tag-end 388 in proximal (closer to angler) slot 406 is one way to prepare for subsequent rig adjustment procedures. When tag-end 388 is positioned on left-hand (FIG. 93A) or right-hand (FIG. 93B) side of Anglers Jig, dominant hand be used to manipulate rig pieces and tools in a controlled, stepwise manner. For example, right-handed anglers with tag-end 388 exiting from right-hand side (FIG. 93B) can then use nipper and forceps, or other tools with right hand.

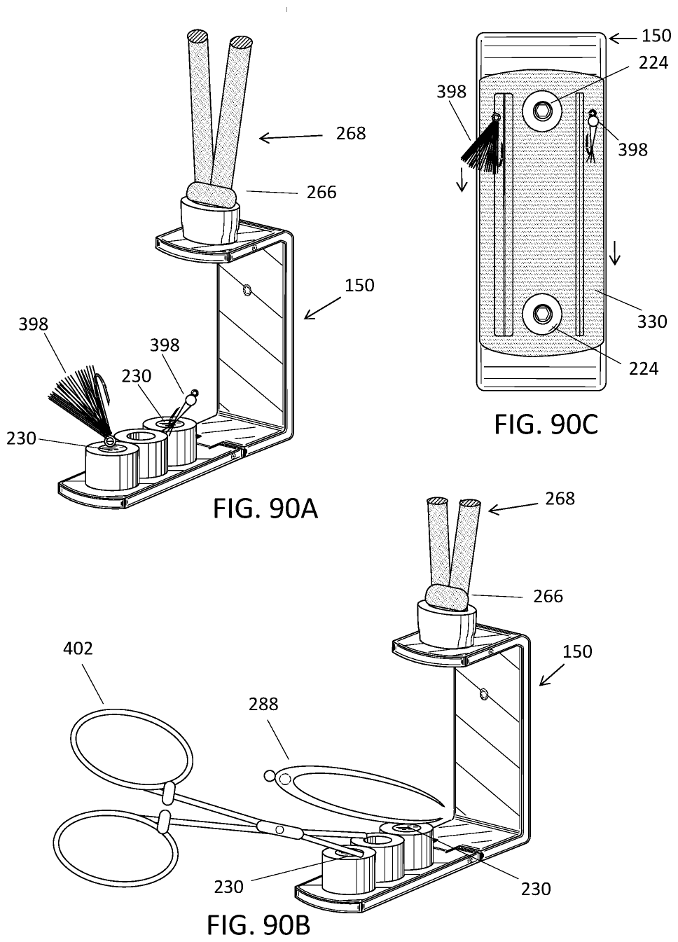

Operational Feature 2: Magnetic Hook and Tool Retainer. Magnets 230 temporarily hold fishing hooks 398 (FIG. 90A). Magnets 230 temporarily hold iron-containing tools including most nippers 288 (FIG. 90B), forceps 402 (FIG. 90B), and tin box 376 (FIG. 88). Some fishing pieces and tools are made of non-iron-containing material (such as lead, plastic and aluminum), and are not attracted to magnets.

Operational Feature 3: Hook Sharpener. Sharpening the hook is another rig adjustment required for consistent success. A hook sharpener 330 can be attached to back of Jig for easy accessibility and use (FIG. 90C). Hook tied to mono 394 docked in proximal slot 406 can be easily controlled and sharpened.

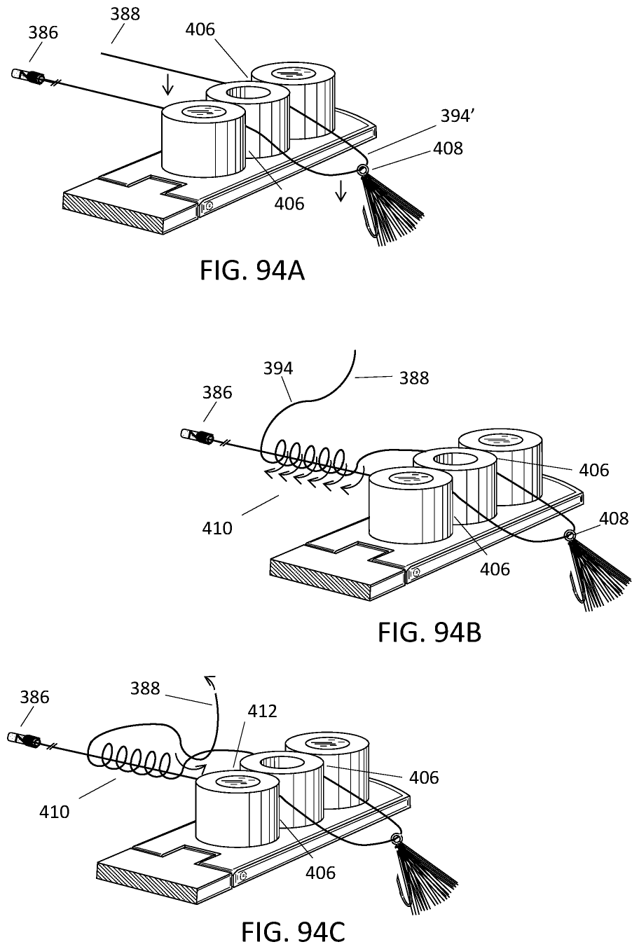

Operational Feature 4. Line-to-Hook-Eye Jig: Tying consistently strong mono-to-hook knots is probably angler's most frequent rig modification procedure. By breaking this procedure into steps, the Angler's Jig helps angler consistently and rapidly tie strong mono-to-hook knots. A variety of knots can be used for line-to-hook connection. A step-wise process for attaching a hook to mono using an ‘improved clinch knot’ 400 starts with ‘docking’ mono 394 near tag end 388 in proximal slot 406 (FIG. 93A, FIG. 93B). A hook 398 is placed on distal (farther from angler) magnet 230, with hook-eye 408 on magnet. Right-handed angler grips mono 394 near tag-end 388 with dominant hand and guides, or ‘threads’, mono through hook-eye 408 (FIG. 93C). Angler then forms a loop in mono 394′ (with hook in center of loop), by inserting tag-end 388 of mono 394 in distal slot 406 (FIG. 94A). A variety of knots can be simplified with Angler's Jig.

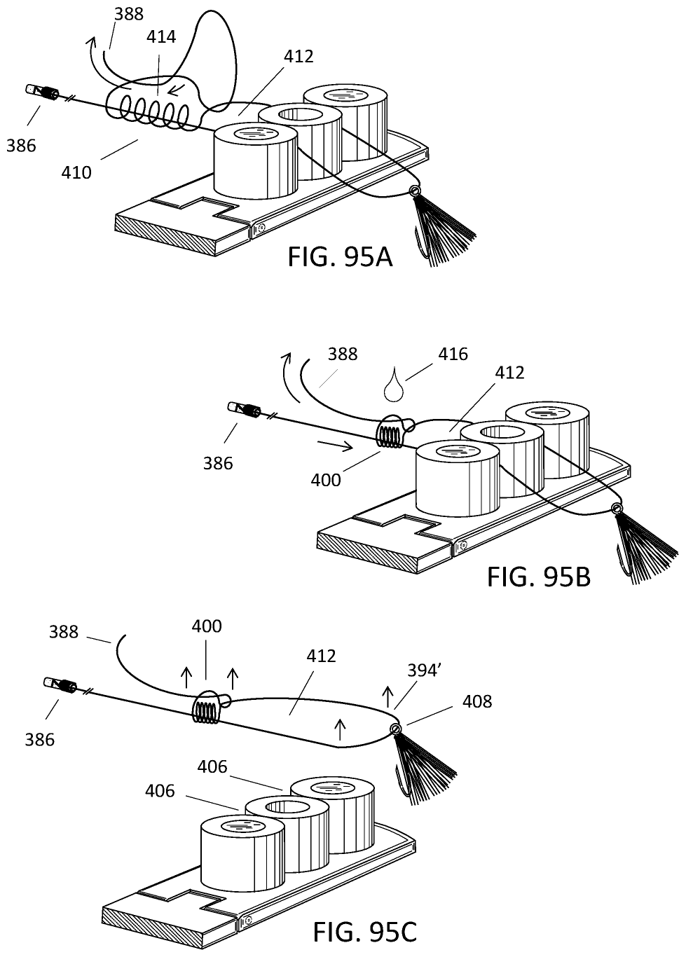

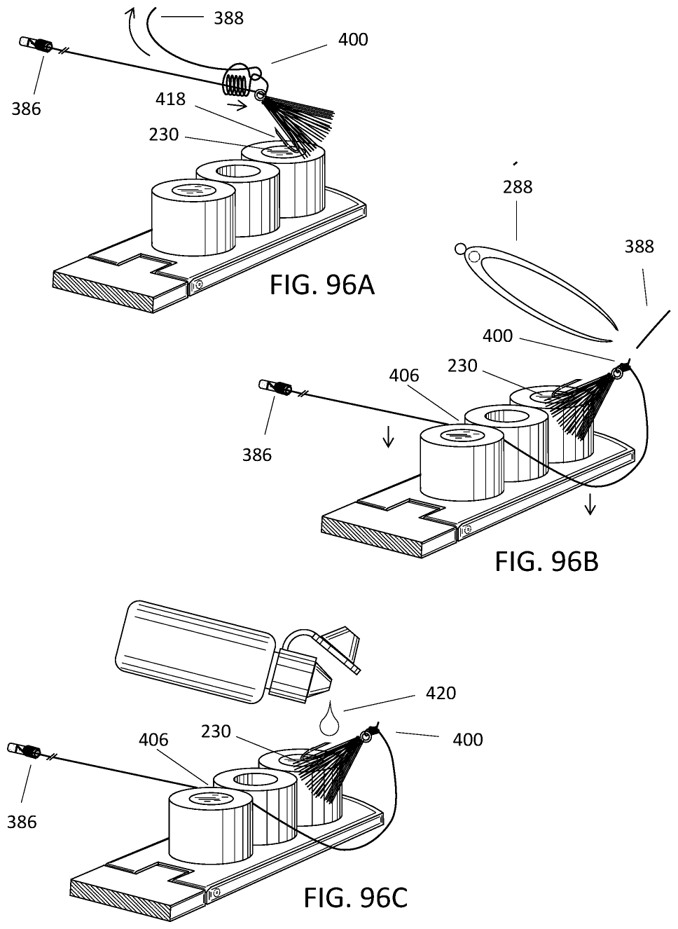

For this operational description, a conventional ‘improved-clinch’ knot is used to demonstrate a mono-to-hook connection (FIG. 94-FIG. 96). With hook-eye 408 threaded through mono loop 394′ and both ends retained by slots 406 (FIG. 94A), tag end of mono is wrapped 410 five to seven times around distal-end of mono (FIG. 94B). Tag end 388 is then passed through bottom of loop 412 (FIG. 94C) and then passed through top of loop 414 (FIG. 95A). ‘Improved clinch knot’ 400 is then formed by moistening knot, commonly with saliva 416, and pulling tag-end 388 to left. While pulling tag-end 388, loops are drawn closed and arranged parallel with one-another (FIG. 95B). While simultaneously holding knot 400 with left hand and loop 394′ with right hand, improved clinch knot is lifted up out of both slots 406 (FIG. 95C) and hook bend 418 is placed on distal magnet (FIG. 96A) to finish cinching knot onto hook-eye. Once improved clinch knot 400 is can be cinched on hook-eye 408, mono adjacent to hook is docked in proximal slot 406, and nippers 288 are used to cut off remaining tag end near knot 400 (FIG. 96B). Dark, matte-finished parts of Angler's Jig is optimal background for visualization of translucent mono. With rig mono docked in proximal slot 406, lures/flies intended to float on surface of water are often ‘dressed’ by application of liquid ‘floatant’ 420 that is rubbed into hair, feathers, or foam to equally distribute and make water repellent (FIG. 96C). Addition of more floatant to flies is a common rig adjustment. Similar conventional liquid ‘sinkants’ are applied to promote sinking in water.

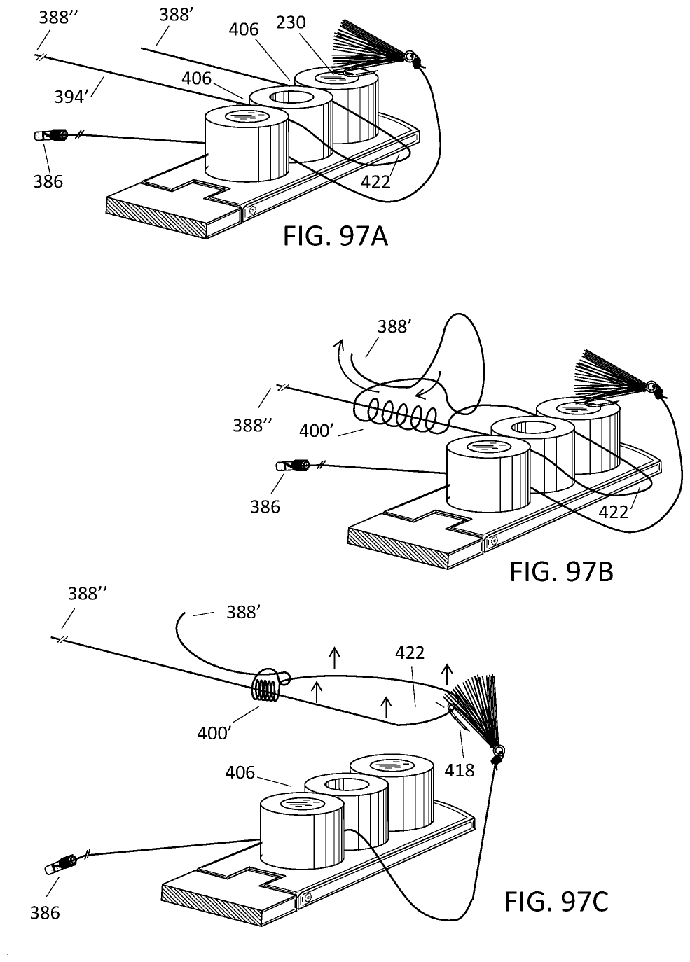

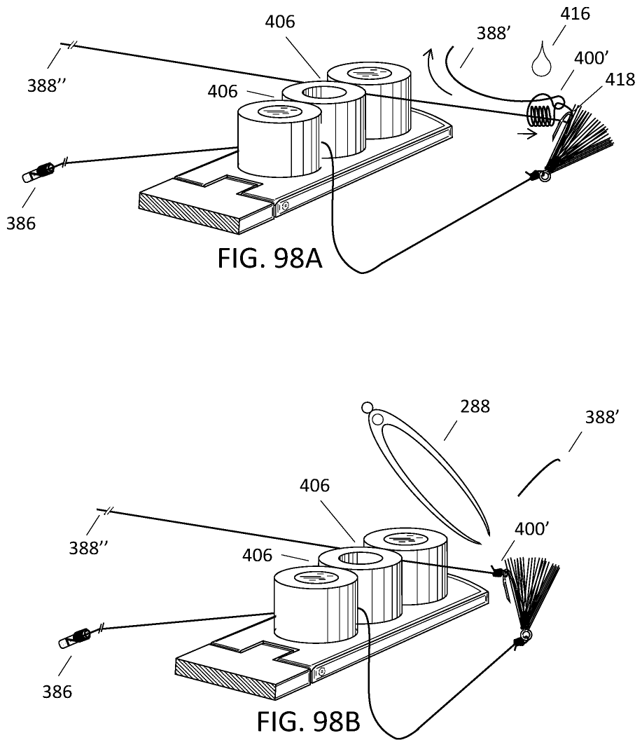

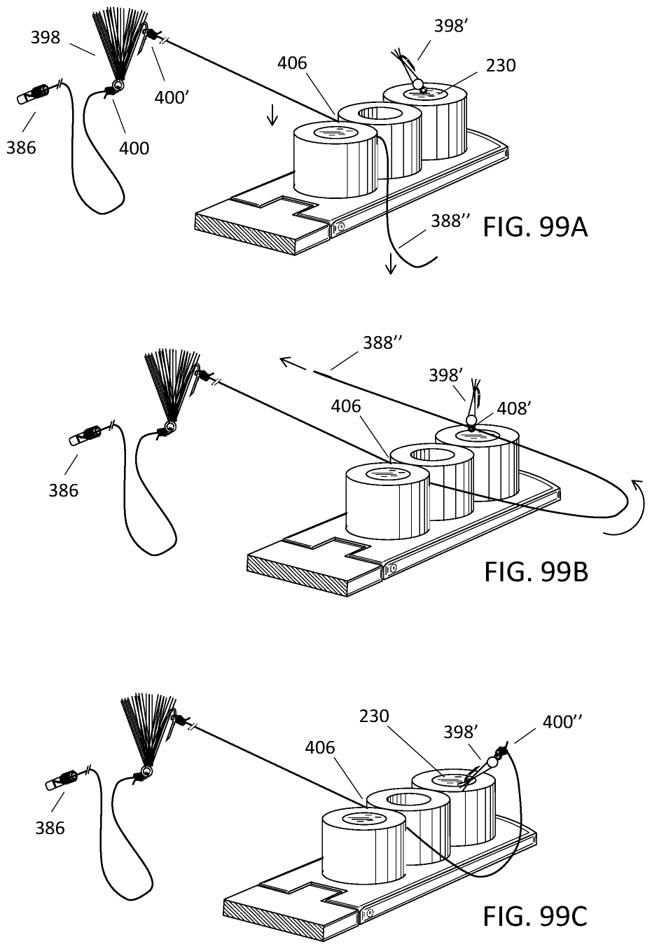

Operational Feature 5. Line-to-Hook-Bend Knot Jig: Another rig modification is addition of a second lure. Attachment of a second lure to rig can be accomplished in a variety of ways. For this operational description, a conventional ‘improved-clinch’ knot is used to make a mono-to-hook bend connection (FIG. 97-FIG. 98). With 1^{st} lure connected to distal magnet 230, and rig mono docked in proximal slot 406, a length of mono 394′ is inserted into slots 406 such that a loop 422 is stabilized (FIG. 97A). Distal end 388″ of this monofilament is indicated and length is determined by angler, as to desired distance between lures. An improved clinch knot 400′ is tied as above except without a hook-eye threaded in loop 422 (FIG. 97B). Hook bend of 1^{st} lure is inserted in loop 422 and improved clinch knot is lifted out of both slots (FIG. 97C), cinched to bend of hook following lubricant application (FIG. 98A), and tag end 388′ cut off with nippers 288 (FIG. 98B). To tie a second fly to this mono attached to hook bend of first lure, first dock tag-end of mono 388″ into proximal slot 406 and place second lure 398′, hook-eye down, onto distal magnet 230 (FIG. 99A). Thread tag-end of mono 388″ through hook-eye 408′ of second fly 398′ (FIG. 99B), and tie an improved clinch knot to hook-eye (as above). Cut off tag-end and process is complete (FIG. 99C).

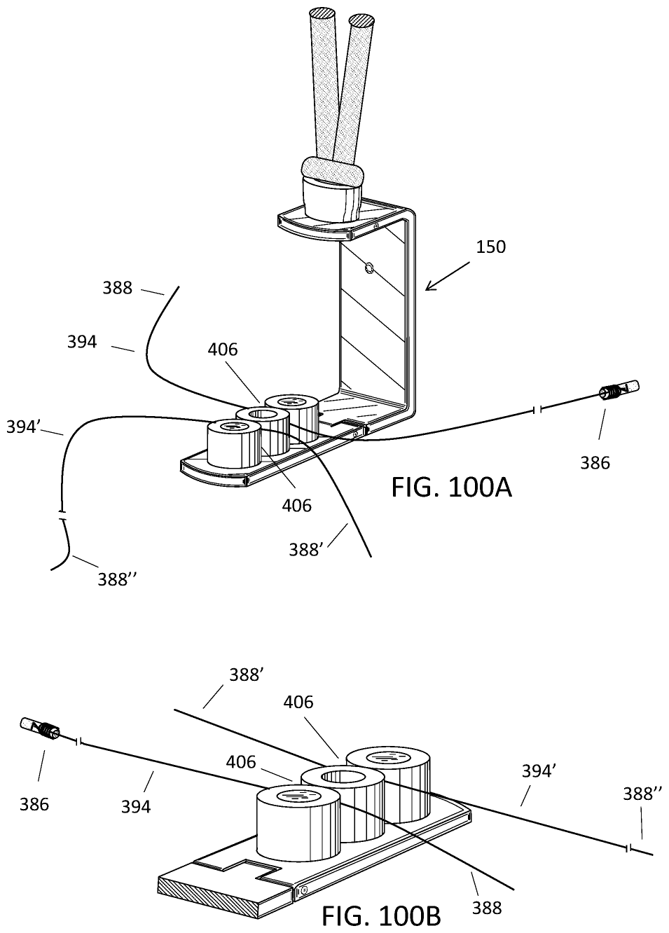

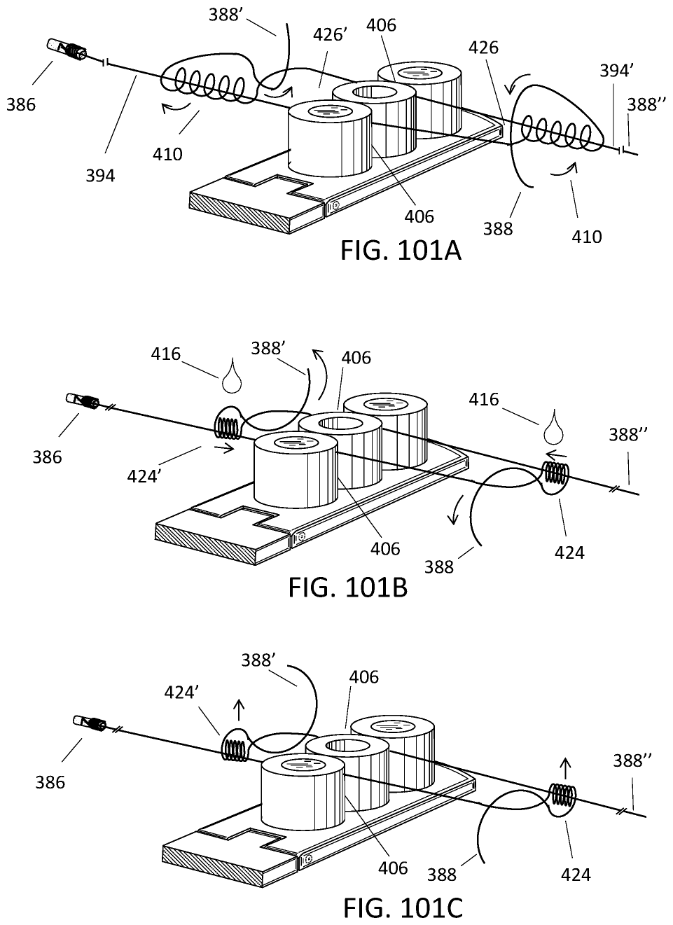

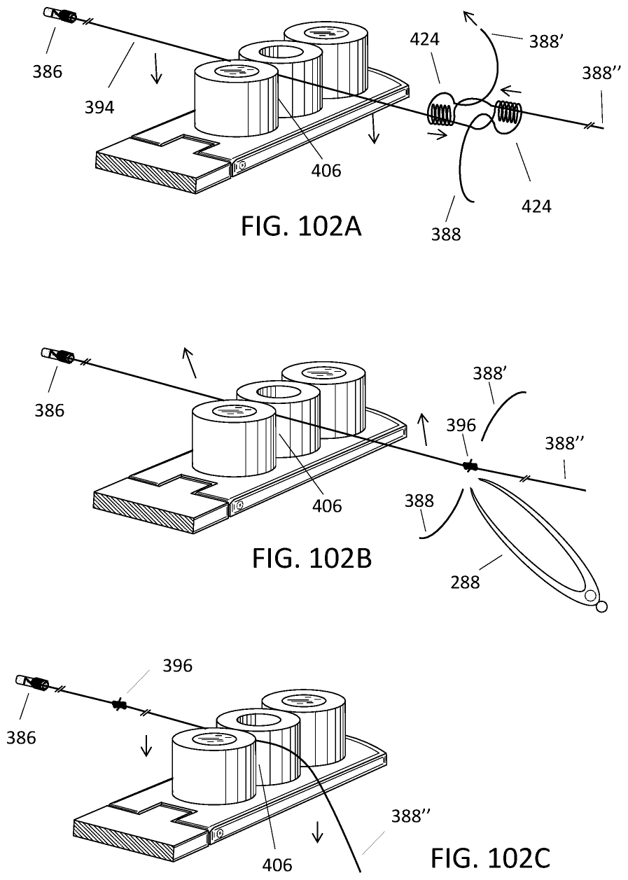

Operational Feature 6. Line-to-Line Knot Jig: Another rig modification is addition of monofilament. Attachment of a monofilament to rig can be accomplished in a variety of ways. Two common methods are a double-surgeons knot and blood. For this operational description, a conventional ‘blood’ knot can be used to make a tapered leader to mono or mono-to-mono connection (FIG. 100-FIG. 102). A step-wise process for attaching mono to mono using a ‘blood knot’ 396 starts with ‘docking’ mono 394 with tag end 388 in proximal slot 406, extending to right of Jig (FIG. 100). Another strand of monofilament 394′ is inserted in distal slot 406 with tag end 388′ extending to left of Jig (FIG. 100). This parallel alignment of two monofilament strands is useful for a variety of other line-to-line connections. Blood knot 396 is basically two clinch knots 424 drawn toward each other (FIG. 101). Tag-end 388 of main rig, is wrapped 410 around proximal portion of additional mono strand 394′ five to seven times and inserted through top of loop 426 (FIG. 101A). Tag-end 388′ of additional mono strand is wrapped 410 around proximal portion of main rig mono 394 five to seven times and inserted through bottom of loop 426′ (FIG. 101A). Two clinch knots 424 and 424′ are lubricated 416 and drawn toward one-another while simultaneously pulling tag-ends 388 and 388′ toward one-another (FIG. 101B). Knots 424′ and 424 are pinched between fingers of left and right hands, respectfully, and lifted out of slots 406 (FIG. 101C). Proximal portion of main rig is then docked in proximal slot 406 and two clinch knots 424 are continually drawn toward one-another by pulling tag-ends 388 and 388′ until blood knot 396 is formed (FIG. 102B). Tag-ends are then clipped off with nippers 288 (FIG. 102B) and proximal portion of extreme terminus of rig 388″ is docked in proximal slot 406 (FIG. 102C), to which additional mono or lure is subsequently connected.

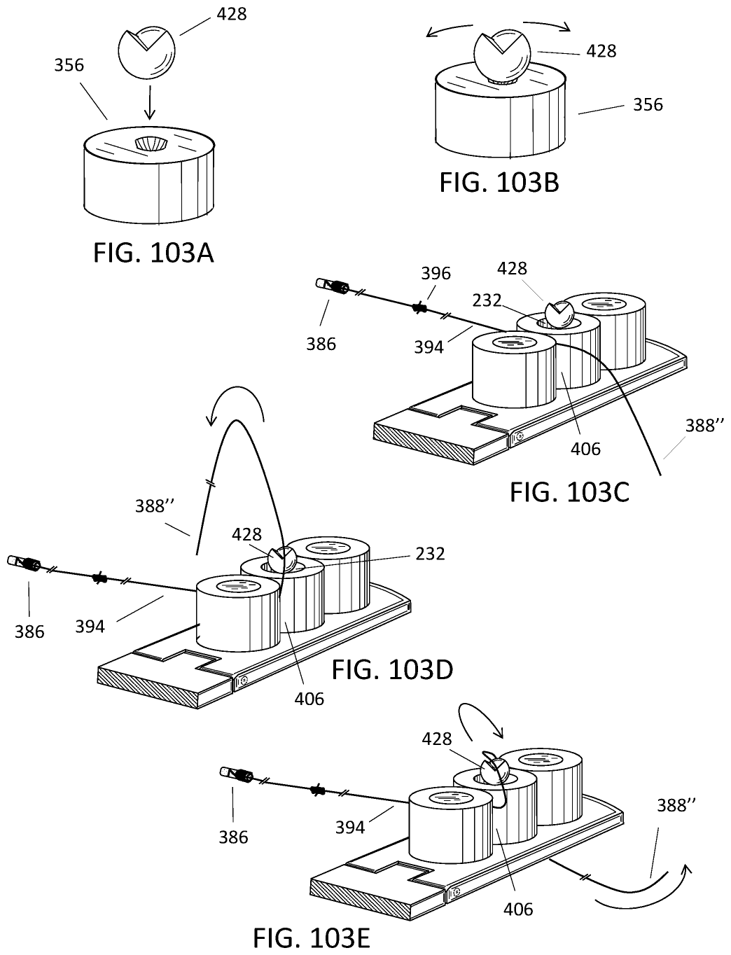

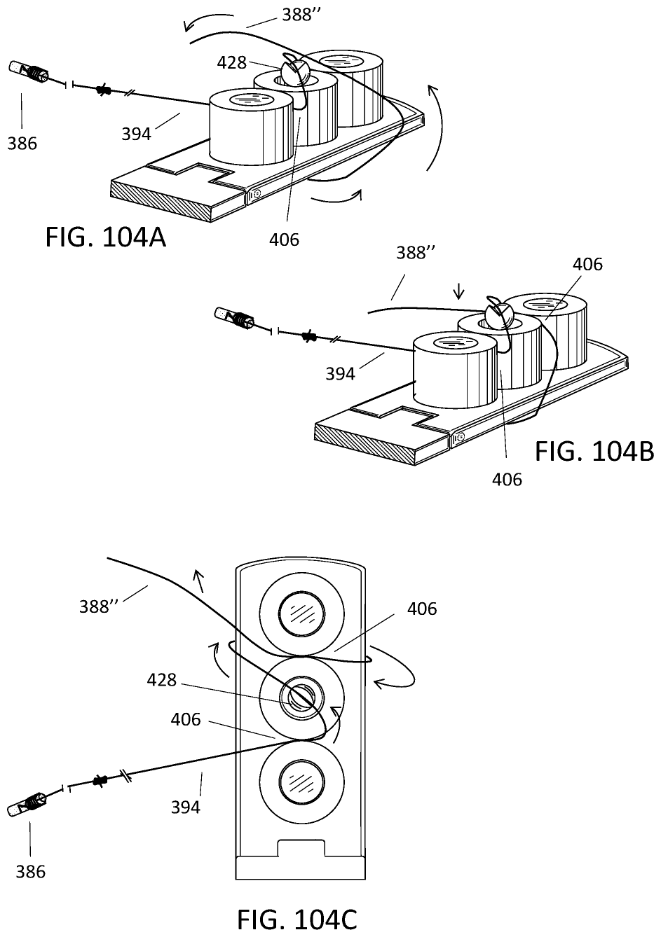

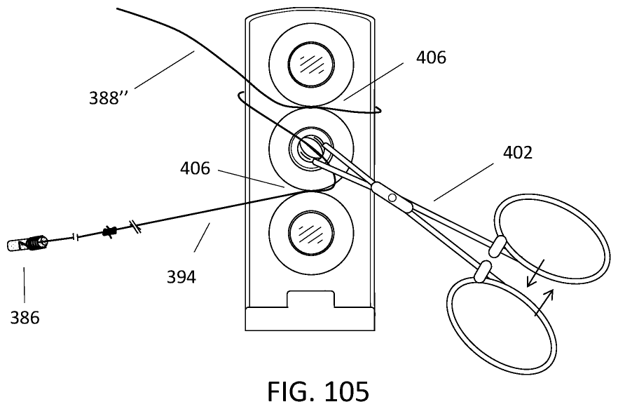

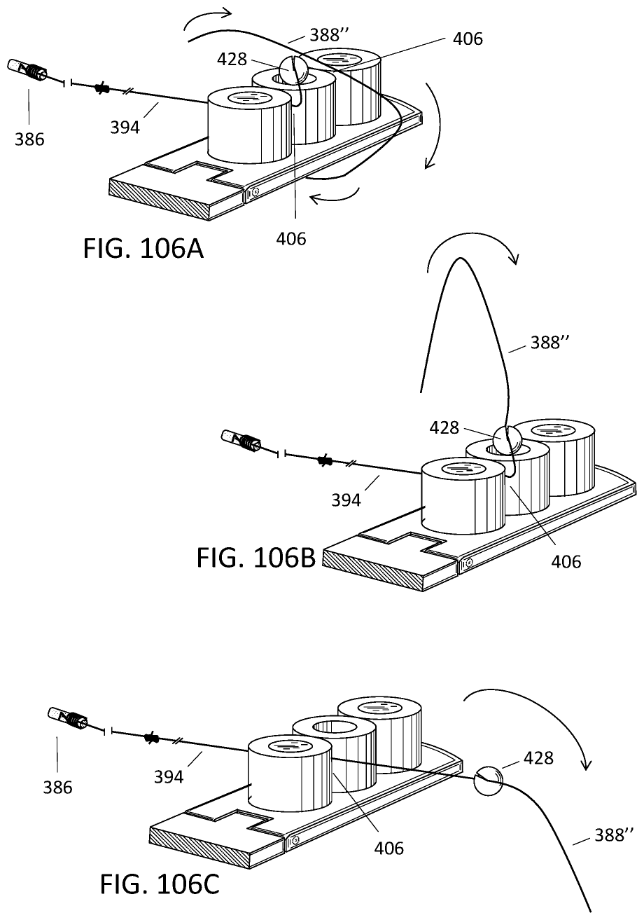

Operational Feature 7. Sinker Attachment to Line: Another rig modification/adjustment is addition of sinkers. Attachment of a sinker to rig can be accomplished in a variety of ways and there are a variety of sinkers. For this operational description, a conventional split-shot sinker is used. Generally, sinkers do not contain iron and cannot be used with magnets 230. Recess 232, disc-shaped insert 234, flat-ring insert 236 and fabricated split-shot holding insert 356 are designed to temporarily hold and align a conventional split-shot sinker 428 with mono 394 at a specific location. Disc 234, ring 236 and insert 356 are used to change depth of recess for working with different sized sinkers. For this operational description, with rig docked in proximal slot 406, fabricated split-shot holding insert 356 allows angler to align sinker 428 with mono 394. With rig docked in proximal slot 406, mono 394 is guided into split by wrapping tag-end 388″ behind Jig (FIG. 103A-FIG. 103E). Tag-end 388″ is wrapped around main body of jig and inserted in distal slot 406, effectively positioning and retaining split-shot sinker 428 at desired location (FIG. 104). Forceps 402 can be used to pinch sinker 428 onto mono 394 (FIG. 105). Distal end of mono is then unwound by pulling tag 388″ from distal slot 406 (FIG. 106).

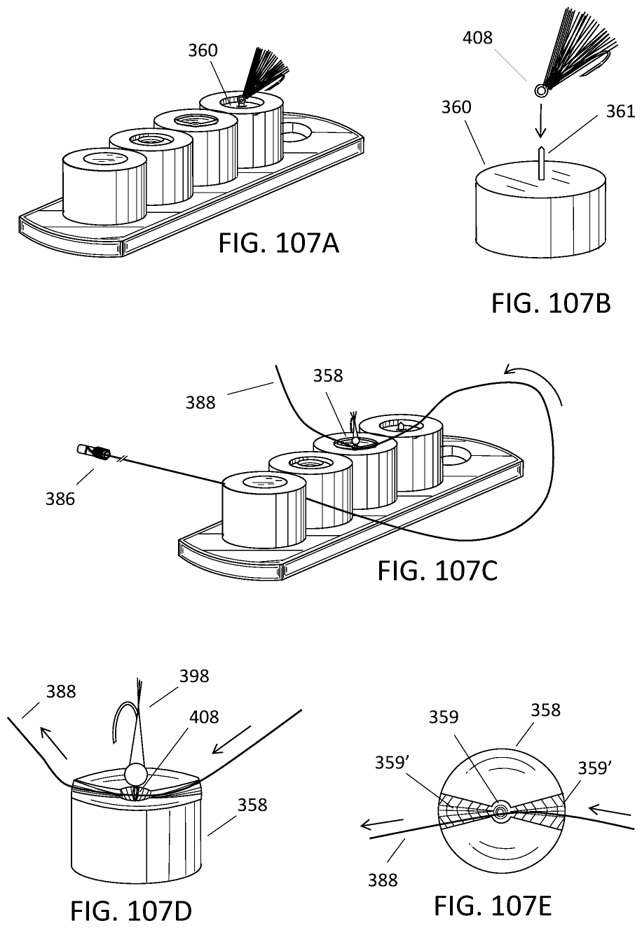

Operational Feature 8. Hook-eye cleaner: (FIG. 107A-FIG. 107B):_Hook-eyes are sometimes difficult to thread mono through, often due to adhesive residue from lure making process. Hook-eye cleaner insert 360 with central pin 361 is designed to remove hook-eye residue for easy mono threading.

Operational Feature 9. Hook-eye threader: (FIG. 107C FIG. 107E). Hook-eyes are sometimes difficult to thread. Hook-eye threader insert 358 positions hook-eye 408 in central concavity 359 perpendicular to cone-shaped concavity 359′ to easily thread tag-end 388 through eye of hook, from both left and right-hand sides (lure not shown in FIG. 107E for clarity).

### CONCLUSIONS, RAMIFICATIONS AND SCOPE OF INVENTION

This description of the Angler's Rigging Jig and it's operation demonstrates how anglers can expedite rig modifications by using the hands-free hook, line, and sinker retainers. While the above description contains many specificities, these should not be construed as limitations on the scope of the invention, but rather as an exemplification of three preferred embodiments thereof.

In fact, the three Versions of the Angler's Rigging Jig described here were provided to demonstrate how the scope of this rather simple invention can be expanded. Version 1 can maintain a horizontal bench-like position on lanyard, connecting link or other connector capable of maintaining orientation. Version 2 can maintain a horizontal bench-like surface when directly mounted to upward-facing surface such as a pocket-top using a variety of attachment methods. Version 3 is the most simplified version that is not as easy to manipulate/retain sinkers, it still functions properly. Furthermore, the scope of each of these Versions can be further expanded by employment of alternate line retainer sizes and shapes, alternate/exchangeable inserts for holding, threading, hook-eye clearing also described above. The scope of all versions can be further expanded by variations in colors of components, slight size variations of components, removable/replaceable components. Scope of all Versions can also be further expanded by combining one or more components together during molding process (modular or in pieces). The scope of all Versions can be expanded by addition or subtraction of one or more hook, line, or sinker retainers. Accordingly the scope of the invention should be determined not by the embodiments illustrated, but by the appended claims and their legal equivalents.

1. A hands-free anglers rigging device comprising:
a. an elongated rectangular main body comprised of rigid material having one or more integral or mounted resilient retainers for gently holding fishing line,
b. one or more integral or mounted magnetic retainers for holding and threading hooks,
c. and one or more attachment points to allow hands-free use

2. A hands-free anglers rigging device comprising:
a. an elongated rectangular main body comprised of rigid material having one or more integral or mounted resilient retainers for gently holding fishing line,
b. one or more integral or mounted magnetic retainers for holding and threading hooks,
c. one or more mounted or integral recesses for retaining sinkers and attaching them to line,
d. and one or more attachment points to allow hands-free use.

3. A hands-free anglers rigging device comprising:
a. an elongated rectangular main body comprised of rigid material having one or more integral or mounted resilient retainers for gently holding fishing line,
b. one or more integral or mounted magnetic retainers for holding and threading hooks,
c. one or more mounted or integral recesses for retaining sinkers and attaching them to line,
d. a hinged cover to protect retainers when closed and maintain horizontal bench-like position when open,
e. and one or more attachment points to allow hands-free use
